(19) United States
(12) Patent Application Publication
(10) Pub. No.: US 2015/0066548 A1
(43) Pub. Date: Mar. 5, 2015

(54) Algorithmically Optimized Project Portfolio Management Utilizing Purpose Directed Hard and Soft Data Feeds

(71) Applicant: Anthony Salvaggio, Allentown, PA (US)

(72) Inventor: Anthony Salvaggio, Allentown, PA (US)

(21) Appl. No.: 14/016,272

(22) Filed: Sep. 3, 2013

(51) Int. Cl. G06Q 10/06

(52) U.S. Cl. CPC G06Q 10/063
USPC 705/7.11

(57) ABSTRACT

In the algorithmically optimized project portfolio management, a uniquely comprehensive and holistic approach to data gathering with purpose directed hard and soft data feeds along with a complex and extensible algorithm is used to create and manage a portfolio of projects on an ongoing basis. The method includes broader data gathering capabilities from both people and other systems of record that contain hard data than other approaches. It also uses the functions of an integrated automated project office and a resource utilization planner to provide input to manage the portfolio on an ongoing basis.

### REFERENCE TO RELATED APPLICATIONS

The present application claims the benefit of U.S. Provisional Patent Application No. 61/643,6194, filed May 7, 2012, whose disclosure is hereby incorporated by reference in its entirety into the present disclosure.

### FIELD OF THE INVENTION

The present invention is directed to the totality of the combination of a unique algorithmically optimized project portfolio management utilizing a here-to-fore undocumented holistic approach with purpose directed hard and soft data feeds. Specifically, it is such a system and method where a broader reach of directed or targeted data elements comprised of both empirically proven data and subjective human intelligence are combined along predetermined project data points. This then determines objectively the business efficacy and benefit of a project or group of projects according to a unique set of business rules and numerical algorithms that have greater sophistication than popularized methods.

### DESCRIPTION OF RELATED ART

The Project Management Book of Knowledge 4th edition identifies project portfolio management as “The centralized management of one or more portfolios, which includes identifying, prioritizing, authorizing, managing, and controlling projects, programs, and other related work, to achieve specific strategic business objectives.”

FIG. 12 shows the list of software that is advertised in the project portfolio management space. These were reviewed based on information obtained via their websites to determine the presence of the unique capabilities of an algorithmically optimized project portfolio management solution that utilized purpose directed hard and soft data feeds. None were found to have this complete set of characteristics that holistically addresses the dynamic and complex nature of project portfolio management.

The present invention also differs significantly from all other submissions. For example U.S. patent application No. 61/145,903 states, “ . . . a project-management method includes implementing, on a server computer having a processor and memory, a universal framework for engaging projects within an enterprise . . . .” This focus on project management process and validation is the venue of Automated Project Office inventions that precede and/or lie below the Project Portfolio Management system. U.S. Pat. No. 8,401,882 states, “A method of aligning development of an information technology system with business objectives can include obtaining at least one metric relating to a development process for the information technology system and comparing the at least one metric with at least one quantified business objective relating to the information technology system to determine a delta between the at least one metric and the quantified business objective(s) . . . .” This focus on a metric of business alignment does not take into account the need to balance and optimize resources in a realistic and effective manner. U.S. Pat. No. 8,290,806 states, “A system for calculating financial benefit estimations and generating reports for multi-dimensional project plans for implementing packaged software applications, the system includes . . . a model and control layer configured to implement rules based on a series of estimation and implementation models, and to perform calculations to determine financial benefits.” This is closer to true Project Portfolio Management needs as identified in the Project Management Book of Knowledge 4th edition, however it does not take into account the need for a broad base of purpose directed data from both hard and soft data sources. U.S. Pat. No. 8,214,240 states, “Described are methods and apparatuses, including computer program products, for optimizing allocation of resources across projects in a project portfolio. The method includes receiving, at a computing device, (i) resource information, (ii) a portfolio of project definitions and (iii) one or more portfolio-level optimization criteria. The resource information representing a plurality of resources available for allocation to the projects, and each project definition includes a unique identifier and one or more project-level constraints. The method also includes generating, using the computing device, a plurality of project portfolio allocation scenarios and determining one or more optimized project portfolio allocation scenarios from the plurality of project portfolio allocation scenarios. Each project portfolio allocation scenario satisfies the one or more project-level constraints associated with each project definition. Each optimized project portfolio allocation scenario optimizes a sequence of the projects to satisfy the one or more portfolio-level optimization criteria.” This does indeed refer to true project portfolio management, but lacks the understanding that portfolio management is an activity that is executed on an ongoing basis as events change in inflight projects, new projects come into the mix and new considerations outside those of the original planning schedule come to bear. It also does not does not contain significant aspect that make the proposed application unique such as both hard and soft data driven by directed questions, a Branch and Bound Simplex algorithmic process, factoring for resource proficiency, confidence levels for project estimates, the creation of additional models that are complimentary or supplementary to the standard models, and both singular Objective Function and Full Spectrum Optimization.

In Chapter 7.2 of Project Portfolio Management (Levine 2005) Robert Cooper states: “Portfolio management is a dynamic decision process, whereby a business's list of active new product (and development) projects is constantly updated and revised . . . . . The portfolio decision process is characterized by uncertain and changing information, dynamic opportunities, multiple goals and strategic considerations, interdependence among projects, and multiple decision-makers and locations.”

Furthermore, Prepare for the unexpected: Investment planning in asset-intensive industries, a report from the Economist Intelligence Unit states in its conclusion that organizations must “Gather and use all the information and expertise available when making decisions”.

The algorithmically optimized project portfolio management solution that utilized purpose directed hard and soft data feeds was specifically designed to address the issues of uncertain and changing information while allowing for the dynamic opportunities, multiple goals, strategic considerations, interdependence among projects, and multiple decision-makers by gathering all the pertinent information via both hard (system generated and quantifiable) and soft (human subjective expert opinion) data feeds that are intelligent purpose directed to support strategic enterprise goals.

### SUMMARY OF THE INVENTION

It is therefore an object of the invention to overcome the above-noted deficiencies of the prior art. To that end, the present invention is directed to a system and method that, in various embodiments, can include the following functionalities.

### GLOSSARY OF TERMS

Glossary

| Term | Meaning |
|---|---|
| Project | Any closed ended activity (has an end date) to which people's time may be |
| | allocated and terms of total hours to be expended before the end date. |
| Activity | Any open ended activity to which people's time may be allocated at a rate: |
| | hours per month or percent of capacity. |
| Project Manager | An individual responsible for managing one or more projects - and the |
| | assignments of people working on those projects |
| Functional Manager | An individual responsible for managing a team of people and with |
| | responsibility for managing people's time on activities |
| Managed Resource | A person whose time is managed to ensure that they are being effectively |
| | utilized |
| Role | The nature of the assignment of a person to a project and activity. People |
| | typically have a default role (e.g. Software developer) and these defaults serve |
| | to define the nominal capacity of a team |
| Assignment | The assignment of an individual to a particular project or activity in a specified |
| | role. Assignments may be limited in terms of start and end date, total hours |
| | and maximum rate (hrs. per mo.) |
| Assignment Manager | Either the Project or Functional manager associated with this assignment |
| Flex Task | A work item that the resource works on when their time is not allocated to non- |
| | flex assignments. |
| Work Plan | The allocation of people's time on a week-by-week basis to an assignment |
| Support Activity | A class of activity that provides support services to customers and users. |
| | Time on these typically pre-empts time spend on projects and other classes of |
| | activity |
| Status Statement | A brief statement, provided each week by assignees reporting on their |
| | accomplishments and plans. Report is made to the assignment manager |
| Program | A collection of related projects and activities managed collectively |
| Resource Capacity | The nominal number of hours available per week for this individual. In the US, |
| | this figure would be 40 (hrs./wk.) although part time employees would have a |
| | smaller number. |
| Planning Grid | A screen artifact containing records from the current work plan |

Optimization

The objective of optimization is to select that subset of the candidate and inflight projects that optimizes characteristics of the portfolio and that may be implemented with the available resources. For example, the client may wish to maximize the ROI or Business Alignment of the portfolio or minimize the amount of idle resource.

Any portfolio is constrained by the resources available to perform the work. These resources are primarily: the available staff, each with their own role plus any non-labor funds that may be required. Funds may come from multiple sources each with its own cost and cap.

The algorithm will then determine the optimal solution based on these resource constraints. It will also identify any resources that are surplus to requirements (for this portfolio). These resources could be released or redeployed in a different role—one that is constraining the portfolio.

Setting Up the Problem

### DEFINITIONS

Have a set of n candidate projects Pⱼ (j→1−n)

Each project has a value contribution of vⱼ

Have a set of m Resources Rᵢ (i→1−m)

Each role has a capacity Cᵢ

Project j requires a_{i,j} units of resource i

δⱼ is from the set {0,1} and indicates whether the project is in solution—equals 1 if it is and 0 if it is not.

In addition optimization uses data from a system capable of generating question sets that survey various aspects of the projects activities to assess projects in various areas. Each question set and possible answers are categorized, scored, and weighted in such a way as to gather specific project portfolio data that supports strategic goals.

Questions sets are formed from a large question pool that contains all possible questions and qualifiers. New question sets are built by selecting questions from the pool and storing the question set into a question set library.

The question sets are customizable and are assigned according to various classifications for a project. Classifications for the project include a portfolio and a project type. Projects are broken down into one or more portfolios or collections which have some common characteristic or interest (for example, a business unit or line of business, or a particular technology, etc.). Each portfolio has one or more question sets assigned to it that are used for optimization

Optimization requires a facility for periodically “running” or stepping through the question sets for the entire portfolio.

The solution is sensitive to the payback values of the projects (vⱼ) and the resource requirements (a_{i,j}) for each project on a role-by-role basis. Neither of these may be known with precision. Consequentially question sets are used to solicit confidence information on these parameters and in so doing allow for sensitivity analysis to be performed on each solution.

Objective Function

The Objective Function describes an attribute of the portfolio that the user wished to optimize. This is typically expressed as a maximization or minimization of a computed value.

### Example 1

The user wants to maximize the Business Alignment, V, of the portfolio. Here the value vⱼ is contribution to the business alignment score from project j and the objective function is

maximize V=Σⱼ₌₁ⁿvⱼ×δⱼ where δⱼε{0,1}

### Example 2

Minimize the amount of resource (money or people) not leveraged for the portfolio—in other words, idle resource. Here the value vⱼ is the amount of resource not being leveraged function. This is the capacity of each resource less that amount of resource committed to selected projects and then summed over all resources.

minimize Σᵢ₌₁^{m}(Cᵢ−Σⱼ₌₁ⁿα_{i,j}δⱼ) where δⱼε{0,1}

Each of these two examples are subject to the same constraints:

α_{1,1}+ . . . +α_{1,j}+ . . . +α_{1,n}≦C₁

α_{i,1}+ . . . +α_{i,j}+ . . . +α_{i,n}≦Cᵢ

α_{m,1}+ . . . +α_{m,j}+ . . . +α_{m,n}≦Cₘ

Solution Algorithm

The solution approach will employ a combination of the Branch and Bound and Simplex algorithmic processes to solve the integer programming problem of selecting that set of projects from the candidate list that maximizes the return to the company.

While this approach identifies a theoretically optimal solution it ignores many of the real world constraints such as dependencies between projects, location and compatibility of resources as well as the time phasing of the projects within the planning window. Facilities in the solution also manually add these criteria and re-plan the solution. Similarly facilities included relax one or more constraints so as to identify a resourcing need.

The algorithm allows users to relax one or more constraints and recalculate the portfolio. This will increase the value of the portfolio while identifying the additional resources that will be required by type in order to implement the portfolio.

Full Spectrum Optimization

Full spectrum optimization includes opportunities for sensitivity analysis on the results. For instance these might include other facilities such as:

Being able to selectively relax constraints on one or more resources to determine if the gain in portfolio value warrants the additional resources. This can be automated instead of incrementally relaxing one constraint at a time.

Multi-period planning where a particular project could span periods.

Additional pre-requisites & co-requisites.

Time-phasing resources across project life.

Multi-role resources where individuals may contribute to overall capacity in more than one role.

Factoring proficiency (Novice, Proficient, Expert) when computing role capacity.

Selectively add confidence intervals to estimates.

Portfolio Analysis

Optimization requires an integrated portfolio analysis function that allows an organization to track its projects according to a high-level classification system that allows for understanding a particular project footprint or balance of efforts relative to an overall goal. It should incorporate standard models like the MIT Model of portfolio classification, and uses it to perform a (classification) balance analysis. From a holistic perspective other models should also be included to extend the analysis and gather cumulative benefits. For example, the MIT Model classifies projects as Infrastructure, Transactional, Informational, or Strategic, and uses the relative distributions of projects to those classifications to determine a position or balance for Cost Focused portfolio, Agility portfolio, or Balanced Cost and Agility portfolio.

In addition to the MIT Model for portfolio classification, a user creates new models with appropriate classifications based on the latest available data. This makes the system responsive to the dynamics of the environment and allows analysis to be inclusive of finding new opportunity previously unplanned for.

Resource Utilization Planner

The resource utilization planner is a component of the solution that addresses the ongoing need to balance resources across in-flight activities and projects. Project and functional managers work co-operatively to allocate resource time that maximizes the value to the organization. This may cause projects to be prioritized based upon resource commitments to other activities, such as support.

The resource utilization planner provides a collection of tools and reports to management depicting the allocation of resources (people) to projects, programs, strategic initiatives, etc. and enabling dynamic rebalancing of resources to address current business imperatives.

The resource utilization planner implements the following use cases:

Create a new assignment (person to project/activity)

The user assigns a person to an existing project/activity.
The project (or activity) must be open.
The project (or activity) must be owned by the user.
Minimal information is the Project, resource (person) and role. Other information that could be included are the start and end dates for the assignment, the total number of hours allocated and the maximum percent of the person's time that can be allocated on a weekly basis.

Delete an Assignment

An assignment can only be deleted by the project manager or resource manager and only if no history has been recorded—either planned or actual.
An assignment can however be closed as described in the next topic.

Update an Assignment

Assignments can be marked as closed. This will prevent further time from being planned on the assignment. In fact, all planned hours from the date of closure are removed from the plan. The assignment will not show on the planning grid. If a closed assignment needs to be reopened the user must open the project and modify the assignment there.
Assignments are automatically closed if they have a finished date and that finish date has passed.

Mark an Assignment a Flex Task

User checks the flex task check box for the task. All entered values are then replaced with computed values. These are recomputed whenever changes are made to the assignment's work plan. Flex behavior can be turned on or off from the grid—not just when defining the assignment.

View Assignments by Project

The system provides a dropdown filter allowing the user to restrict the display to a single project.

View Assignments by Person

The system provides a dropdown filter allowing the user to restrict the display to a single person. This will support the verification that the individual's time is fully planned.

View Assignments by Role

The system provides a dropdown filter allowing the user to restrict the display to a single role. The will support the verification that the role's capacity is fully planned.

Create/Update/Delete Work-Items Under an Assignment

User creates a new work item under a particular assignment. Press [New Work Item] button to add a row to the planning grid. In the resource column, enter the name of the assignee (from the drop-down) control. In the assignment field, select the assignment from the drop-down. This is populated with all the open assignments for this person. In the Work Item column key a description of the task/activity.

Resource records vacation (Approved by PM and/or manager)

Report Status on an Assignment

The resource utilization planner's system behavior

Assignments May be Imported from External Systems

Need to be able to support feeds from external systems such as MS Project.

System Adjusts Flex Time

Whenever changes are made to the work plan for a resource, all flex tasks are adjusted so that the resource's time is fully accounted for (up to the max on f the resource's capacity or availability as specified in the assignment).
The maximum hours that may be assigned to all the flex tasks is the resources capacity (hrs./wk.)*the percent availability (as defined in the assignment).

Limit Plan Hours to Allocation

If the user attempts to allocated more hours to a work-plan than are specified in the assignment the system hours will be flagged in red and the system will prevent the user from saving the work plan. The user can either: reduce the hours in the work plan or modify the assignment, increasing or removing the cap.

Limit Plan Hours to the Period (Start Date to Finish Date)

For plan items that are driven by regulatory timeframes.

Limit Plan Hours on Flex Tasks to Availability

Have the ability to deprecate the availability field <No: Renamed to RateCap features in roles assignment teams.

Inhibit Input for Historic Dates

Users cannot modify work plan for historic dates.

Capture Actuals Against Plan

As work proceeds it would be beneficial to capture actual charges made to a work item. However this is problematic if work items are informal activities booked to an assignment. We may still be able to capture actuals against the assignment itself, as long as the appropriate feeds are put into place.

Generate/Publish Reports

The system will generate and distribute a standard set of reports modeled on those used internally.

View Reports Online

It should be possible to view reports (tables and charts online) by appropriately authorized individuals.

Users can only update people for whom they have assignments or that they manage directly.

Can be represented through team assignments.

Account for Vacations and Holidays

Holidays can vary by location (country).

The Resource Utilization Planner User Interface

The project and functional managers update the work plan via an online screen(s) that presents assignments in a grid of rows (representing assignments) and columns representing weeks).

User may filter list of assignments by Person, Project/Activity or Role.

User may only modify assignments for people they manage (either though project or functional management).

Only assignment owners may modify those specific assignments.

Column headers must reflect the corresponding week ending date (rather than the current CW+n template).

User must save or cancel input rather than being bound to the source data.

Overall User Interface Characteristics

Error! Reference source not found. shows the navigation on the PPM console that navigates the user to the various facilities and services required for Resource Utilization Planning.

In the figure, the yellow blocks are the activities associated with creating and maintaining the list of projects. The blue blocks are the activities associated with reporting status on those projects and the green are the activities associated with planning resource utilization.

The project and functional managers update the work plan via an online screen that presents assignments in a grid of rows (representing assignments) and columns representing weeks).

User may filter list of assignments by Person, Project/Activity or Role.

User may only modify assignments for people they manage, either though project or functional management.

Only assignment owners may modify those specific assignments.

Column headers must reflect the corresponding week ending date (rather than the current CW+n template).

User must save or cancel input rather than being bound to the source data.

Modeling Assignments

FIG. 2 shows how work planning dates are derived by the system through a conceptual model.

An assignment record (table ppm.Assignments) maps a person to a project (or activity) in a specific role. Fields in the assignment record can be used to specify the start and end dates of the assignment, then number of hours assigned and the weekly rate at which these hours may be consumed. The assignment record also indicates if this is a flex assignment.

FIG. 3 shows the data model for the assignments.

FIG. 4 shows the actual table definition for the Assignment record.

EntID identifies the project or activity, ResID the person and RoleID the Role. Allocation is the total number of hours allocated to this assignment. AllocatedRemaining is the number currently available and ETC is the person's estimate of how many hours are required to complete the work.

Availability is a percentage representing the fraction of the person's capacity that can be applied to this task per week. FromDate and ToDate are self-explanatory. Score and Results are not relevant to the current discussion but are post-completion measures of how well the task was performed.

Modeling the Work Plan

The work plan describes how people's time is planned against these assignments.

FIG. 5 shows the relationship between Work plan and Assignment in a data model.

FIG. 6 shows the table definition that implements work plan and assignment.

The Work Plan identifies the hours per week that will be expended against the assignment.

Note the Flex field on the Assignment. If set to True, this indicates that the work item will function as a filler task for people when other tasks are not booking the person's full capacity.

### BRIEF DESCRIPTION OF THE DRAWINGS

A preferred embodiment of the present invention will be set forth in detail with reference to the drawings, in which:

FIG. 1 shows a web site diagram that depicts the flow from one panel of a screens activity to all its possible navigation targets and the general area of work that is performed one each.

FIG. 2 shows a conceptual model of how work planning dates are derived from their source in the physical world and expressed logically in the system.

FIG. 3 shows a data model diagram of the data necessary for making assignments.

FIG. 4 shows a table design for the ppm.Assignments table.

FIG. 5 shows the Work Plan and Assignment data model diagram.

FIG. 6 shows the Work Plan and Assignment table definition.

FIG. 7 shows the Project Portfolio Planner screen after the algorithm has run.

FIG. 8 shows Project Portfolio Scenario Manager Screen with a list of scenarios.

FIG. 9 shows the Problem Setup Data Model.

FIG. 10 shows the Solution Setup Data Model.

FIG. 11 shows the Financials Data Model.

FIG. 12 shows a list of software application that were reviewed.

### DETAILED DESCRIPTION OF THE PREFERRED EMBODIMENT

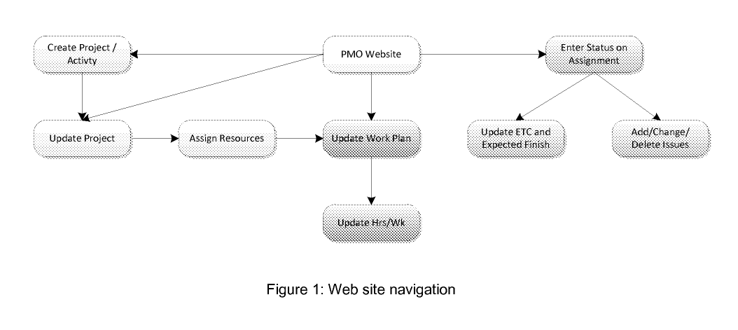

An overview of the web site navigation of the preferred embodiment is shown in the website navigation diagram of FIG. 1. The Project Portfolio Management (PPM) user has access to previously entered project data status on assignments. Through these the PPM user can create additional project activity or update existing project data. The PPM user can from this state assign resources as input to an updated work plan. The PPM user can also as a consequence of the PPM activities update the estimated time to completion and expected finish date for a project as well as modify any issues. The updated work plan reveals an updated hours worked schedule details.

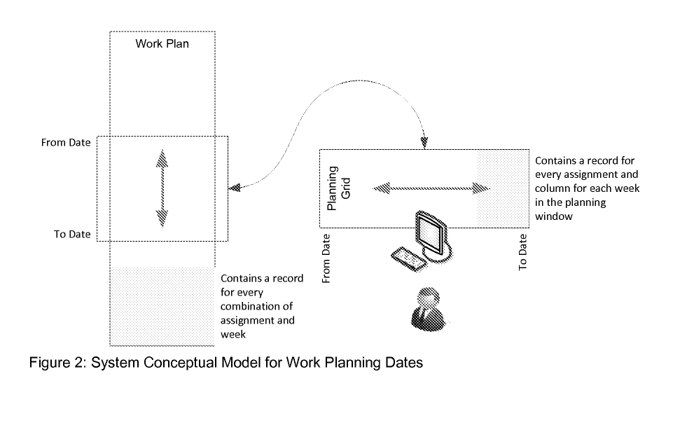

FIG. 2 shows a conceptual model on how these work planning dates referred to above are derived as a part of the assignment process and taken from a planning grid that holds the logical information and creates a set of physical work plan dates.

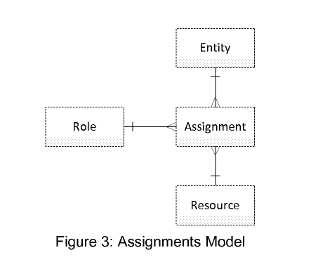

FIG. 3 shows how these assignments are represented as data in the underlying relational model. The normalization of the model with generic entities for Roles, Assignments and Resources provides for extensibility in the assignments process beyond personnel to include facilities, hardware and other non-human resources.

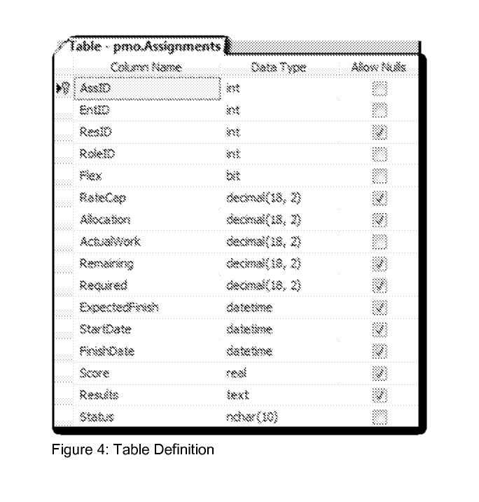

FIG. 4 shows how the assignment data from the model can be defined as a table with references to resources, roles and entities.

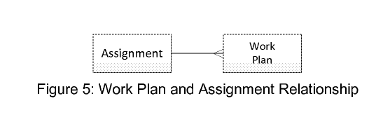

FIG. 5 further shows how this assignment data relates to the actual work plan in a one to many relationship.

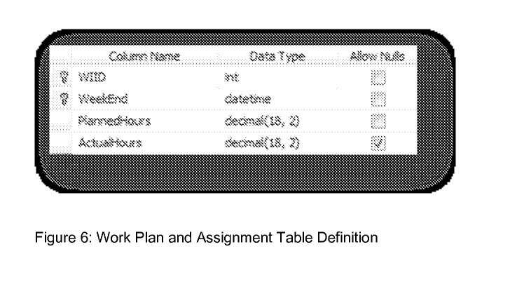

FIG. 6 shows how the work plan and assignment are hours are joined in a table's definition.

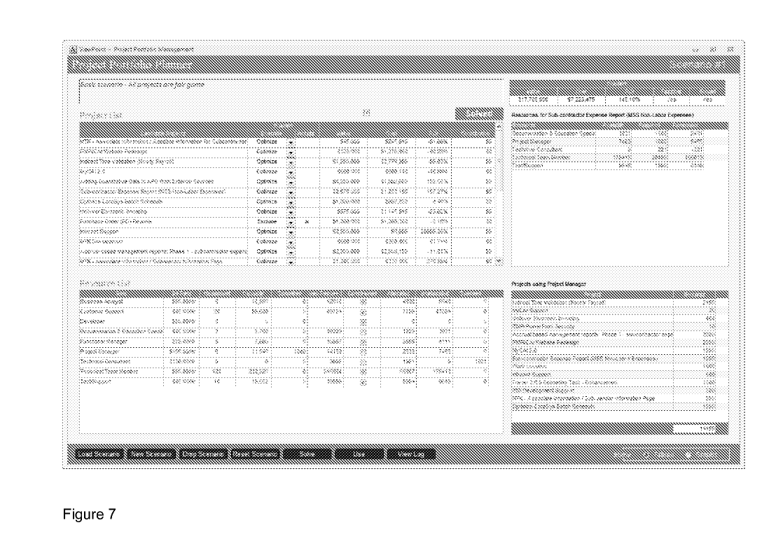

FIG. 7 shows an example of the project portfolio planner main window after optimization has been run and the results listed in the Project List pane with summary financials, resource consumption and project management assignment in separate panes. The description of the scenario that is currently loaded and which the project data was optimized against is declared in the upper left hand pane under the title bar. It also shows the functions of loading a preexisting scenario, creating a new project portfolio management scenario, dropping an existing scenario, resetting the current scenario, solving the current scenario using the specified optimization and viewing the resulting detailed log file from the optimization run. Data can be viewed either in tables or graphs.

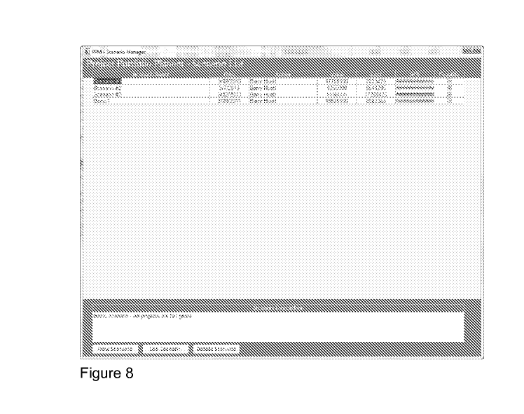

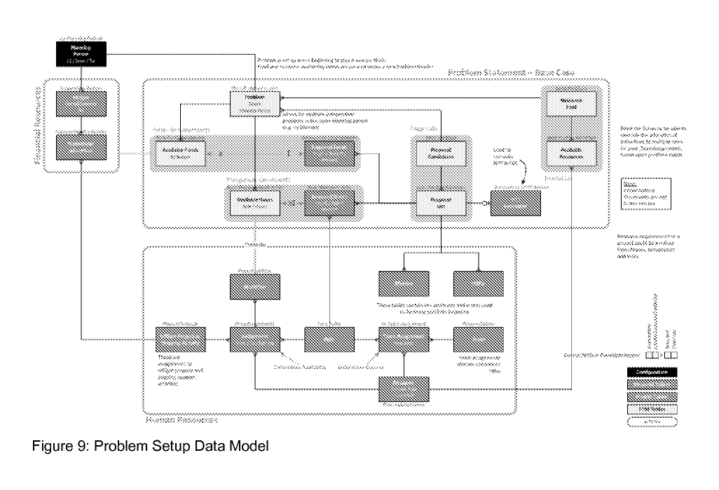

FIG. 8 sows that pull down list of the results of all the optimization scenarios that is available in the project portfolio manager scenario manager. Showing the scenario name, date of execution, author, value of the portfolio, the cost of the portfolio and the portfolio's return on investment.

FIG. 9 shows the problem setup overall data model. This model incorporates the previous work plan and assignment models. There are three main categories of data in the problem setup Financial Resources, Human Resources and the Problem Statement. Planning periods are driven by system configurable entities. Planning periods are necessary for the beginning of a new portfolio marked by the creation of a new problem scope. Planning periods are also required for the budget accounting as qualifiers for both capital and expense items and subsequent accounting work order allocation. These feed the financial constraints for available funds. Available funds are then balanced across required funding for projects. Manpower constraints also limit the problem scope resulting in a subset of proposal candidates for the portfolio. From the list of these proposals a total cost of ownership amount is derived along with subsequent net present value and return on investment calculations. Resource pooling is used to feed the problem/manpower constraints workload balancing. The human resource data contains both individual and team based assignments that supply data to calculate available hours, required hours and the metrics and user defined field used to facilitate portfolio balancing. The optimizer is capable of overriding the planned allocation of individuals to multiple roles based on the needs of the portfolio's specific optimization settings. Resource requirements must also be able to be considered as either aggregate or atomic in nature.

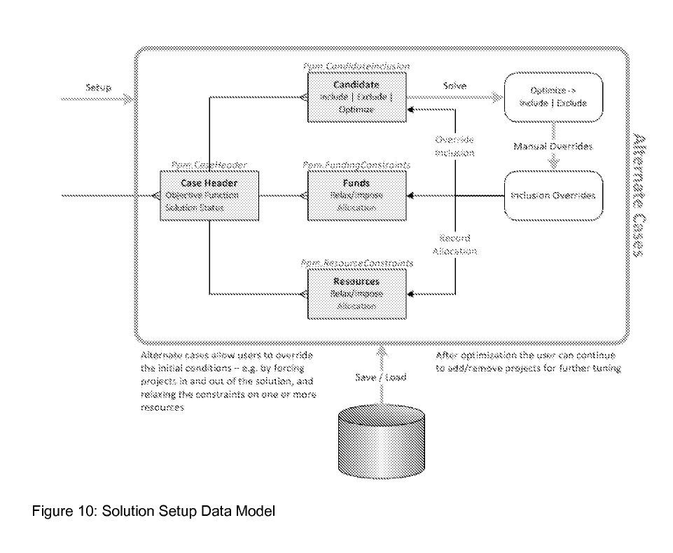

FIG. 10 shows the comparative use of alternate cases to improve on a portfolio's optimization by allowing the PPM user to override initial conditions forcing projects into and out of the portfolio solution. It is also a vehicle for relaxing the constraints on one or more resources to for rebalancing. To supplement this portfolio balancing effort PPM users also can directly remove or add projects to the mix to account for addition considerations outside of the PPM optimization algorithm. All resulting cases can be saved and later retrieved for comparisons of the various optimization strategies effectiveness in implementing organizational goals.

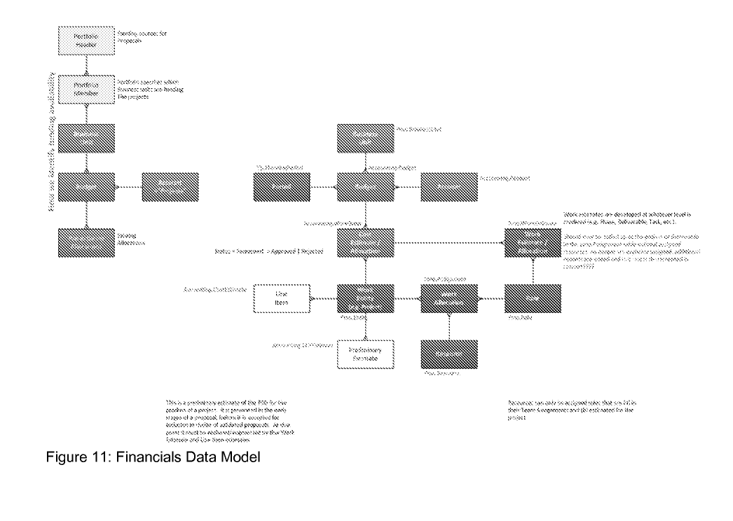

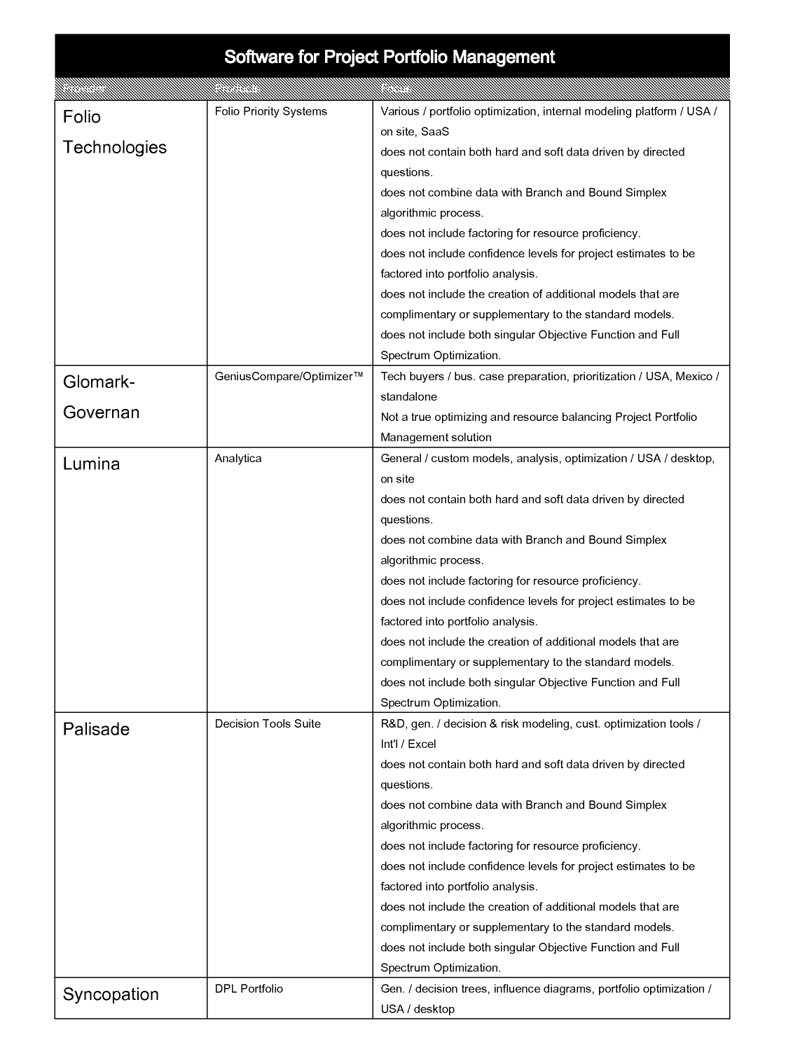

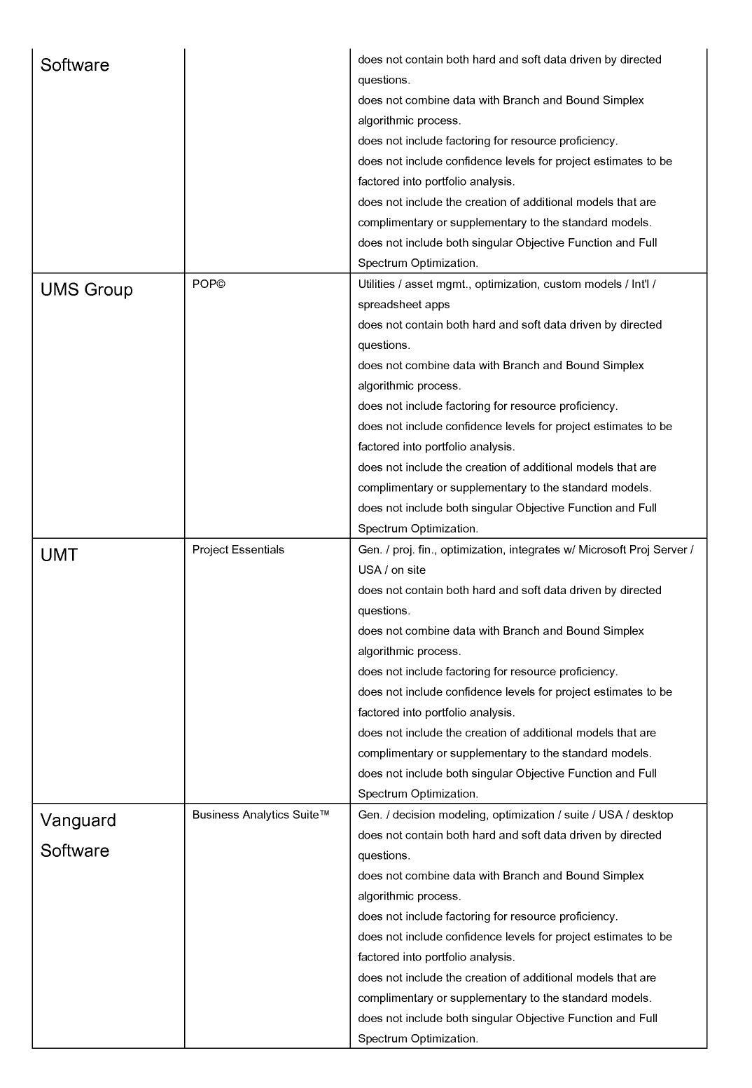

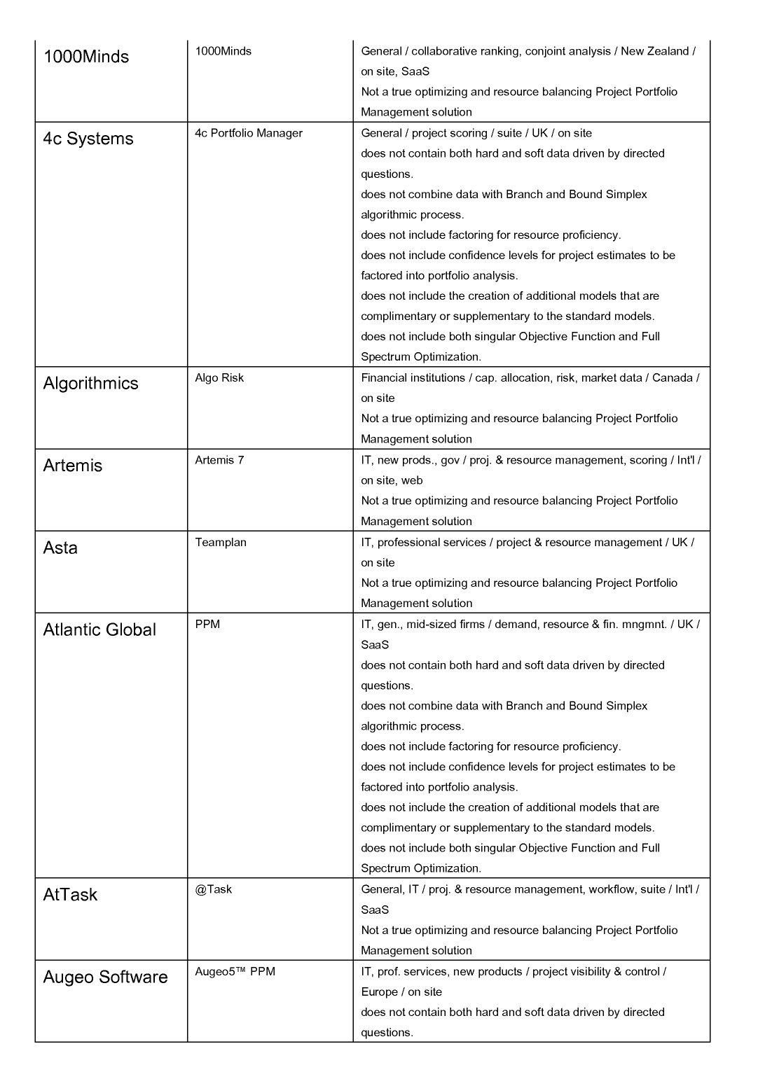

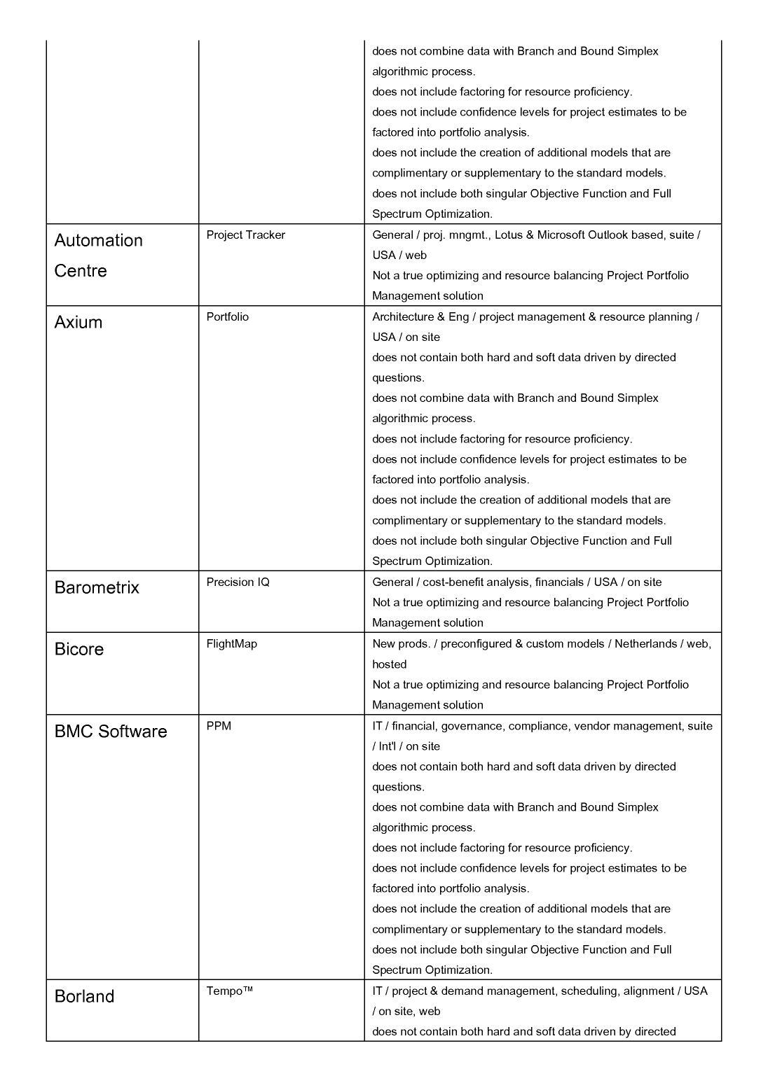

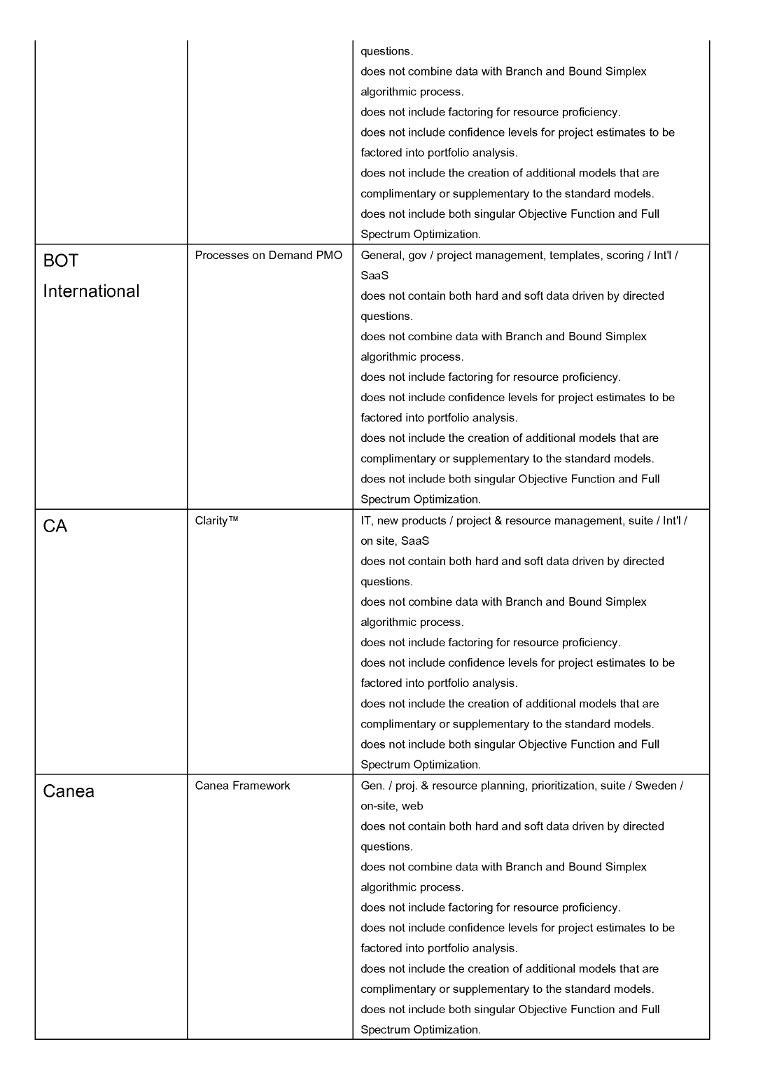

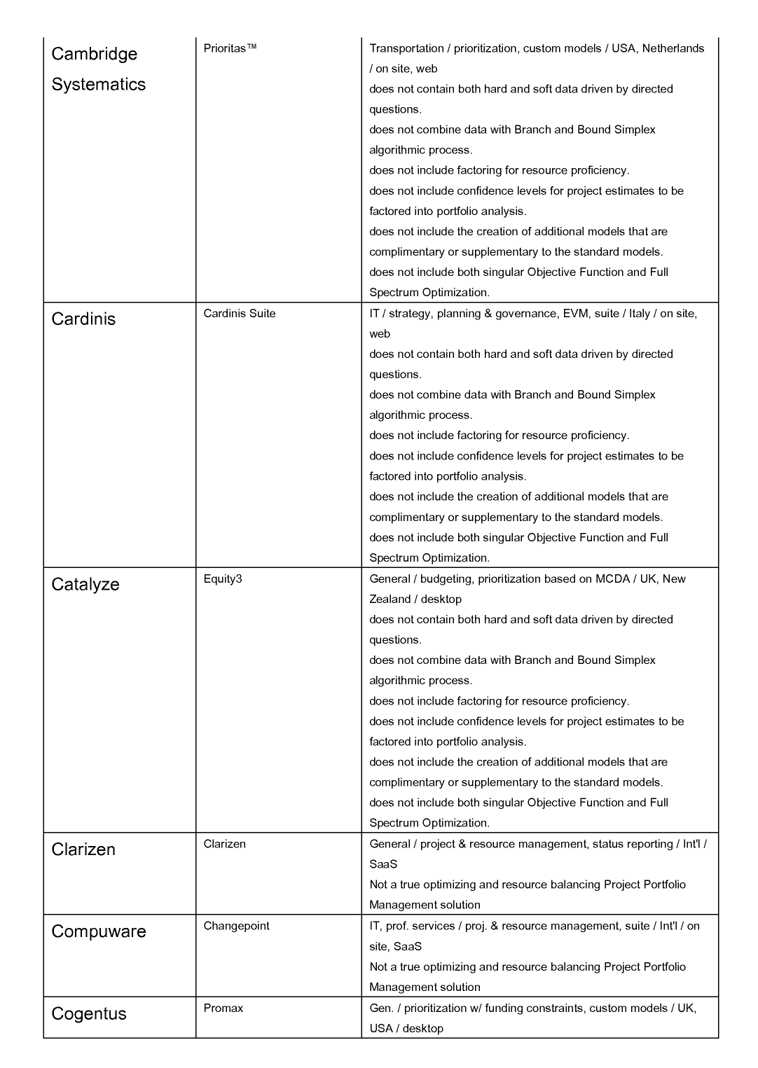

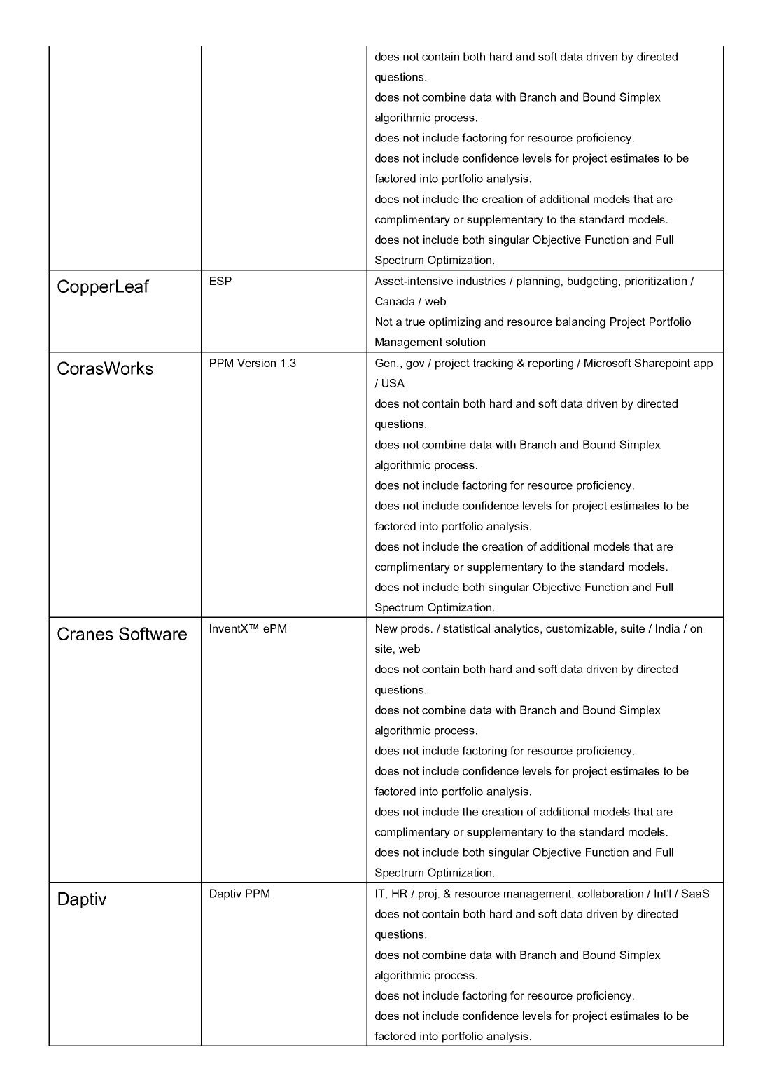

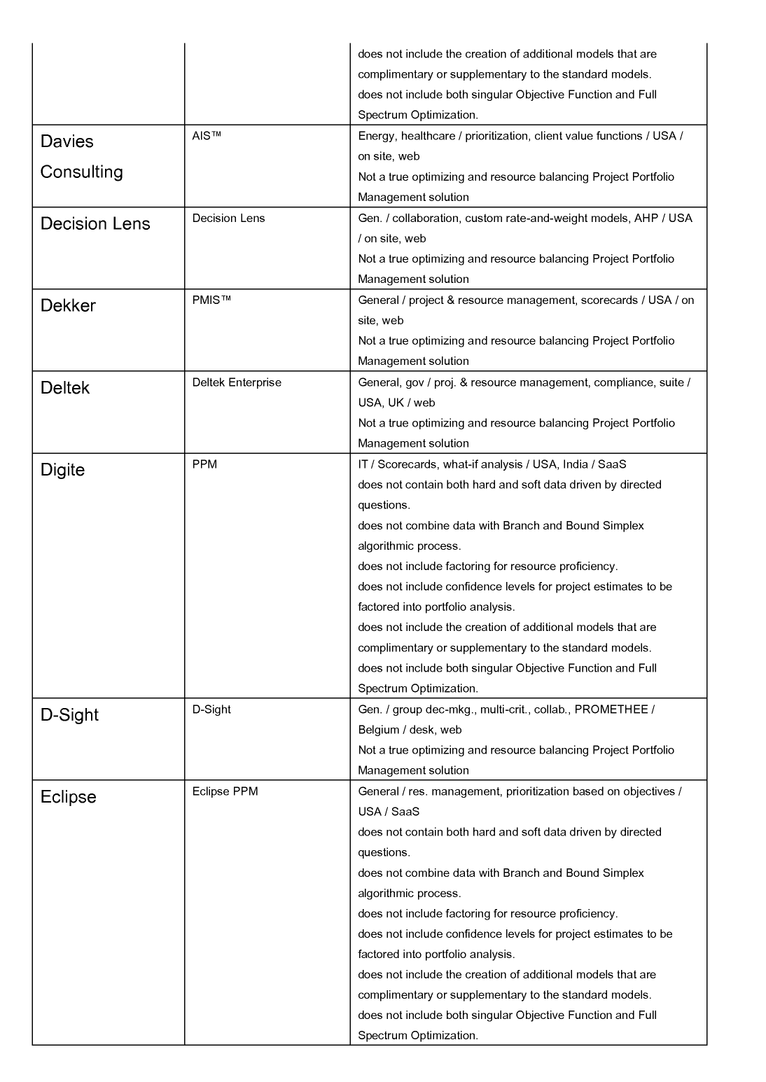

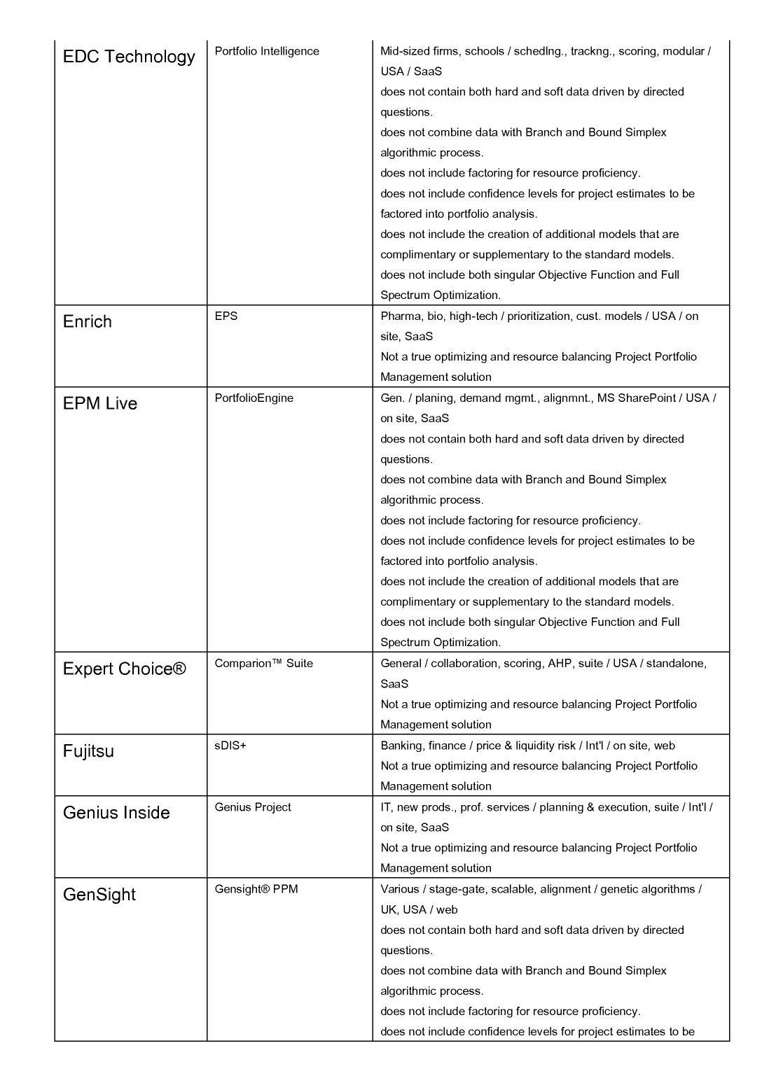

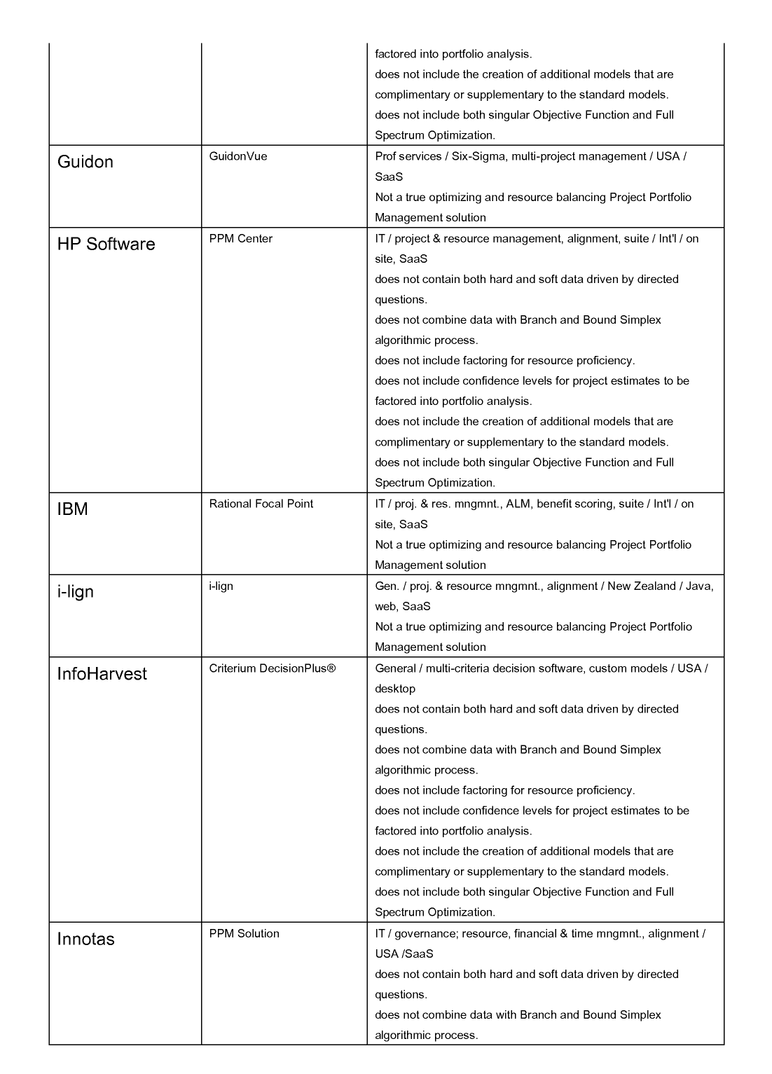

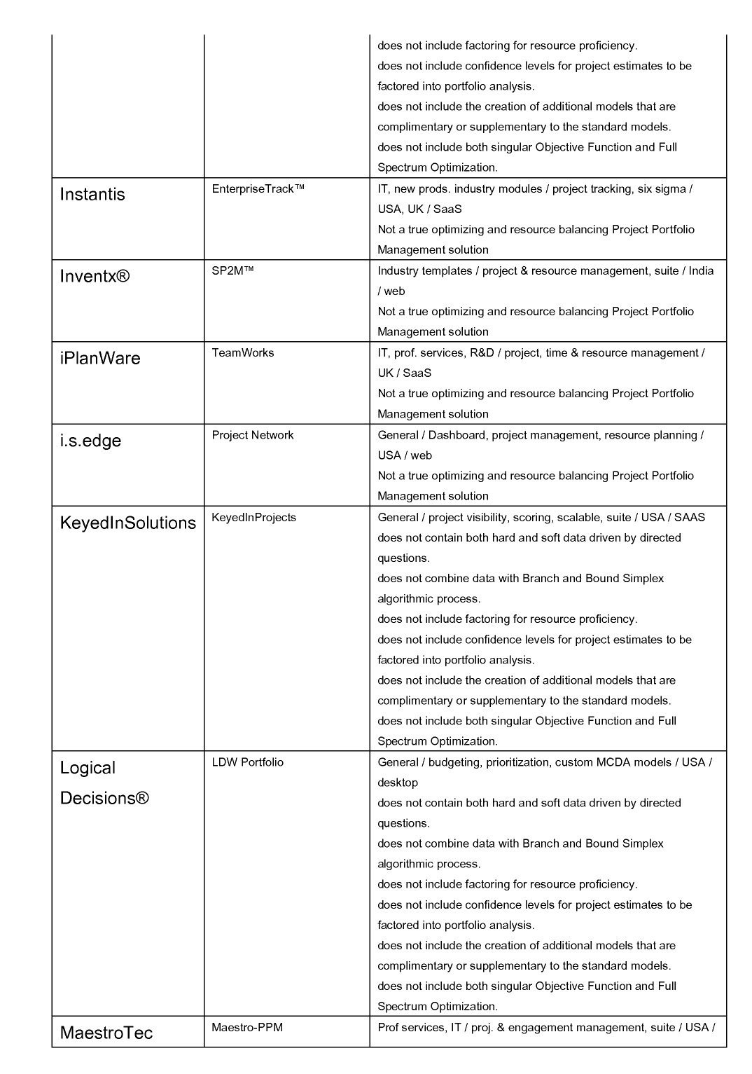

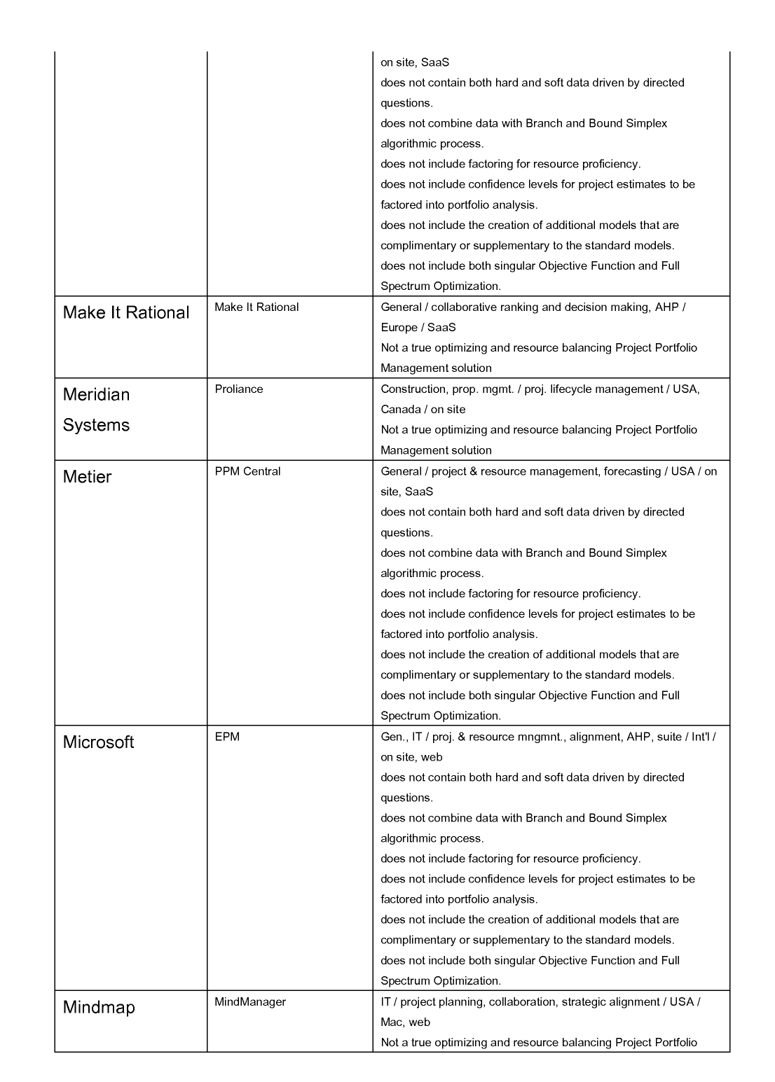

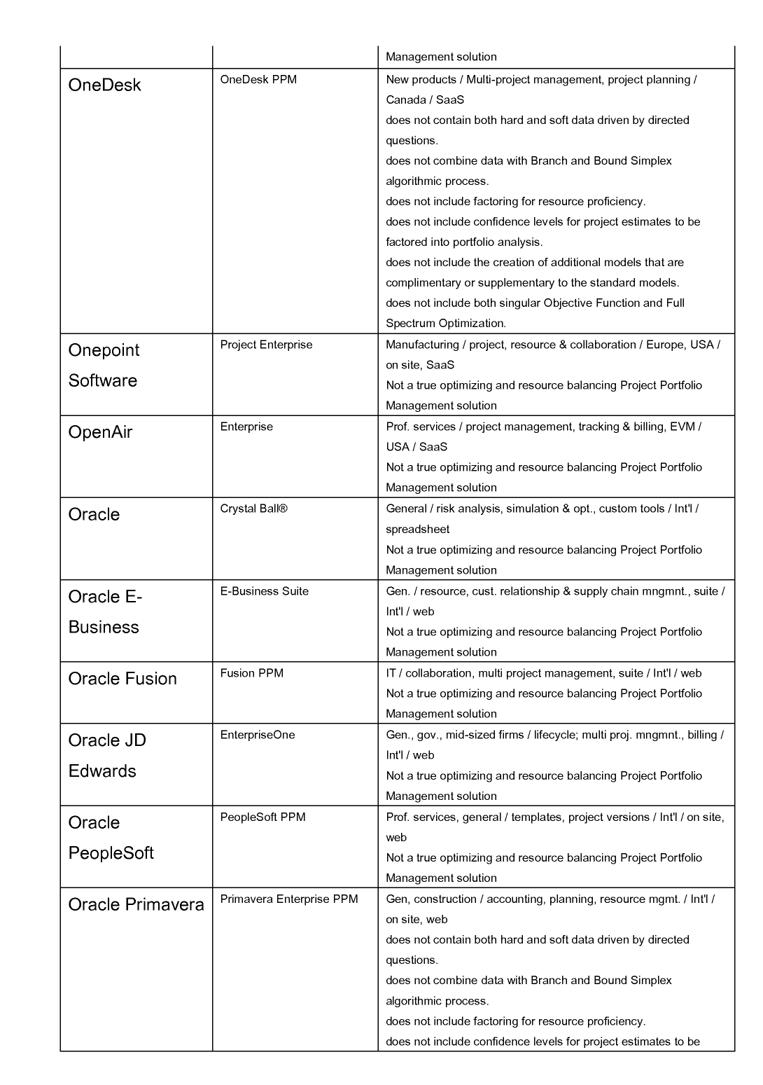

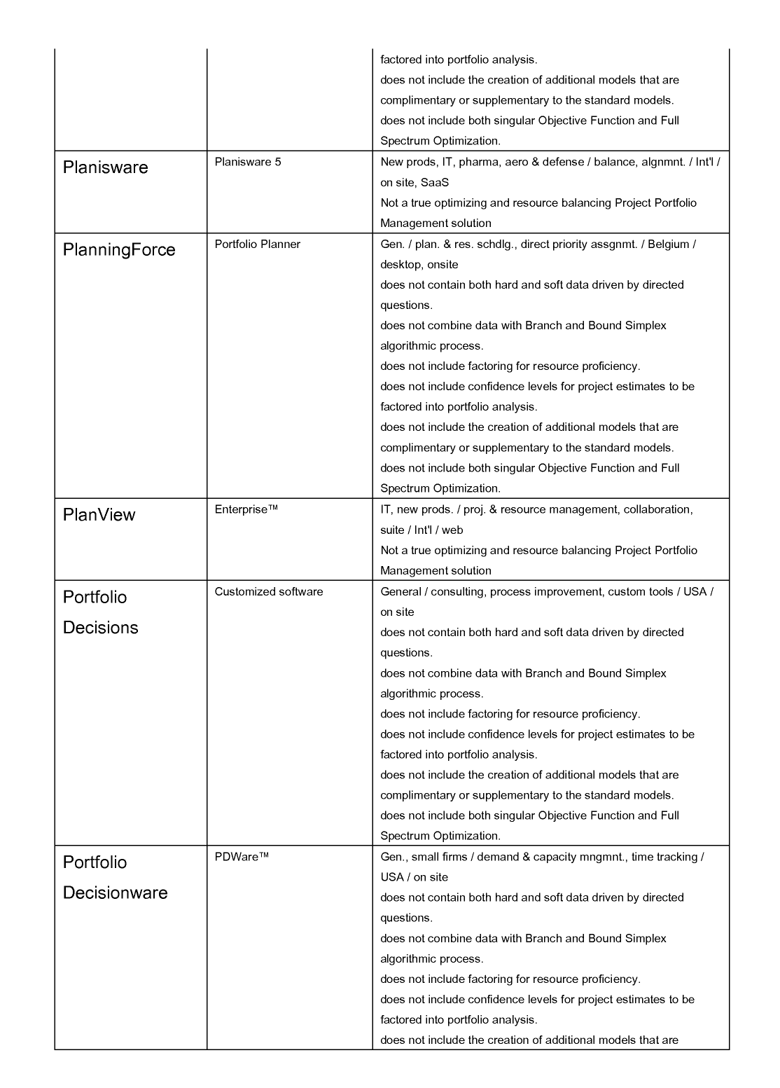

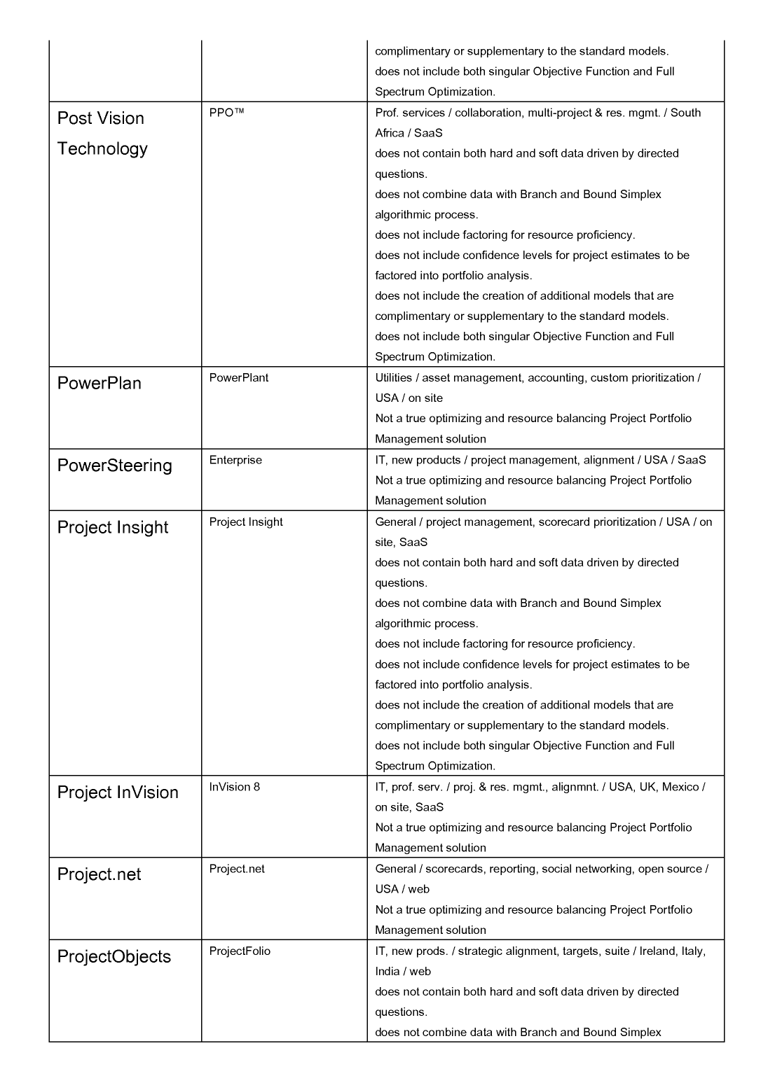

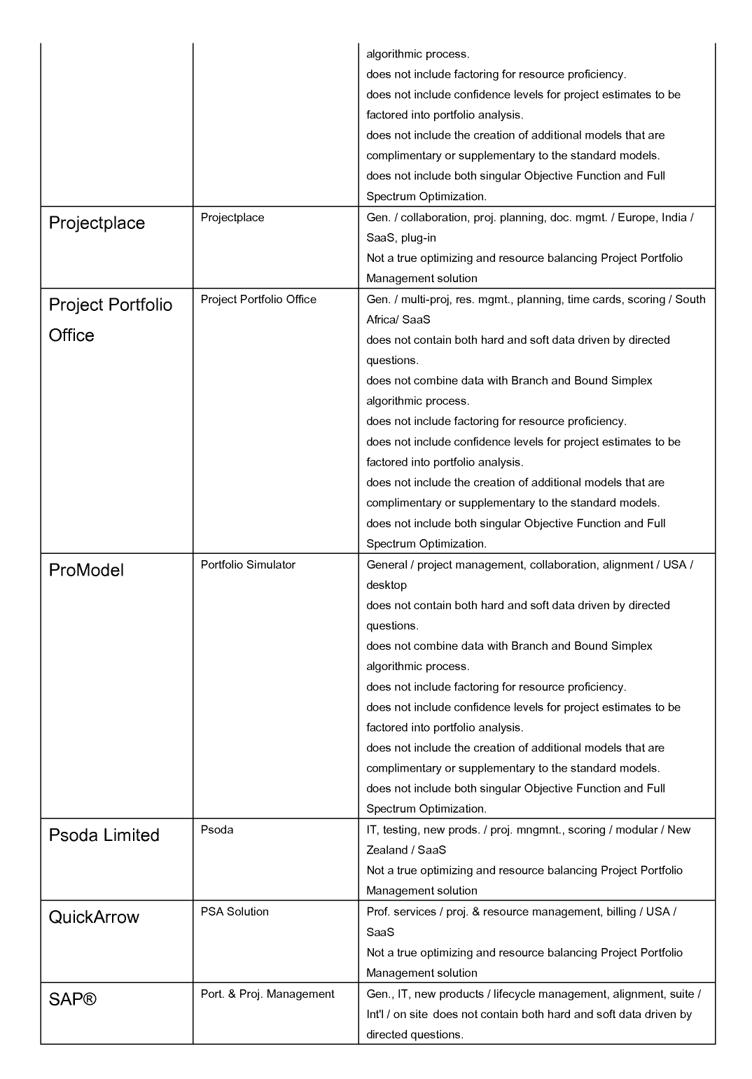

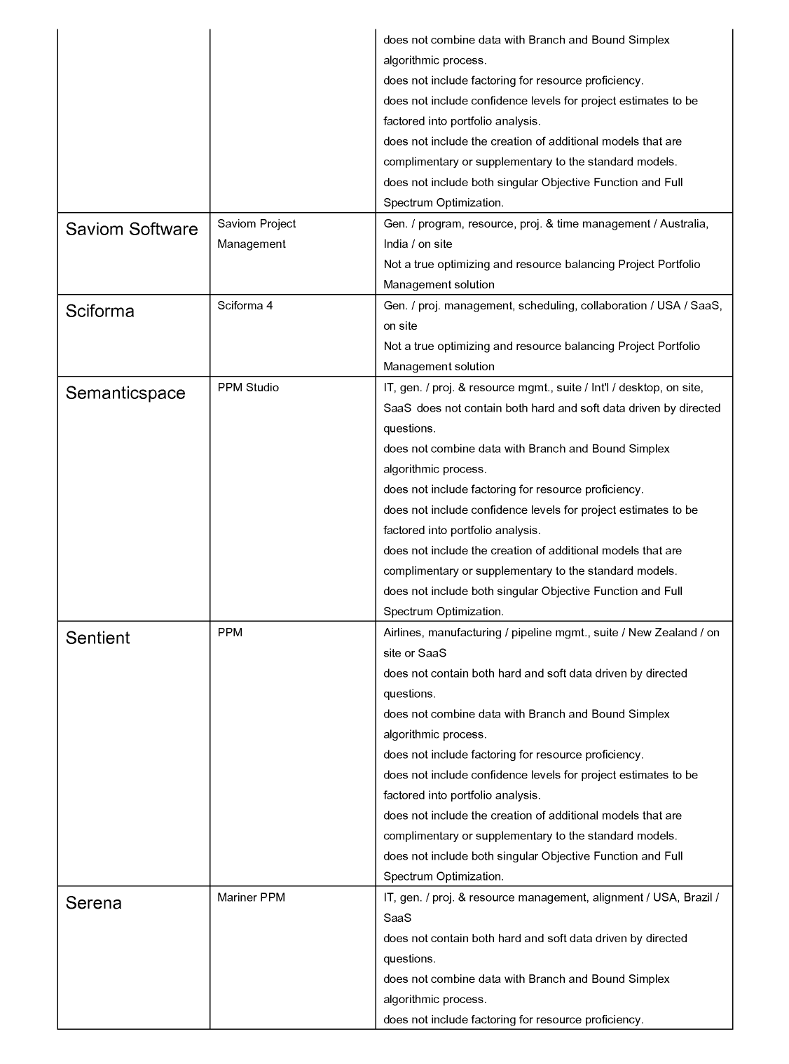

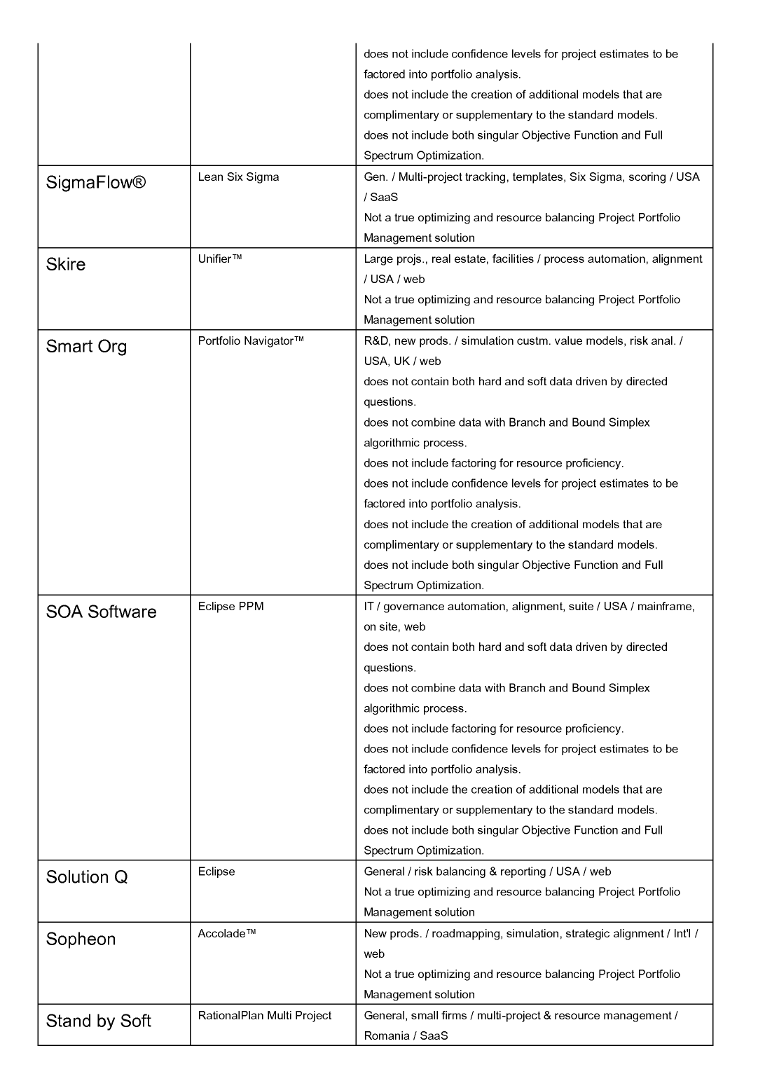

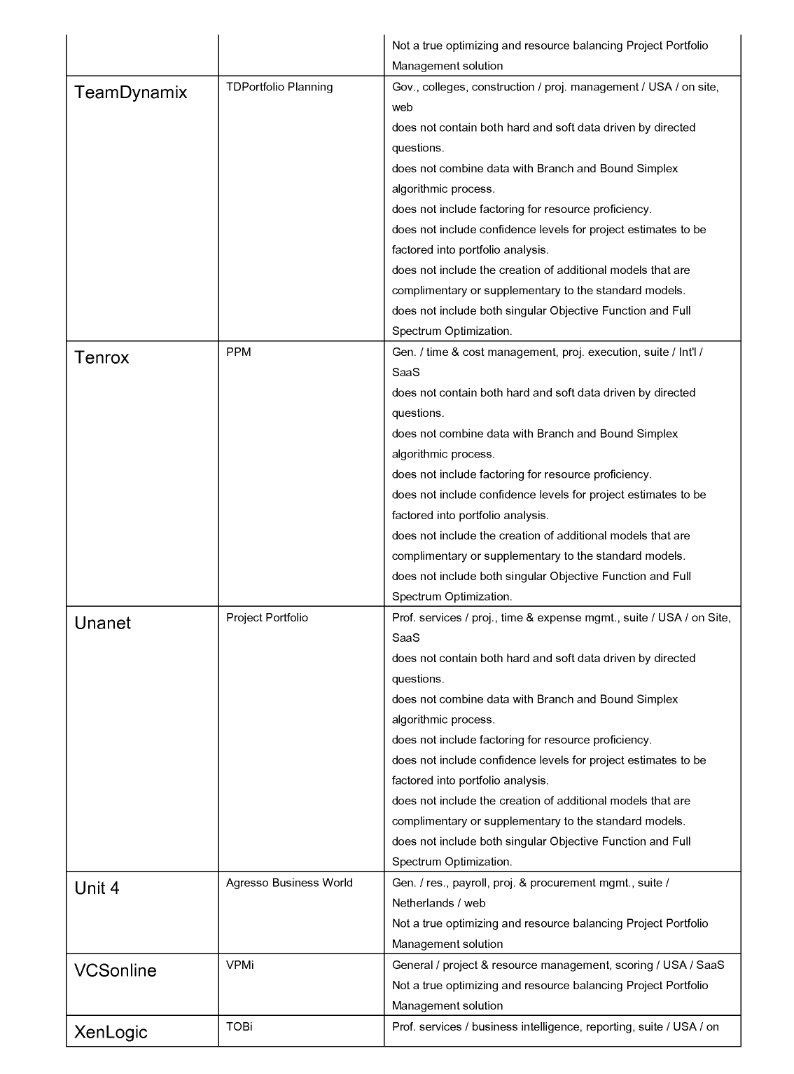

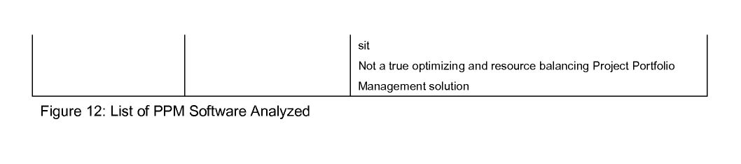

FIG. 11 provides additional details into the financial model underlying the project portfolio management system. Funding sources are defined and associated with business units that are the entities of record for the portfolio. In turn these spawn budgets which are based on individual project accounts both planned and preexisting allocations. The business unit remains the main point of initiation for all the project portfolio management data. It is the basis for all the budgets that are set in a specific period, either current or planned, fed by the individual account data. The results of work estimation and allocation on budget is a cost estimation allocation which is the basic work entity or project based financing. Resources, work allocations, roles and work estimate allocations are continually reassessed throughout the balancing process in creating preliminary estimates.

A log file demonstrating a problem being solved with output from the algorithm is shown in attachment A at the end of this document. It depicts a scenario of 25 projects loaded with project name, value, cost, contribution, inclusions, exclusions as input variables and a reports a calculated disposition. For resource balancing, it loads 9 resource types based on roles using resource type, capacity, commitment, constraints and aggregate demand as input variables.

Those skilled in the art who have reviewed the present disclosure will readily appreciate that the system and methods defined above can be implemented on a variety of computer hardware and software. The communication within the solutions domain can take place over the Internet, an intranet, or any other suitable network. The key differentiators of the system and methods are as follows:

(a) its comprehensive approach to purpose directed data gathering both initially and on an ongoing basis to ensure that all the pertinent facts are being evaluated and;

(b) the complex and extensible bound and branch algorithm which make sophisticated and intelligent optimizations based on this inclusive data and;

(c) the resource utilization planner which looks at the bigger picture of workforce efficiency without sacrificing the ability to implement specific overrides based on critical needs.

The preferred embodiment of the invention has been described in detail above. Those skilled in the art who have reviewed the present disclosure will readily appreciate that the features of the invention can be implemented in a different order from that disclosed herein. Therefore, the present invention should be construed as limited only by the appended claims.

Attachment A:
Log File Demonstrating a Problem Being Solved with Output from the Algorithm
Solution: Scenario #1
25 projects loaded

| # | Name | Value | Cost | Contribution | Include | Exclude | Selected | Disposition |
|---|---|---|---|---|---|---|---|---|
| 1: | Accrual based management reports: | 2300000 | 2608150 | 0 | False | False | False | Optimize |
| | Phase 1 - subcontractor expense(885) | | | | | | | |
| 2: | ITMPI/CAI Website Redesign(1158) | 125000 | 1278950 | 0 | False | False | False | Optimize |
| 3: | Indirect Time Validation | 1250000 | 2779350 | 0 | False | False | False | Optimize |
| | (Hourly Payroll)(1235) | | | | | | | |
| 4: | MyCAI 2.0(1246) | 500000 | 600110 | 0 | False | False | False | Optimize |
| 5: | Adding Quantitative Data to APO | 4250000 | 1682660 | 0 | False | False | False | Optimize |
| | from External Sources(1271) | | | | | | | |
| 6: | Sub-contractor Expense Report | 2670000 | 1288150 | 0 | False | False | False | Optimize |
| | (MSS Non-Labor Expenses)(1310) | | | | | | | |
| 7: | Optimize CorpSys Batch Schedule(1312) | 1000000 | 957850 | 0 | False | False | False | Optimize |
| 8: | Unilever Electronic Invoicing(1314) | 875000 | 1145515 | 0 | False | False | False | Optimize |
| 9: | Purchase Order (PO) Rewrite(1317) | 1200000 | 1265300 | 0 | False | True | False | Exclude |
| 10: | Internet Support(1319) | 2500000 | 8685 | 0 | False | False | False | Optimize |
| 11: | MTK Development(1327) | 500000 | 260805 | 0 | False | False | False | Optimize |
| 12: | DBE Report(1331) | 250000 | 629250 | 0 | False | True | False | Exclude |
| 13: | MTK - Associate Information/Sub-vendor | 1245000 | 336005 | 0 | False | False | False | Optimize |
| | Information Page(1334) | | | | | | | |
| 14: | MTK - Associate Information/Asociate | 45000 | 245610 | 0 | False | False | False | Optimize |
| | Information for Subcontractors(1335) | | | | | | | |
| 15: | MTK - Financial/Phase 2 Forecasting(1337) | 500000 | 340475 | 0 | False | False | False | Optimize |
| 16: | MTK - Job Information/Extended Job | 550000 | 36405 | 0 | False | False | False | Optimize |
| | Info View for Managers(1338) | | | | | | | |
| 17: | myCAI Support(1339) | 150000 | 12445 | 0 | False | False | False | Optimize |
| 18: | Work Location(1344) | 2000000 | 882080 | 0 | False | False | False | Optimize |
| 19: | ITMI Development Support(1351) | 75000 | 391375 | 0 | False | False | False | Optimize |
| 20: | Intranet Support(1361) | 7500000 | 404420 | 0 | False | False | False | Optimize |
| 21: | ITMPI Filter Feature(1362) | 0 | 349370 | 0 | False | True | False | Exclude |
| 22: | ITMPI PowerPoint Security(1363) | 15000 | 1000 | 0 | False | False | False | Optimize |
| 23: | Benefits - Dependent Coverage(1364) | 1200000 | 1060065 | 0 | False | False | False | Optimize |
| 24: | Tracer 2400 - 161 Defects retrofit(1365) | 1600000 | 2612500 | 0 | False | True | False | Exclude |
| 25: | Tracer 2.6.0 Estimating Task - | 4000000 | 1978805 | 0 | False | False | False | Optimize |
| | Enhancement(1366) | | | | | | | |

9 resource types (roles)loaded

| # | Resource Type | Capacity | Committed | Constrained | Available | Aggregate | Demand |
|---|---|---|---|---|---|---|---|
| 1: | Technical Team Member(ID = 1) | 232320 | 0 | True | 232320 | 315864 | Total requirement |
| | | | | | | | exceeds capacity |
| 2: | Project Manager(ID = 2) | 11040 | 1040 | False | 10000 | 14159 | Total requirement |
| | | | | | | | exceeds capacity |
| 3: | Functional Manager(ID = 7) | 7680 | 0 | True | 7680 | 10967 | Total requirement |
| | | | | | | | exceeds capacity |
| 4: | Test/Support(ID = 8) | 15552 | 0 | True | 15552 | 19556 | Total requirement |
| | | | | | | | exceeds capacity |
| 5: | Customer Support(ID= 10) | 55680 | 0 | True | 55680 | 49724 | |
| 6: | Technical Consultant(ID = 25) | 0 | 0 | False | 0 | 3602 | Total requirement |
| | | | | | | | exceeds capacity |
| 7: | Developer(ID = 26) | 0 | 0 | True | 0 | 0 | |
| 8: | Documentation & Education Specialist(ID = 28) | 5760 | 0 | False | 5760 | 19229 | Total requirement |
| | | | | | | | exceeds capacity |
| 9: | Business Analyst(ID = 34) | 10560 | 0 | True | 10560 | 12010 | Total requirement |
| | | | | | | | exceeds capacity |

7 resources are imposing constraints
3/12/2013 2:07:37 PM Analysis starting . . .
0 projects are manually Included
4 projects are manually Excluded
As a consequence the Solution Value is constrained to be between 0 and 33250000

| | | |
|---|---|---|
| Starting Solution 1 | | |
| 0: | 1 ? ? ? ? ? ? ? 0 ? ? 0 ? ? ? ? ? ? ? ? 0 ? ? 0 ? | Value = 2300000 |
| 1: | 1 1 ? ? ? ? ? ? 0 ? ? 0 ? ? ? ? ? ? ? ? 0 ? ? 0 ? | Value = 2425000 |
| 2: | 1 1 1 ? ? ? ? ? 0 ? ? 0 ? ? ? ? ? ? ? ? 0 ? ? 0 ? | Value = 3675000 |
| 3: | 1 1 1 1 ? ? ? ? 0 ? ? 0 ? ? ? ? ? ? ? ? 0 ? ? 0 ? | Infeasible |
| 3: | 1 1 1 0 1 ? ? ? 0 ? ? 0 ? ? ? ? ? ? ? ? 0 ? ? 0 ? | Infeasible |
| 3: | 1 1 1 0 0 1 ? ? 0 ? ? 0 ? ? ? ? ? ? ? ? 0 ? ? 0 ? | Infeasible |
| 3: | 1 1 1 0 0 0 1 ? 0 ? ? 0 ? ? ? ? ? ? ? ? 0 ? ? 0 ? | Infeasible |
| 3: | 1 1 1 0 0 0 0 1 0 ? ? 0 ? ? ? ? ? ? ? ? 0 ? ? 0 ? | Infeasible |
| 3: | 1 1 1 0 0 0 0 0 0 1 ? 0 ? ? ? ? ? ? ? ? 0 ? ? 0 ? | Value = 6175000 |
| 4: | 1 1 1 0 0 0 0 0 0 1 1 0 ? ? ? ? ? ? ? ? 0 ? ? 0 ? | Infeasible |
| 4: | 1 1 1 0 0 0 0 0 0 1 0 0 1 ? ? ? ? ? ? ? 0 ? ? 0 ? | Value = 7420000 |
| 5: | 1 1 1 0 0 0 0 0 0 1 0 0 1 1 ? ? ? ? ? ? 0 ? ? 0 ? | Value = 7465000 |
| 6: | 1 1 1 0 0 0 0 0 0 1 0 0 1 1 1 ? ? ? ? ? 0 ? ? 0 ? | Infeasible |
| 6: | 1 1 1 0 0 0 0 0 0 1 0 0 1 1 0 1 ? ? ? ? 0 ? ? 0 ? | Value = 8015000 |
| 7: | 1 1 1 0 0 0 0 0 0 1 0 0 1 1 0 1 1 ? ? ? 0 ? ? 0 ? | Value = 8165000 |
| 8: | 1 1 1 0 0 0 0 0 0 1 0 0 1 1 0 1 1 1 ? ? 0 ? ? 0 ? | Infeasible |
| 8: | 1 1 1 0 0 0 0 0 0 1 0 0 1 1 0 1 1 0 1 ? 0 ? ? 0 ? | Infeasible |
| 8: | 1 1 1 0 0 0 0 0 0 1 0 0 1 1 0 1 1 0 0 1 0 ? ? 0 ? | Value = 15665000 |
| 9: | 1 1 1 0 0 0 0 0 0 1 0 0 1 1 0 1 1 0 0 1 0 1 ? 0 ? | Value = 15680000 |
| 10: | 1 1 1 0 0 0 0 0 0 1 0 0 1 1 0 1 1 0 0 1 0 1 1 0 ? | Infeasible |
| 10: | 1 1 1 0 0 0 0 0 0 1 0 0 1 1 0 1 1 0 0 1 0 1 0 0 1 | Infeasible |
| 9: | 1 1 1 0 0 0 0 0 0 1 0 0 1 1 0 1 1 0 0 1 0 1 1 0 ? | Infeasible Fathomed |
| 9: | 1 1 1 0 0 0 0 0 0 1 0 0 1 1 0 1 1 0 0 1 0 1 0 0 1 | Infeasible Fathomed |
| 8: | 1 1 1 0 0 0 0 0 0 1 0 0 1 1 0 1 1 0 0 1 0 1 ? 0 ? | Value = 15680000 (Maximal) Fathomed |
| 8: | 1 1 1 0 0 0 0 0 0 1 0 0 1 1 0 1 1 0 0 1 0 0 1 0 ? | Infeasible Fathomed |
| 8: | 1 1 1 0 0 0 0 0 0 1 0 0 1 1 0 1 1 0 0 1 0 0 0 0 1 | Infeasible Fathomed |
| 7: | 1 1 1 0 0 0 0 0 0 1 0 0 1 1 0 1 1 1 ? ? 0 ? ? 0 ? | Infeasible Fathomed |
| 7: | 1 1 1 0 0 0 0 0 0 1 0 0 1 1 0 1 1 0 1 ? 0 ? ? 0 ? | Infeasible Fathomed |
| 7: | 1 1 1 0 0 0 0 0 0 1 0 0 1 1 0 1 1 0 0 1 0 ? ? 0 ? | Value = 15665000 Fathomed |
| 7: | 1 1 1 0 0 0 0 0 0 1 0 0 1 1 0 1 1 0 0 0 0 1 ? 0 ? | Value = 8180000 Fathomed |
| 7: | 1 1 1 0 0 0 0 0 0 1 0 0 1 1 0 1 1 0 0 0 0 0 1 0 ? | Value = 9365000 Fathomed |
| 7: | 1 1 1 0 0 0 0 0 0 1 0 0 1 1 0 1 1 0 0 0 0 0 0 0 1 | Infeasible Fathomed |
| 6: | 1 1 1 0 0 0 0 0 0 1 0 0 1 1 0 1 1 ? ? ? 0 ? ? 0 ? | Value = 8165000 Fathomed |
| 6: | 1 1 1 0 0 0 0 0 0 1 0 0 1 1 0 1 0 1 ? ? 0 ? ? 0 ? | Infeasible Fathomed |
| 6: | 1 1 1 0 0 0 0 0 0 1 0 0 1 1 0 1 0 0 1 ? 0 ? ? 0 ? | Infeasible Fathomed |
| 6: | 1 1 1 0 0 0 0 0 0 1 0 0 1 1 0 1 0 0 0 1 0 ? ? 0 ? | Value = 15515000 Fathomed |
| 6: | 1 1 1 0 0 0 0 0 0 1 0 0 1 1 0 1 0 0 0 0 0 1 ? 0 ? | Value = 8030000 Fathomed |
| 6: | 1 1 1 0 0 0 0 0 0 1 0 0 1 1 0 1 0 0 0 0 0 0 1 0 ? | Value = 9215000 Fathomed |
| 6: | 1 1 1 0 0 0 0 0 0 1 0 0 1 1 0 1 0 0 0 0 0 0 0 0 1 | Infeasible Fathomed |
| 5: | 1 1 1 0 0 0 0 0 0 1 0 0 1 1 1 ? ? ? ? ? 0 ? ? 0 ? | Infeasible Fathomed |
| 5: | 1 1 1 0 0 0 0 0 0 1 0 0 1 1 0 1 ? ? ? ? 0 ? ? 0 ? | Value = 8015000 Fathomed |
| 5: | 1 1 1 0 0 0 0 0 0 1 0 0 1 1 0 0 1 ? ? ? 0 ? ? 0 ? | Value = 7615000 Fathomed |
| 5: | 1 1 1 0 0 0 0 0 0 1 0 0 1 1 0 0 0 1 ? ? 0 ? ? 0 ? | Infeasible Fathomed |
| 5: | 1 1 1 0 0 0 0 0 0 1 0 0 1 1 0 0 0 0 1 ? 0 ? ? 0 ? | Infeasible Fathomed |
| 5: | 1 1 1 0 0 0 0 0 0 1 0 0 1 1 0 0 0 0 0 1 0 ? ? 0 ? | Value = 14965000 Fathomed |
| 5: | 1 1 1 0 0 0 0 0 0 1 0 0 1 1 0 0 0 0 0 0 0 1 ? 0 ? | Value = 7480000 Fathomed |
| 5: | 1 1 1 0 0 0 0 0 0 1 0 0 1 1 0 0 0 0 0 0 0 0 1 0 ? | Value = 8665000 Fathomed |
| 5: | 1 1 1 0 0 0 0 0 0 1 0 0 1 1 0 0 0 0 0 0 0 0 0 0 1 | Infeasible Fathomed |
| 4: | 1 1 1 0 0 0 0 0 0 1 0 0 1 1 ? ? ? ? ? ? 0 ? ? 0 ? | Value = 7465000 Fathomed |
| 4: | 1 1 1 0 0 0 0 0 0 1 0 0 1 0 1 ? ? ? ? ? 0 ? ? 0 ? | Value = 7920000 Fathomed |
| 4: | 1 1 1 0 0 0 0 0 0 1 0 0 1 0 0 1 ? ? ? ? 0 ? ? 0 ? | Value = 7970000 Fathomed |
| 4: | 1 1 1 0 0 0 0 0 0 1 0 0 1 0 0 0 1 ? ? ? 0 ? ? 0 ? | Value = 7570000 Fathomed |
| 4: | 1 1 1 0 0 0 0 0 0 1 0 0 1 0 0 0 0 1 ? ? 0 ? ? 0 ? | Infeasible Fathomed |
| 4: | 1 1 1 0 0 0 0 0 0 1 0 0 1 0 0 0 0 0 1 ? 0 ? ? 0 ? | Infeasible Fathomed |
| 4: | 1 1 1 0 0 0 0 0 0 1 0 0 1 0 0 0 0 0 0 1 0 ? ? 0 ? | Value = 14920000 Fathomed |
| 4: | 1 1 1 0 0 0 0 0 0 1 0 0 1 0 0 0 0 0 0 0 0 1 ? 0 ? | Value = 7435000 Fathomed |
| 4: | 1 1 1 0 0 0 0 0 0 1 0 0 1 0 0 0 0 0 0 0 0 0 1 0 ? | Value = 8620000 Fathomed |
| 4: | 1 1 1 0 0 0 0 0 0 1 0 0 1 0 0 0 0 0 0 0 0 0 0 0 1 | Infeasible Fathomed |
| 3: | 1 1 1 0 0 0 0 0 0 1 1 0 ? ? ? ? ? ? ? ? 0 ? ? 0 ? | Infeasible Fathomed |
| 3: | 1 1 1 0 0 0 0 0 0 1 0 0 1 ? ? ? ? ? ? ? 0 ? ? 0 ? | Value = 7420000 Fathomed |
| 3: | 1 1 1 0 0 0 0 0 0 1 0 0 0 1 ? ? ? ? ? ? 0 ? ? 0 ? | Value = 6220000 Fathomed |
| 3: | 1 1 1 0 0 0 0 0 0 1 0 0 0 0 1 ? ? ? ? ? 0 ? ? 0 ? | Value = 6675000 Fathomed |
| 3: | 1 1 1 0 0 0 0 0 0 1 0 0 0 0 0 1 ? ? ? ? 0 ? ? 0 ? | Value = 6725000 Fathomed |
| 3: | 1 1 1 0 0 0 0 0 0 1 0 0 0 0 0 0 1 ? ? ? 0 ? ? 0 ? | Value = 6325000 Fathomed |
| 3: | 1 1 1 0 0 0 0 0 0 1 0 0 0 0 0 0 0 1 ? ? 0 ? ? 0 ? | Infeasible Fathomed |
| 3: | 1 1 1 0 0 0 0 0 0 1 0 0 0 0 0 0 0 0 1 ? 0 ? ? 0 ? | Infeasible Fathomed |
| 3: | 1 1 1 0 0 0 0 0 0 1 0 0 0 0 0 0 0 0 0 1 0 ? ? 0 ? | Value = 13675000 Fathomed |
| 3: | 1 1 1 0 0 0 0 0 0 1 0 0 0 0 0 0 0 0 0 0 0 1 ? 0 ? | Value = 6190000 Fathomed |
| 3: | 1 1 1 0 0 0 0 0 0 1 0 0 0 0 0 0 0 0 0 0 0 0 1 0 ? | Value = 7375000 Fathomed |
| 3: | 1 1 1 0 0 0 0 0 0 1 0 0 0 0 0 0 0 0 0 0 0 0 0 0 1 | Infeasible Fathomed |
| 2: | 1 1 1 1 ? ? ? ? 0 ? ? 0 ? ? ? ? ? ? ? ? 0 ? ? 0 ? | Infeasible Fathomed |
| 2: | 1 1 1 0 1 ? ? ? 0 ? ? 0 ? ? ? ? ? ? ? ? 0 ? ? 0 ? | Infeasible Fathomed |
| 2: | 1 1 1 0 0 1 ? ? 0 ? ? 0 ? ? ? ? ? ? ? ? 0 ? ? 0 ? | Infeasible Fathomed |
| 2: | 1 1 1 0 0 0 1 ? 0 ? ? 0 ? ? ? ? ? ? ? ? 0 ? ? 0 ? | Infeasible Fathomed |
| 2: | 1 1 1 0 0 0 0 1 0 ? ? 0 ? ? ? ? ? ? ? ? 0 ? ? 0 ? | Infeasible Fathomed |
| 2: | 1 1 1 0 0 0 0 0 0 1 ? 0 ? ? ? ? ? ? ? ? 0 ? ? 0 ? | Value = 6175000 Fathomed |
| 2: | 1 1 1 0 0 0 0 0 0 0 1 0 ? ? ? ? ? ? ? ? 0 ? ? 0 ? | Infeasible Fathomed |
| 2: | 1 1 1 0 0 0 0 0 0 0 0 0 1 ? ? ? ? ? ? ? 0 ? ? 0 ? | Value = 4920000 Fathomed |
| 2: | 1 1 1 0 0 0 0 0 0 0 0 0 0 1 ? ? ? ? ? ? 0 ? ? 0 ? | Value = 3720000 Fathomed |
| 2: | 1 1 1 0 0 0 0 0 0 0 0 0 0 0 1 ? ? ? ? ? 0 ? ? 0 ? | Value = 4175000 Fathomed |
| 2: | 1 1 1 0 0 0 0 0 0 0 0 0 0 0 0 1 ? ? ? ? 0 ? ? 0 ? | Value = 4225000 Fathomed |
| 2: | 1 1 1 0 0 0 0 0 0 0 0 0 0 0 0 0 1 ? ? ? 0 ? ? 0 ? | Value = 3825000 Fathomed |
| 2: | 1 1 1 0 0 0 0 0 0 0 0 0 0 0 0 0 0 1 ? ? 0 ? ? 0 ? | Infeasible Fathomed |
| 2: | 1 1 1 0 0 0 0 0 0 0 0 0 0 0 0 0 0 0 1 ? 0 ? ? 0 ? | Infeasible Fathomed |
| 2: | 1 1 1 0 0 0 0 0 0 0 0 0 0 0 0 0 0 0 0 1 0 ? ? 0 ? | Value = 11175000 Fathomed |
| 2: | 1 1 1 0 0 0 0 0 0 0 0 0 0 0 0 0 0 0 0 0 0 1 ? 0 ? | Value = 3690000 Fathomed |
| 2: | 1 1 1 0 0 0 0 0 0 0 0 0 0 0 0 0 0 0 0 0 0 0 1 0 ? | Value = 4875000 Fathomed |
| 2: | 1 1 1 0 0 0 0 0 0 0 0 0 0 0 0 0 0 0 0 0 0 0 0 0 1 | Infeasible Fathomed |
| 1: | 1 1 1 ? ? ? ? ? 0 ? ? 0 ? ? ? ? ? ? ? ? 0 ? ? 0 ? | Value = 3675000 Fathomed |
| 1: | 1 1 0 1 ? ? ? ? 0 ? ? 0 ? ? ? ? ? ? ? ? 0 ? ? 0 ? | Value = 2925000 Fathomed |
| 1: | 1 1 0 0 1 ? ? ? 0 ? ? 0 ? ? ? ? ? ? ? ? 0 ? ? 0 ? | Value = 6675000 Fathomed |
| 1: | 1 1 0 0 0 1 ? ? 0 ? ? 0 ? ? ? ? ? ? ? ? 0 ? ? 0 ? | Value = 5095000 Fathomed |
| 1: | 1 1 0 0 0 0 1 ? 0 ? ? 0 ? ? ? ? ? ? ? ? 0 ? ? 0 ? | Value = 3425000 Fathomed |
| 1: | 1 1 0 0 0 0 0 1 0 ? ? 0 ? ? ? ? ? ? ? ? 0 ? ? 0 ? | Value = 3300000 Fathomed |
| 1: | 1 1 0 0 0 0 0 0 0 1 ? 0 ? ? ? ? ? ? ? ? 0 ? ? 0 ? | Value = 4925000 Fathomed |
| 1: | 1 1 0 0 0 0 0 0 0 0 1 0 ? ? ? ? ? ? ? ? 0 ? ? 0 ? | Infeasible Fathomed |
| 1: | 1 1 0 0 0 0 0 0 0 0 0 0 1 ? ? ? ? ? ? ? 0 ? ? 0 ? | Value = 3670000 Fathomed |
| 1: | 1 1 0 0 0 0 0 0 0 0 0 0 0 1 ? ? ? ? ? ? 0 ? ? 0 ? | Value = 2470000 Fathomed |
| 1: | 1 1 0 0 0 0 0 0 0 0 0 0 0 0 1 ? ? ? ? ? 0 ? ? 0 ? | Value = 2925000 Fathomed |
| 1: | 1 1 0 0 0 0 0 0 0 0 0 0 0 0 0 1 ? ? ? ? 0 ? ? 0 ? | Value = 2975000 Fathomed |
| 1: | 1 1 0 0 0 0 0 0 0 0 0 0 0 0 0 0 1 ? ? ? 0 ? ? 0 ? | Value = 2575000 Fathomed |
| 1: | 1 1 0 0 0 0 0 0 0 0 0 0 0 0 0 0 0 1 ? ? 0 ? ? 0 ? | Value = 4425000 Fathomed |
| 1: | 1 1 0 0 0 0 0 0 0 0 0 0 0 0 0 0 0 0 1 ? 0 ? ? 0 ? | Value = 2500000 Fathomed |
| 1: | 1 1 0 0 0 0 0 0 0 0 0 0 0 0 0 0 0 0 0 1 0 ? ? 0 ? | Value = 9925000 Fathomed |
| 1: | 1 1 0 0 0 0 0 0 0 0 0 0 0 0 0 0 0 0 0 0 0 1 ? 0 ? | Value = 2440000 Fathomed |
| 1: | 1 1 0 0 0 0 0 0 0 0 0 0 0 0 0 0 0 0 0 0 0 0 1 0 ? | Value = 3625000 Fathomed |
| 1: | 1 1 0 0 0 0 0 0 0 0 0 0 0 0 0 0 0 0 0 0 0 0 0 0 1 | Value = 6425000 Fathomed |
| Starting Solution 2 | | |
| 0: | ? 1 ? ? ? ? ? ? 0 ? ? 0 ? ? ? ? ? ? ? ? 0 ? ? 0 ? | Value = 125000 |
| 1: | 0 1 1 ? ? ? ? ? 0 ? ? 0 ? ? ? ? ? ? ? ? 0 ? ? 0 ? | Value = 1375000 |
| 2: | 0 1 1 1 ? ? ? ? 0 ? ? 0 ? ? ? ? ? ? ? ? 0 ? ? 0 ? | Value = 18175000 |
| 3: | 0 1 1 1 1 ? ? ? 0 ? ? 0 ? ? ? ? ? ? ? ? 0 ? ? 0 ? | Value = 6125000 |
| 4: | 0 1 1 1 1 1 ? ? 0 ? ? 0 ? ? ? ? ? ? ? ? 0 ? ? 0 ? | Infeasible |
| 4: | 0 1 1 1 1 0 1 ? 0 ? ? 0 ? ? ? ? ? ? ? ? 0 ? ? 0 ? | Value = 7125000 |
| 5: | 0 1 1 1 1 0 1 1 0 ? ? 0 ? ? ? ? ? ? ? ? 0 ? ? 0 ? | Infeasible |
| 5: | 0 1 1 1 1 0 1 0 0 1 ? 0 ? ? ? ? ? ? ? ? 0 ? ? 0 ? | Value = 9625000 |
| 6: | 0 1 1 1 1 0 1 0 0 1 1 0 ? ? ? ? ? ? ? ? 0 ? ? 0 ? | Infeasible |
| 6: | 0 1 1 1 1 0 1 0 0 1 0 0 1 ? ? ? ? ? ? ? 0 ? ? 0 ? | Value = 10870000 |
| 7: | 0 1 1 1 1 0 1 0 0 1 0 0 1 1 ? ? ? ? ? ? 0 ? ? 0 ? | Infeasible |
| 7: | 0 1 1 1 1 0 1 0 0 1 0 0 1 0 1 ? ? ? ? ? 0 ? ? 0 ? | Value = 11370000 |
| 8: | 0 1 1 1 1 0 1 0 0 1 0 0 1 0 1 1 ? ? ? ? 0 ? ? 0 ? | Infeasible |
| 8: | 0 1 1 1 1 0 1 0 0 1 0 0 1 0 1 0 1 ? ? ? 0 ? ? 0 ? | Value = 11520000 |
| 9: | 0 1 1 1 1 0 1 0 0 1 0 0 1 0 1 0 1 1 ? ? 0 ? ? 0 ? | Infeasible |
| 9: | 0 1 1 1 1 0 1 0 0 1 0 0 1 0 1 0 1 0 1 ? 0 ? ? 0 ? | Infeasible |
| 9: | 0 1 1 1 1 0 1 0 0 1 0 0 1 0 1 0 1 0 0 1 0 ? ? 0 ? | Infeasible |
| 9: | 0 1 1 1 1 0 1 0 0 1 0 0 1 0 1 0 1 0 0 0 0 1 ? 0 ? | Value = 11535000 |
| 10: | 0 1 1 1 1 0 1 0 0 1 0 0 1 0 1 0 1 0 0 0 0 1 1 0 ? | Infeasible |
| 10: | 0 1 1 1 1 0 1 0 0 1 0 0 1 0 1 0 1 0 0 0 0 1 0 0 1 | Infeasible |
| 9: | 0 1 1 1 1 0 1 0 0 1 0 0 1 0 1 0 1 0 0 0 0 1 1 0 ? | Infeasible Fathomed |
| 9 | 0 1 1 1 1 0 1 0 0 1 0 0 1 0 1 0 1 0 0 0 0 1 0 0 1 | Infeasible Fathomed |
| 8 | 0 1 1 1 1 0 1 0 0 1 0 0 1 0 1 0 1 1 ? ? 0 ? ? 0 ? | Infeasible Fathomed |
| 8 | 0 1 1 1 1 0 1 0 0 1 0 0 1 0 1 0 1 0 1 ? 0 ? ? 0 ? | Infeasible Fathomed |
| 8 | 0 1 1 1 1 0 1 0 0 1 0 0 1 0 1 0 1 0 0 1 0 ? ? 0 ? | Infeasible Fathomed |
| 8 | 0 1 1 1 1 0 1 0 0 1 0 0 1 0 1 0 1 0 0 0 0 1 ? 0 ? | Value = 11535000 Fathomed |
| 8: | 0 1 1 1 1 0 1 0 0 1 0 0 1 0 1 0 1 0 0 0 0 0 1 0 ? | Infeasible Fathomed |
| 8: | 0 1 1 1 1 0 1 0 0 1 0 0 1 0 1 0 1 0 0 0 0 0 0 0 1 | Infeasible Fathomed |
| 7: | 0 1 1 1 1 0 1 0 0 1 0 0 1 0 1 1 ? ? ? ? 0 ? ? 0 ? | Infeasible Fathomed |
| 7: | 0 1 1 1 1 0 1 0 0 1 0 0 1 0 1 0 1 ? ? ? 0 ? ? 0 ? | Value = 11520000 Fathomed |
| 7: | 0 1 1 1 1 0 1 0 0 1 0 0 1 0 1 0 0 1 ? ? 0 ? ? 0 ? | Infeasible Fathomed |
| 7: | 0 1 1 1 1 0 1 0 0 1 0 0 1 0 1 0 0 0 1 ? 0 ? ? 0 ? | Infeasible Fathomed |
| 7: | 0 1 1 1 1 0 1 0 0 1 0 0 1 0 1 0 0 0 0 1 0 ? ? 0 ? | Value = 18870000 Fathomed |
| 7: | 0 1 1 1 1 0 1 0 0 1 0 0 1 0 1 0 0 0 0 0 0 1 ? 0 ? | Value = 11385000 Fathomed |
| 7: | 0 1 1 1 1 0 1 0 0 1 0 0 1 0 1 0 0 0 0 0 0 0 1 0 ? | Infeasible Fathomed |
| 7: | 0 1 1 1 1 0 1 0 0 1 0 0 1 0 1 0 0 0 0 0 0 0 0 0 1 | Infeasible Fathomed |
| 6: | 0 1 1 1 1 0 1 0 0 1 0 0 1 1 ? ? ? ? ? ? 0 ? ? 0 ? | Infeasible Fathomed |
| 6: | 0 1 1 1 1 0 1 0 0 1 0 0 1 0 1 ? ? ? ? ? 0 ? ? 0 ? | Value = 11370000 Fathomed |
| 6: | 0 1 1 1 1 0 1 0 0 1 0 0 1 0 0 1 ? ? ? ? 0 ? ? 0 ? | Infeasible Fathomed |
| 6: | 0 1 1 1 1 0 1 0 0 1 0 0 1 0 0 0 1 ? ? ? 0 ? ? 0 ? | Value = 11020000 Fathomed |
| 6: | 0 1 1 1 1 0 1 0 0 1 0 0 1 0 0 0 0 1 ? ? 0 ? ? 0 ? | Infeasible Fathomed |
| 6: | 0 1 1 1 1 0 1 0 0 1 0 0 1 0 0 0 0 0 1 ? 0 ? ? 0 ? | Infeasible Fathomed |
| 6: | 0 1 1 1 1 0 1 0 0 1 0 0 1 0 0 0 0 0 0 1 0 ? ? 0 ? | Value = 18370000 Fathomed |
| 6: | 0 1 1 1 1 0 1 0 0 1 0 0 1 0 0 0 0 0 0 0 0 1 ? 0 ? | Value = 10885000 Fathomed |
| 6: | 0 1 1 1 1 0 1 0 0 1 0 0 1 0 0 0 0 0 0 0 0 0 1 0 ? | Infeasible Fathomed |
| 6: | 0 1 1 1 1 0 1 0 0 1 0 0 1 0 0 0 0 0 0 0 0 0 0 0 1 | Infeasible Fathomed |
| 5: | 0 1 1 1 1 0 1 0 0 1 1 0 ? ? ? ? ? ? ? ? 0 ? ? 0 ? | Infeasible Fathomed |
| 5: | 0 1 1 1 1 0 1 0 0 1 0 0 1 ? ? ? ? ? ? ? 0 ? ? 0 ? | Value = 10870000 Fathomed |
| 5: | 0 1 1 1 1 0 1 0 0 1 0 0 0 1 ? ? ? ? ? ? 0 ? ? 0 ? | Value = 9670000 Fathomed |
| 5: | 0 1 1 1 1 0 1 0 0 1 0 0 0 0 1 ? ? ? ? ? 0 ? ? 0 ? | Value = 10125000 Fathomed |
| 5: | 0 1 1 1 1 0 1 0 0 1 0 0 0 0 0 1 ? ? ? ? 0 ? ? 0 ? | Value = 10175000 Fathomed |
| 5: | 0 1 1 1 1 0 1 0 0 1 0 0 0 0 0 0 1 ? ? ? 0 ? ? 0 ? | Value = 9775000 Fathomed |
| 5: | 0 1 1 1 1 0 1 0 0 1 0 0 0 0 0 0 0 1 ? ? 0 ? ? 0 ? | Infeasible Fathomed |
| 5: | 0 1 1 1 1 0 1 0 0 1 0 0 0 0 0 0 0 0 1 ? 0 ? ? 0 ? | Value = 9700000 Fathomed |
| 5: | 0 1 1 1 1 0 1 0 0 1 0 0 0 0 0 0 0 0 0 1 0 ? ? 0 ? | Value = 17125000 Fathomed |
| 5: | 0 1 1 1 1 0 1 0 0 1 0 0 0 0 0 0 0 0 0 0 0 1 ? 0 ? | Value = 9640000 Fathomed |
| 5: | 0 1 1 1 1 0 1 0 0 1 0 0 0 0 0 0 0 0 0 0 0 0 1 0 ? | Infeasible Fathomed |
| 5: | 0 1 1 1 1 0 1 0 0 1 0 0 0 0 0 0 0 0 0 0 0 0 0 0 1 | Infeasible Fathomed |
| 4: | 0 1 1 1 1 0 1 1 0 ? ? 0 ? ? ? ? ? ? ? ? 0 ? ? 0 ? | Infeasible Fathomed |
| 4: | 0 1 1 1 1 0 1 0 0 1 ? 0 ? ? ? ? ? ? ? ? 0 ? ? 0 ? | Value = 9625000 Fathomed |
| 4: | 0 1 1 1 1 0 1 0 0 0 1 0 ? ? ? ? ? ? ? ? 0 ? ? 0 ? | Infeasible Fathomed |
| 4: | 0 1 1 1 1 0 1 0 0 0 0 0 1 ? ? ? ? ? ? ? 0 ? ? 0 ? | Value = 8370000 Fathomed |
| 4: | 0 1 1 1 1 0 1 0 0 0 0 0 0 1 ? ? ? ? ? ? 0 ? ? 0 ? | Value = 7170000 Fathomed |
| 4: | 0 1 1 1 1 0 1 0 0 0 0 0 0 0 1 ? ? ? ? ? 0 ? ? 0 ? | Value = 7625000 Fathomed |
| 4: | 0 1 1 1 1 0 1 0 0 0 0 0 0 0 0 1 ? ? ? ? 0 ? ? 0 ? | Value = 7675000 Fathomed |
| 4: | 0 1 1 1 1 0 1 0 0 0 0 0 0 0 0 0 1 ? ? ? 0 ? ? 0 ? | Value = 7275000 Fathomed |
| 4: | 0 1 1 1 1 0 1 0 0 0 0 0 0 0 0 0 0 1 ? ? 0 ? ? 0 ? | Infeasible Fathomed |
| 4: | 0 1 1 1 1 0 1 0 0 0 0 0 0 0 0 0 0 0 1 ? 0 ? ? 0 ? | Value = 7200000 Fathomed |
| 4: | 0 1 1 1 1 0 1 0 0 0 0 0 0 0 0 0 0 0 0 1 0 ? ? 0 ? | Value = 14625000 Fathomed |
| 4: | 0 1 1 1 1 0 1 0 0 0 0 0 0 0 0 0 0 0 0 0 0 1 ? 0 ? | Value = 7140000 Fathomed |
| 4: | 0 1 1 1 1 0 1 0 0 0 0 0 0 0 0 0 0 0 0 0 0 0 1 0 ? | Infeasible Fathomed |
| 4: | 0 1 1 1 1 0 1 0 0 0 0 0 0 0 0 0 0 0 0 0 0 0 0 0 1 | Infeasible Fathomed |
| 3: | 0 1 1 1 1 1 ? ? 0 ? ? 0 ? ? ? ? ? ? ? ? 0 ? ? 0 ? | Infeasible Fathomed |
| 3: | 0 1 1 1 1 0 1 ? 0 ? ? 0 ? ? ? ? ? ? ? ? 0 ? ? 0 ? | Value = 7125000 Fathomed |
| 3: | 0 1 1 1 1 0 0 1 0 ? ? 0 ? ? ? ? ? ? ? ? 0 ? ? 0 ? | Value = 7000000 Fathomed |
| 3: | 0 1 1 1 1 0 0 0 0 1 ? 0 ? ? ? ? ? ? ? ? 0 ? ? 0 ? | Value = 8625000 Fathomed |
| 3: | 0 1 1 1 1 0 0 0 0 0 1 0 ? ? ? ? ? ? ? ? 0 ? ? 0 ? | Value = 6625000 Fathomed |
| 3: | 0 1 1 1 1 0 0 0 0 0 0 0 1 ? ? ? ? ? ? ? 0 ? ? 0 ? | Value = 7370000 Fathomed |
| 3: | 0 1 1 1 1 0 0 0 0 0 0 0 0 1 ? ? ? ? ? ? 0 ? ? 0 ? | Value = 6170000 Fathomed |
| 3: | 0 1 1 1 1 0 0 0 0 0 0 0 0 0 1 ? ? ? ? ? 0 ? ? 0 ? | Value = 6625000 Fathomed |
| 3: | 0 1 1 1 1 0 0 0 0 0 0 0 0 0 0 1 ? ? ? ? 0 ? ? 0 ? | Value = 6675000 Fathomed |
| 3: | 0 1 1 1 1 0 0 0 0 0 0 0 0 0 0 0 1 ? ? ? 0 ? ? 0 ? | Value = 6275000 Fathomed |
| 3: | 0 1 1 1 1 0 0 0 0 0 0 0 0 0 0 0 0 1 ? ? 0 ? ? 0 ? | Value = 8125000 Fathomed |
| 3: | 0 1 1 1 1 0 0 0 0 0 0 0 0 0 0 0 0 0 1 ? 0 ? ? 0 ? | Value = 6200000 Fathomed |
| 3: | 0 1 1 1 1 0 0 0 0 0 0 0 0 0 0 0 0 0 0 1 0 ? ? 0 ? | Value = 13625000 Fathomed |
| 3: | 0 1 1 1 1 0 0 0 0 0 0 0 0 0 0 0 0 0 0 0 0 1 ? 0 ? | Value = 6140000 Fathomed |
| 3: | 0 1 1 1 1 0 0 0 0 0 0 0 0 0 0 0 0 0 0 0 0 0 1 0 ? | Infeasible Fathomed |
| 3: | 0 1 1 1 1 0 0 0 0 0 0 0 0 0 0 0 0 0 0 0 0 0 0 0 1 | Infeasible Fathomed |
| 2: | 0 1 1 1 1 ? ? ? 0 ? ? 0 ? ? ? ? ? ? ? ? 0 ? ? 0 ? | Value = 6125000 Fathomed |
| 2: | 0 1 1 1 0 1 ? ? 0 ? ? 0 ? ? ? ? ? ? ? ? 0 ? ? 0 ? | Value = 4545000 Fathomed |
| 2: | 0 1 1 1 0 0 1 ? 0 ? ? 0 ? ? ? ? ? ? ? ? 0 ? ? 0 ? | Value = 2875000 Fathomed |
| 2: | 0 1 1 1 0 0 0 1 0 ? ? 0 ? ? ? ? ? ? ? ? 0 ? ? 0 ? | Value = 2750000 Fathomed |
| 2: | 0 1 1 1 0 0 0 0 0 1 ? 0 ? ? ? ? ? ? ? ? 0 ? ? 0 ? | Value = 4375000 Fathomed |
| 2: | 0 1 1 1 0 0 0 0 0 0 1 0 ? ? ? ? ? ? ? ? 0 ? ? 0 ? | Value = 2375000 Fathomed |
| 2: | 0 1 1 1 0 0 0 0 0 0 0 0 1 ? ? ? ? ? ? ? 0 ? ? 0 ? | Value = 3120000 Fathomed |
| 2: | 0 1 1 1 0 0 0 0 0 0 0 0 0 1 ? ? ? ? ? ? 0 ? ? 0 ? | Value = 1920000 Fathomed |
| 2: | 0 1 1 1 0 0 0 0 0 0 0 0 0 0 1 ? ? ? ? ? 0 ? ? 0 ? | Value = 2375000 Fathomed |
| 2: | 0 1 1 1 0 0 0 0 0 0 0 0 0 0 0 1 ? ? ? ? 0 ? ? 0 ? | Value = 2425000 Fathomed |
| 2: | 0 1 1 1 0 0 0 0 0 0 0 0 0 0 0 0 1 ? ? ? 0 ? ? 0 ? | Value = 2025000 Fathomed |
| 2: | 0 1 1 1 0 0 0 0 0 0 0 0 0 0 0 0 0 1 ? ? 0 ? ? 0 ? | Value = 3875000 Fathomed |
| 2: | 0 1 1 1 0 0 0 0 0 0 0 0 0 0 0 0 0 0 1 ? 0 ? ? 0 ? | Value = 1950000 Fathomed |
| 2: | 0 1 1 1 0 0 0 0 0 0 0 0 0 0 0 0 0 0 0 1 0 ? ? 0 ? | Value = 9375000 Fathomed |
| 2: | 0 1 1 1 0 0 0 0 0 0 0 0 0 0 0 0 0 0 0 0 0 1 ? 0 ? | Value = 1890000 Fathomed |
| 2: | 0 1 1 1 0 0 0 0 0 0 0 0 0 0 0 0 0 0 0 0 0 0 1 0 ? | Value = 3075000 Fathomed |
| 2: | 0 1 1 1 0 0 0 0 0 0 0 0 0 0 0 0 0 0 0 0 0 0 0 0 1 | Value = 5875000 Fathomed |
| 1: | 0 1 1 1 ? ? ? ? 0 ? ? 0 ? ? ? ? ? ? ? ? 0 ? ? 0 ? | Value = 1875000 Fathomed |
| 1: | 0 1 1 0 1 ? ? ? 0 ? ? 0 ? ? ? ? ? ? ? ? 0 ? ? 0 ? | Value = 5625000 Fathomed |
| 1: | 0 1 1 0 0 1 ? ? 0 ? ? 0 ? ? ? ? ? ? ? ? 0 ? ? 0 ? | Value = 4045000 Fathomed |
| 1: | 0 1 1 0 0 0 1 ? 0 ? ? 0 ? ? ? ? ? ? ? ? 0 ? ? 0 ? | Value = 2375000 Fathomed |
| 1: | 0 1 1 0 0 0 0 1 0 ? ? 0 ? ? ? ? ? ? ? ? 0 ? ? 0 ? | Value = 2250000 Fathomed |
| 1: | 0 1 1 0 0 0 0 0 0 1 ? 0 ? ? ? ? ? ? ? ? 0 ? ? 0 ? | Value = 3875000 Fathomed |
| 1: | 0 1 1 0 0 0 0 0 0 0 1 0 ? ? ? ? ? ? ? ? 0 ? ? 0 ? | Value = 1875000 Fathomed |
| 1: | 0 1 1 0 0 0 0 0 0 0 0 0 1 ? ? ? ? ? ? ? 0 ? ? 0 ? | Value = 2620000 Fathomed |
| 1: | 0 1 1 0 0 0 0 0 0 0 0 0 0 1 ? ? ? ? ? ? 0 ? ? 0 ? | Value = 1420000 Fathomed |
| 1: | 0 1 1 0 0 0 0 0 0 0 0 0 0 0 1 ? ? ? ? ? 0 ? ? 0 ? | Value = 1875000 Fathomed |
| 1: | 0 1 1 0 0 0 0 0 0 0 0 0 0 0 0 1 ? ? ? ? 0 ? ? 0 ? | Value = 1925000 Fathomed |
| 1: | 0 1 1 0 0 0 0 0 0 0 0 0 0 0 0 0 1 ? ? ? 0 ? ? 0 ? | Value = 1525000 Fathomed |
| 1: | 0 1 1 0 0 0 0 0 0 0 0 0 0 0 0 0 0 1 ? ? 0 ? ? 0 ? | Value = 3375000 Fathomed |
| 1: | 0 1 1 0 0 0 0 0 0 0 0 0 0 0 0 0 0 0 1 ? 0 ? ? 0 ? | Value = 1450000 Fathomed |
| 1: | 0 1 1 0 0 0 0 0 0 0 0 0 0 0 0 0 0 0 0 1 0 ? ? 0 ? | Value = 8875000 Fathomed |
| 1: | 0 1 1 0 0 0 0 0 0 0 0 0 0 0 0 0 0 0 0 0 0 1 ? 0 ? | Value = 1390000 Fathomed |
| 1: | 0 1 1 0 0 0 0 0 0 0 0 0 0 0 0 0 0 0 0 0 0 0 1 0 ? | Value = 2575000 Fathomed |
| 1: | 0 1 1 0 0 0 0 0 0 0 0 0 0 0 0 0 0 0 0 0 0 0 0 0 1 | Value = 5375000 Fathomed |
| Starting Solution 3 | | |
| 0: | ? ? 1 ? ? ? ? ? 0 ? ? 0 ? ? ? ? ? ? ? ? 0 ? ? 0 ? | Value = 1250000 |
| 1: | 0 0 1 1 ? ? ? ? 0 ? ? 0 ? ? ? ? ? ? ? ? 0 ? ? 0 ? | Value = 1750000 |
| 2: | 0 0 1 1 1 ? ? ? 0 ? ? 0 ? ? ? ? ? ? ? ? 0 ? ? 0 ? | Value = 6000000 |
| 3: | 0 0 1 1 1 1 ? ? 0 ? ? 0 ? ? ? ? ? ? ? ? 0 ? ? 0 ? | Value = 8670000 |
| 4: | 0 0 1 1 1 1 1 ? 0 ? ? 0 ? ? ? ? ? ? ? ? 0 ? ? 0 ? | Value = 9670000 |
| 5: | 0 0 1 1 1 1 1 1 0 ? ? 0 ? ? ? ? ? ? ? ? 0 ? ? 0 ? | Infeasible |
| 5: | 0 0 1 1 1 1 1 0 0 1 ? 0 ? ? ? ? ? ? ? ? 0 ? ? 0 ? | Value = 12170000 |
| 6: | 0 0 1 1 1 1 1 0 0 1 1 0 ? ? ? ? ? ? ? ? 0 ? ? 0 ? | Infeasible |
| 6: | 0 0 1 1 1 1 1 0 0 1 0 0 1 ? ? ? ? ? ? ? 0 ? ? 0 ? | Infeasible |
| 6: | 0 0 1 1 1 1 1 0 0 1 0 0 0 1 ? ? ? ? ? ? 0 ? ? 0 ? | Infeasible |
| 6: | 0 0 1 1 1 1 1 0 0 1 0 0 0 0 1 ? ? ? ? ? 0 ? ? 0 ? | Value = 12670000 |
| 7: | 0 0 1 1 1 1 1 0 0 1 0 0 0 0 1 1 ? ? ? ? 0 ? ? 0 ? | Infeasible |
| 7: | 0 0 1 1 1 1 1 0 0 1 0 0 0 0 1 0 1 ? ? ? 0 ? ? 0 ? | Infeasible |
| 7: | 0 0 1 1 1 1 1 0 0 1 0 0 0 0 1 0 0 1 ? ? 0 ? ? 0 ? | Infeasible |
| 7: | 0 0 1 1 1 1 1 0 0 1 0 0 0 0 1 0 0 0 1 ? 0 ? ? 0 ? | Infeasible |
| 7: | 0 0 1 1 1 1 1 0 0 1 0 0 0 0 1 0 0 0 0 1 0 ? ? 0 ? | Infeasible |
| 7: | 0 0 1 1 1 1 1 0 0 1 0 0 0 0 1 0 0 0 0 0 0 1 ? 0 ? | Value = 12685000 |
| 8: | 0 0 1 1 1 1 1 0 0 1 0 0 0 0 1 0 0 0 0 0 0 1 1 0 ? | Infeasible |
| 8: | 0 0 1 1 1 1 1 0 0 1 0 0 0 0 1 0 0 0 0 0 0 1 0 0 1 | Infeasible |
| 7: | 0 0 1 1 1 1 1 0 0 1 0 0 0 0 1 0 0 0 0 0 0 1 1 0 ? | Infeasible Fathomed |
| 7: | 0 0 1 1 1 1 1 0 0 1 0 0 0 0 1 0 0 0 0 0 0 1 0 0 1 | Infeasible Fathomed |
| 6: | 0 0 1 1 1 1 1 0 0 1 0 0 0 0 1 1 ? ? ? ? 0 ? ? 0 ? | Infeasible Fathomed |
| 6: | 0 0 1 1 1 1 1 0 0 1 0 0 0 0 1 0 1 ? ? ? 0 ? ? 0 ? | Infeasible athomed |
| 6: | 0 0 1 1 1 1 1 0 0 1 0 0 0 0 1 0 0 1 ? ? 0 ? ? 0 ? | Infeasible Fathomed |
| 6: | 0 0 1 1 1 1 1 0 0 1 0 0 0 0 1 0 0 0 1 ? 0 ? ? 0 ? | Infeasible Fathomed |
| 6: | 0 0 1 1 1 1 1 0 0 1 0 0 0 0 1 0 0 0 0 1 0 ? ? 0 ? | Infeasible Fathomed |
| 6: | 0 0 1 1 1 1 1 0 0 1 0 0 0 0 1 0 0 0 0 0 0 1 ? 0 ? | Value = 12685000 Fathomed |
| 6: | 0 0 1 1 1 1 1 0 0 1 0 0 0 0 1 0 0 0 0 0 0 0 1 0 ? | Infeasible Fathomed |
| 6: | 0 0 1 1 1 1 1 0 0 1 0 0 0 0 1 0 0 0 0 0 0 0 0 0 1 | Infeasible Fathomed |
| 5: | 0 0 1 1 1 1 1 0 0 1 1 0 ? ? ? ? ? ? ? ? 0 ? ? 0 ? | Infeasible Fathomed |
| 5: | 0 0 1 1 1 1 1 0 0 1 0 0 1 ? ? ? ? ? ? ? 0 ? ? 0 ? | Infeasible Fathomed |
| 5: | 0 0 1 1 1 1 1 0 0 1 0 0 0 1 ? ? ? ? ? ? 0 ? ? 0 ? | Infeasible Fathomed |
| 5: | 0 0 1 1 1 1 1 0 0 1 0 0 0 0 1 ? ? ? ? ? 0 ? ? 0 ? | Value = 12670000 Fathomed |
| 5: | 0 0 1 1 1 1 1 0 0 1 0 0 0 0 0 1 ? ? ? ? 0 ? ? 0 ? | Infeasible Fathomed |
| 5: | 0 0 1 1 1 1 1 0 0 1 0 0 0 0 0 0 1 ? ? ? 0 ? ? 0 ? | Infeasible Fathomed |
| 5: | 0 0 1 1 1 1 1 0 0 1 0 0 0 0 0 0 0 1 ? ? 0 ? ? 0 ? | Infeasible Fathomed |
| 5: | 0 0 1 1 1 1 1 0 0 1 0 0 0 0 0 0 0 0 1 ? 0 ? ? 0 ? | Infeasible Fathomed |
| 5: | 0 0 1 1 1 1 1 0 0 1 0 0 0 0 0 0 0 0 0 1 0 ? ? 0 ? | Infeasible Fathomed |
| 5: | 0 0 1 1 1 1 1 0 0 1 0 0 0 0 0 0 0 0 0 0 0 1 ? 0 ? | Value = 12185000 Fathomed |
| 5: | 0 0 1 1 1 1 1 0 0 1 0 0 0 0 0 0 0 0 0 0 0 0 1 0 ? | Infeasible Fathomed |
| 5: | 0 0 1 1 1 1 1 0 0 1 0 0 0 0 0 0 0 0 0 0 0 0 0 0 1 | Infeasible Fathomed |
| 4: | 0 0 1 1 1 1 1 1 0 ? ? 0 ? ? ? ? ? ? ? ? 0 ? ? 0 ? | Infeasible Fathomed |
| 4: | 0 0 1 1 1 1 1 0 0 1 ? 0 ? ? ? ? ? ? ? ? 0 ? ? 0 ? | Value = 12170000 Fathomed |
| 4: | 0 0 1 1 1 1 1 0 0 0 1 0 ? ? ? ? ? ? ? ? 0 ? ? 0 ? | Infeasible Fathomed |
| 4: | 0 0 1 1 1 1 1 0 0 0 0 0 1 ? ? ? ? ? ? ? 0 ? ? 0 ? | Infeasible Fathomed |
| 4: | 0 0 1 1 1 1 1 0 0 0 0 0 0 1 ? ? ? ? ? ? 0 ? ? 0 ? | Infeasible Fathomed |
| 4: | 0 0 1 1 1 1 1 0 0 0 0 0 0 0 1 ? ? ? ? ? 0 ? ? 0 ? | Value = 10170000 Fathomed |
| 4: | 0 0 1 1 1 1 1 0 0 0 0 0 0 0 0 1 ? ? ? ? 0 ? ? 0 ? | Infeasible Fathomed |
| 4: | 0 0 1 1 1 1 1 0 0 0 0 0 0 0 0 0 1 ? ? ? 0 ? ? 0 ? | Value = 9820000 Fathomed |
| 4: | 0 0 1 1 1 1 1 0 0 0 0 0 0 0 0 0 0 1 ? ? 0 ? ? 0 ? | Infeasible Fathomed |
| 4: | 0 0 1 1 1 1 1 0 0 0 0 0 0 0 0 0 0 0 1 ? 0 ? ? 0 ? | Infeasible Fathomed |
| 4: | 0 0 1 1 1 1 1 0 0 0 0 0 0 0 0 0 0 0 0 1 0 ? ? 0 ? | Value = 17170000 Fathomed |
| 4: | 0 0 1 1 1 1 1 0 0 0 0 0 0 0 0 0 0 0 0 0 0 1 ? 0 ? | Value = 9685000 Fathomed |
| 4: | 0 0 1 1 1 1 1 0 0 0 0 0 0 0 0 0 0 0 0 0 0 0 1 0 ? | Infeasible Fathomed |
| 4: | 0 0 1 1 1 1 1 0 0 0 0 0 0 0 0 0 0 0 0 0 0 0 0 0 1 | Infeasible Fathomed |
| 3: | 0 0 1 1 1 1 1 ? 0 ? ? 0 ? ? ? ? ? ? ? ? 0 ? ? 0 ? | Value = 9670000 Fathomed |
| 3: | 0 0 1 1 1 1 0 1 0 ? ? 0 ? ? ? ? ? ? ? ? 0 ? ? 0 ? | Value = 9545000 Fathomed |
| 3: | 0 0 1 1 1 1 0 0 0 1 ? 0 ? ? ? ? ? ? ? ? 0 ? ? 0 ? | Value = 11170000 Fathomed |
| 3: | 0 0 1 1 1 1 0 0 0 0 1 0 ? ? ? ? ? ? ? ? 0 ? ? 0 ? | Value = 9170000 Fathomed |
| 3: | 0 0 1 1 1 1 0 0 0 0 0 0 1 ? ? ? ? ? ? ? 0 ? ? 0 ? | Value = 9915000 Fathomed |
| 3: | 0 0 1 1 1 1 0 0 0 0 0 0 0 1 ? ? ? ? ? ? 0 ? ? 0 ? | Value = 8715000 Fathomed |
| 3: | 0 0 1 1 1 1 0 0 0 0 0 0 0 0 1 ? ? ? ? ? 0 ? ? 0 ? | Value = 9170000 Fathomed |
| 3: | 0 0 1 1 1 1 0 0 0 0 0 0 0 0 0 1 ? ? ? ? 0 ? ? 0 ? | Value = 9220000 Fathomed |
| 3: | 0 0 1 1 1 1 0 0 0 0 0 0 0 0 0 0 1 ? ? ? 0 ? ? 0 ? | Value = 8820000 Fathomed |
| 3: | 0 0 1 1 1 1 0 0 0 0 0 0 0 0 0 0 0 1 ? ? 0 ? ? 0 ? | Value = 10670000 Fathomed |
| 3: | 0 0 1 1 1 1 0 0 0 0 0 0 0 0 0 0 0 0 1 ? 0 ? ? 0 ? | Value = 8745000 Fathomed |
| 3: | 0 0 1 1 1 1 0 0 0 0 0 0 0 0 0 0 0 0 0 1 0 ? ? 0 ? | Value = 16170000 Fathomed |
| 3: | 0 0 1 1 1 1 0 0 0 0 0 0 0 0 0 0 0 0 0 0 0 1 ? 0 ? | Value = 8685000 Fathomed |
| 3: | 0 0 1 1 1 1 0 0 0 0 0 0 0 0 0 0 0 0 0 0 0 0 1 0 ? | Infeasible Fathomed |
| 3: | 0 0 1 1 1 1 0 0 0 0 0 0 0 0 0 0 0 0 0 0 0 0 0 0 1 | Infeasible Fathomed |
| 2: | 0 0 1 1 1 1 ? ? 0 ? ? 0 ? ? ? ? ? ? ? ? 0 ? ? 0 ? | Value = 8670000 Fathomed |
| 2: | 0 0 1 1 1 0 1 ? 0 ? ? 0 ? ? ? ? ? ? ? ? 0 ? ? 0 ? | Value = 7000000 Fathomed |
| 2: | 0 0 1 1 1 0 0 1 0 ? ? 0 ? ? ? ? ? ? ? ? 0 ? ? 0 ? | Value = 6875000 Fathomed |
| 2: | 0 0 1 1 1 0 0 0 0 1 ? 0 ? ? ? ? ? ? ? ? 0 ? ? 0 ? | Value = 8500000 Fathomed |
| 2: | 0 0 1 1 1 0 0 0 0 0 1 0 ? ? ? ? ? ? ? ? 0 ? ? 0 ? | Value = 6500000 Fathomed |
| 2: | 0 0 1 1 1 0 0 0 0 0 0 0 1 ? ? ? ? ? ? ? 0 ? ? 0 ? | Value = 7245000 Fathomed |
| 2: | 0 0 1 1 1 0 0 0 0 0 0 0 0 1 ? ? ? ? ? ? 0 ? ? 0 ? | Value = 6045000 Fathomed |
| 2: | 0 0 1 1 1 0 0 0 0 0 0 0 0 0 1 ? ? ? ? ? 0 ? ? 0 ? | Value = 6500000 Fathomed |
| 2: | 0 0 1 1 1 0 0 0 0 0 0 0 0 0 0 1 ? ? ? ? 0 ? ? 0 ? | Value = 6550000 Fathomed |
| 2: | 0 0 1 1 1 0 0 0 0 0 0 0 0 0 0 0 1 ? ? ? 0 ? ? 0 ? | Value = 6150000 Fathomed |
| 2: | 0 0 1 1 1 0 0 0 0 0 0 0 0 0 0 0 0 1 ? ? 0 ? ? 0 ? | Value = 8000000 Fathomed |
| 2: | 0 0 1 1 1 0 0 0 0 0 0 0 0 0 0 0 0 0 1 ? 0 ? ? 0 ? | Value = 6075000 Fathomed |
| 2: | 0 0 1 1 1 0 0 0 0 0 0 0 0 0 0 0 0 0 0 1 0 ? ? 0 ? | Value = 13500000 Fathomed |
| 2: | 0 0 1 1 1 0 0 0 0 0 0 0 0 0 0 0 0 0 0 0 0 1 ? 0 ? | Value = 6015000 Fathomed |
| 2: | 0 0 1 1 1 0 0 0 0 0 0 0 0 0 0 0 0 0 0 0 0 0 1 0 ? | Infeasible Fathomed |
| 2: | 0 0 1 1 1 0 0 0 0 0 0 0 0 0 0 0 0 0 0 0 0 0 0 0 1 | Value = 10000000 Fathomed |
| 1: | 0 0 1 1 1 ? ? ? 0 ? ? 0 ? ? ? ? ? ? ? ? 0 ? ? 0 ? | Value = 6000000 Fathomed |
| 1: | 0 0 1 1 0 1 ? ? 0 ? ? 0 ? ? ? ? ? ? ? ? 0 ? ? 0 ? | Value = 4420000 Fathomed |
| 1: | 0 0 1 1 0 0 1 ? 0 ? ? 0 ? ? ? ? ? ? ? ? 0 ? ? 0 ? | Value = 2750000 Fathomed |
| 1: | 0 0 1 1 0 0 0 1 0 ? ? 0 ? ? ? ? ? ? ? ? 0 ? ? 0 ? | Value = 2625000 Fathomed |
| 1: | 0 0 1 1 0 0 0 0 0 1 ? 0 ? ? ? ? ? ? ? ? 0 ? ? 0 ? | Value = 4250000 Fathomed |
| 1: | 0 0 1 1 0 0 0 0 0 0 1 0 ? ? ? ? ? ? ? ? 0 ? ? 0 ? | Value = 2250000 Fathomed |
| 1: | 0 0 1 1 0 0 0 0 0 0 0 0 1 ? ? ? ? ? ? ? 0 ? ? 0 ? | Value = 2995000 Fathomed |
| 1: | 0 0 1 1 0 0 0 0 0 0 0 0 0 1 ? ? ? ? ? ? 0 ? ? 0 ? | Value = 1795000 Fathomed |
| 1: | 0 0 1 1 0 0 0 0 0 0 0 0 0 0 1 ? ? ? ? ? 0 ? ? 0 ? | Value = 2250000 Fathomed |
| 1: | 0 0 1 1 0 0 0 0 0 0 0 0 0 0 0 1 ? ? ? ? 0 ? ? 0 ? | Value = 2300000 Fathomed |
| 1: | 0 0 1 1 0 0 0 0 0 0 0 0 0 0 0 0 1 ? ? ? 0 ? ? 0 ? | Value = 1900000 Fathomed |
| 1: | 0 0 1 1 0 0 0 0 0 0 0 0 0 0 0 0 0 1 ? ? 0 ? ? 0 ? | Value = 3750000 Fathomed |
| 1: | 0 0 1 1 0 0 0 0 0 0 0 0 0 0 0 0 0 0 1 ? 0 ? ? 0 ? | Value = 1825000 Fathomed |
| 1: | 0 0 1 1 0 0 0 0 0 0 0 0 0 0 0 0 0 0 0 1 0 ? ? 0 ? | Value = 9250000 Fathomed |
| 1: | 0 0 1 1 0 0 0 0 0 0 0 0 0 0 0 0 0 0 0 0 0 1 ? 0 ? | Value = 1765000 Fathomed |
| 1: | 0 0 1 1 0 0 0 0 0 0 0 0 0 0 0 0 0 0 0 0 0 0 1 0 ? | Value = 2950000 Fathomed |
| 1: | 0 0 1 1 0 0 0 0 0 0 0 0 0 0 0 0 0 0 0 0 0 0 0 0 1 | Value = 5750000 Fathomed |
| Starting Solution 4 | | |
| 0: | ? ? ? 1 ? ? ? ? 0 ? ? 0 ? ? ? ? ? ? ? ? 0 ? ? 0 ? | Value = 500000 |
| 1: | 0 0 0 1 1 ? ? ? 0 ? ? 0 ? ? ? ? ? ? ? ? 0 ? ? 0 ? | Value = 4750000 |
| 2: | 0 0 0 1 1 1 ? ? 0 ? ? 0 ? ? ? ? ? ? ? ? 0 ? ? 0 ? | Value = 7420000 |
| 3: | 0 0 0 1 1 1 1 ? 0 ? ? 0 ? ? ? ? ? ? ? ? 0 ? ? 0 ? | Value = 8420000 |
| 4: | 0 0 0 1 1 1 1 1 0 ? ? 0 ? ? ? ? ? ? ? ? 0 ? ? 0 ? | Value = 9295000 |
| 5: | 0 0 0 1 1 1 1 1 0 1 ? 0 ? ? ? ? ? ? ? ? 0 ? ? 0 ? | Value = 11795000 |
| 6: | 0 0 0 1 1 1 1 1 0 1 1 0 ? ? ? ? ? ? ? ? 0 ? ? 0 ? | Infeasible |
| 6: | 0 0 0 1 1 1 1 1 0 1 0 0 1 ? ? ? ? ? ? ? 0 ? ? 0 ? | Infeasible |
| 6: | 0 0 0 1 1 1 1 1 0 1 0 0 0 1 ? ? ? ? ? ? 0 ? ? 0 ? | Infeasible |
| 6: | 0 0 0 1 1 1 1 1 0 1 0 0 0 0 1 ? ? ? ? ? 0 ? ? 0 ? | Value = 12295000 |
| 7: | 0 0 0 1 1 1 1 1 0 1 0 0 0 0 1 1 ? ? ? ? 0 ? ? 0 ? | Infeasible |
| 7: | 0 0 0 1 1 1 1 1 0 1 0 0 0 0 1 0 1 ? ? ? 0 ? ? 0 ? | Infeasible |
| 7: | 0 0 0 1 1 1 1 1 0 1 0 0 0 0 1 0 0 1 ? ? 0 ? ? 0 ? | Infeasible |
| 7: | 0 0 0 1 1 1 1 1 0 1 0 0 0 0 1 0 0 0 1 ? 0 ? ? 0 ? | Infeasible |
| 7: | 0 0 0 1 1 1 1 1 0 1 0 0 0 0 1 0 0 0 0 1 0 ? ? 0 ? | Infeasible |
| 7: | 0 0 0 1 1 1 1 1 0 1 0 0 0 0 1 0 0 0 0 0 0 1 ? 0 ? | Value = 12310000 |
| 8: | 0 0 0 1 1 1 1 1 0 1 0 0 0 0 1 0 0 0 0 0 0 1 1 0 ? | Infeasible |
| 8: | 0 0 0 1 1 1 1 1 0 1 0 0 0 0 1 0 0 0 0 0 0 1 0 0 1 | Value = 16310000 |
| 7: | 0 0 0 1 1 1 1 1 0 1 0 0 0 0 1 0 0 0 0 0 0 1 1 0 ? | Infeasible Fathomed |
| 7: | 0 0 0 1 1 1 1 1 0 1 0 0 0 0 1 0 0 0 0 0 0 1 0 0 1 | Value = 16310000 (Maximal) Fathomed |
| 6: | 0 0 0 1 1 1 1 1 0 1 0 0 0 0 1 1 ? ? ? ? 0 ? ? 0 ? | Infeasible Fathomed |
| 6: | 0 0 0 1 1 1 1 1 0 1 0 0 0 0 1 0 1 ? ? ? 0 ? ? 0 ? | Infeasible Fathomed |
| 6: | 0 0 0 1 1 1 1 1 0 1 0 0 0 0 1 0 0 1 ? ? 0 ? ? 0 ? | Infeasible Fathomed |
| 6: | 0 0 0 1 1 1 1 1 0 1 0 0 0 0 1 0 0 0 1 ? 0 ? ? 0 ? | Infeasible Fathomed |
| 6: | 0 0 0 1 1 1 1 1 0 1 0 0 0 0 1 0 0 0 0 1 0 ? ? 0 ? | Infeasible Fathomed |
| 6: | 0 0 0 1 1 1 1 1 0 1 0 0 0 0 1 0 0 0 0 0 0 1 ? 0 ? | Value = 12310000 Fathomed |
| 6: | 0 0 0 1 1 1 1 1 0 1 0 0 0 0 1 0 0 0 0 0 0 0 1 0 ? | Infeasible Fathomed |
| 6: | 0 0 0 1 1 1 1 1 0 1 0 0 0 0 1 0 0 0 0 0 0 0 0 0 1 | Value = 16295000 Fathomed |
| 5: | 0 0 0 1 1 1 1 1 0 1 1 0 ? ? ? ? ? ? ? ? 0 ? ? 0 ? | Infeasible Fathomed |
| 5: | 0 0 0 1 1 1 1 1 0 1 0 0 1 ? ? ? ? ? ? ? 0 ? ? 0 ? | Infeasible Fathomed |
| 5: | 0 0 0 1 1 1 1 1 0 1 0 0 0 1 ? ? ? ? ? ? 0 ? ? 0 ? | Infeasible Fathomed |
| 5: | 0 0 0 1 1 1 1 1 0 1 0 0 0 0 1 ? ? ? ? ? 0 ? ? 0 ? | Value = 12295000 Fathomed |
| 5: | 0 0 0 1 1 1 1 1 0 1 0 0 0 0 0 1 ? ? ? ? 0 ? ? 0 ? | Infeasible Fathomed |
| 5: | 0 0 0 1 1 1 1 1 0 1 0 0 0 0 0 0 1 ? ? ? 0 ? ? 0 ? | Infeasible Fathomed |
| 5: | 0 0 0 1 1 1 1 1 0 1 0 0 0 0 0 0 0 1 ? ? 0 ? ? 0 ? | Infeasible Fathomed |
| 5: | 0 0 0 1 1 1 1 1 0 1 0 0 0 0 0 0 0 0 1 ? 0 ? ? 0 ? | Infeasible Fathomed |
| 5: | 0 0 0 1 1 1 1 1 0 1 0 0 0 0 0 0 0 0 0 1 0 ? ? 0 ? | Infeasible Fathomed |
| 5: | 0 0 0 1 1 1 1 1 0 1 0 0 0 0 0 0 0 0 0 0 0 1 ? 0 ? | Value = 11810000 Fathomed |
| 5: | 0 0 0 1 1 1 1 1 0 1 0 0 0 0 0 0 0 0 0 0 0 0 1 0 ? | Infeasible Fathomed |
| 5: | 0 0 0 1 1 1 1 1 0 1 0 0 0 0 0 0 0 0 0 0 0 0 0 0 1 | Value = 15795000 Fathomed |
| 4: | 0 0 0 1 1 1 1 1 0 1 ? 0 ? ? ? ? ? ? ? ? 0 ? ? 0 ? | Value = 11795000 Fathomed |
| 4: | 0 0 0 1 1 1 1 1 0 0 1 0 ? ? ? ? ? ? ? ? 0 ? ? 0 ? | Infeasible Fathomed |
| 4: | 0 0 0 1 1 1 1 1 0 0 0 0 1 ? ? ? ? ? ? ? 0 ? ? 0 ? | Infeasible Fathomed |
| 4: | 0 0 0 1 1 1 1 1 0 0 0 0 0 1 ? ? ? ? ? ? 0 ? ? 0 ? | Infeasible Fathomed |
| 4: | 0 0 0 1 1 1 1 1 0 0 0 0 0 0 1 ? ? ? ? ? 0 ? ? 0 ? | Value = 9795000 Fathomed |
| 4: | 0 0 0 1 1 1 1 1 0 0 0 0 0 0 0 1 ? ? ? ? 0 ? ? 0 ? | Infeasible Fathomed |
| 4: | 0 0 0 1 1 1 1 1 0 0 0 0 0 0 0 0 1 ? ? ? 0 ? ? 0 ? | Value = 9445000 Fathomed |
| 4: | 0 0 0 1 1 1 1 1 0 0 0 0 0 0 0 0 0 1 ? ? 0 ? ? 0 ? | Infeasible Fathomed |
| 4: | 0 0 0 1 1 1 1 1 0 0 0 0 0 0 0 0 0 0 1 ? 0 ? ? 0 ? | Infeasible Fathomed |
| 4: | 0 0 0 1 1 1 1 1 0 0 0 0 0 0 0 0 0 0 0 1 0 ? ? 0 ? | Value = 16795000 Fathomed |
| 4: | 0 0 0 1 1 1 1 1 0 0 0 0 0 0 0 0 0 0 0 0 0 1 ? 0 ? | Value = 9310000 Fathomed |
| 4: | 0 0 0 1 1 1 1 1 0 0 0 0 0 0 0 0 0 0 0 0 0 0 1 0 ? | Infeasible Fathomed |
| 4: | 0 0 0 1 1 1 1 1 0 0 0 0 0 0 0 0 0 0 0 0 0 0 0 0 1 | Value = 13295000 Fathomed |
| 3: | 0 0 0 1 1 1 1 1 0 ? ? 0 ? ? ? ? ? ? ? ? 0 ? ? 0 ? | Value = 9295000 Fathomed |
| 3: | 0 0 0 1 1 1 1 0 0 1 ? 0 ? ? ? ? ? ? ? ? 0 ? ? 0 ? | Value = 10920000 Fathomed |
| 3: | 0 0 0 1 1 1 1 0 0 0 1 0 ? ? ? ? ? ? ? ? 0 ? ? 0 ? | Infeasible Fathomed |
| 3: | 0 0 0 1 1 1 1 0 0 0 0 0 1 ? ? ? ? ? ? ? 0 ? ? 0 ? | Infeasible Fathomed |
| 3: | 0 0 0 1 1 1 1 0 0 0 0 0 0 1 ? ? ? ? ? ? 0 ? ? 0 ? | Infeasible Fathomed |
| 3: | 0 0 0 1 1 1 1 0 0 0 0 0 0 0 1 ? ? ? ? ? 0 ? ? 0 ? | Value = 8920000 Fathomed |
| 3: | 0 0 0 1 1 1 1 0 0 0 0 0 0 0 0 1 ? ? ? ? 0 ? ? 0 ? | Infeasible Fathomed |
| 3: | 0 0 0 1 1 1 1 0 0 0 0 0 0 0 0 0 1 ? ? ? 0 ? ? 0 ? | Value = 8570000 Fathomed |
| 3: | 0 0 0 1 1 1 1 0 0 0 0 0 0 0 0 0 0 1 ? ? 0 ? ? 0 ? | Infeasible Fathomed |
| 3: | 0 0 0 1 1 1 1 0 0 0 0 0 0 0 0 0 0 0 1 ? 0 ? ? 0 ? | Infeasible Fathomed |
| 3: | 0 0 0 1 1 1 1 0 0 0 0 0 0 0 0 0 0 0 0 1 0 ? ? 0 ? | Value = 15920000 Fathomed |
| 3: | 0 0 0 1 1 1 1 0 0 0 0 0 0 0 0 0 0 0 0 0 0 1 ? 0 ? | Value = 8435000 Fathomed |
| 3: | 0 0 0 1 1 1 1 0 0 0 0 0 0 0 0 0 0 0 0 0 0 0 1 0 ? | Infeasible Fathomed |
| 3: | 0 0 0 1 1 1 1 0 0 0 0 0 0 0 0 0 0 0 0 0 0 0 0 0 1 | Value = 12420000 Fathomed |
| 2: | 0 0 0 1 1 1 1 ? 0 ? ? 0 ? ? ? ? ? ? ? ? 0 ? ? 0 ? | Value = 8420000 Fathomed |
| 2: | 0 0 0 1 1 1 0 1 0 ? ? 0 ? ? ? ? ? ? ? ? 0 ? ? 0 ? | Value = 8295000 Fathomed |
| 2: | 0 0 0 1 1 1 0 0 0 1 ? 0 ? ? ? ? ? ? ? ? 0 ? ? 0 ? | Value = 9920000 Fathomed |
| 2: | 0 0 0 1 1 1 0 0 0 0 1 0 ? ? ? ? ? ? ? ? 0 ? ? 0 ? | Value = 7920000 Fathomed |
| 2: | 0 0 0 1 1 1 0 0 0 0 0 0 1 ? ? ? ? ? ? ? 0 ? ? 0 ? | Value = 8665000 Fathomed |
| 2: | 0 0 0 1 1 1 0 0 0 0 0 0 0 1 ? ? ? ? ? ? 0 ? ? 0 ? | Value = 7465000 Fathomed |
| 2: | 0 0 0 1 1 1 0 0 0 0 0 0 0 0 1 ? ? ? ? ? 0 ? ? 0 ? | Value = 7920000 Fathomed |
| 2: | 0 0 0 1 1 1 0 0 0 0 0 0 0 0 0 1 ? ? ? ? 0 ? ? 0 ? | Value = 7970000 Fathomed |
| 2: | 0 0 0 1 1 1 0 0 0 0 0 0 0 0 0 0 1 ? ? ? 0 ? ? 0 ? | Value = 7570000 Fathomed |
| 2: | 0 0 0 1 1 1 0 0 0 0 0 0 0 0 0 0 0 1 ? ? 0 ? ? 0 ? | Value = 9420000 Fathomed |
| 2: | 0 0 0 1 1 1 0 0 0 0 0 0 0 0 0 0 0 0 1 ? 0 ? ? 0 ? | Value = 7495000 Fathomed |
| 2: | 0 0 0 1 1 1 0 0 0 0 0 0 0 0 0 0 0 0 0 1 0 ? ? 0 ? | Value = 14920000 Fathomed |
| 2: | 0 0 0 1 1 1 0 0 0 0 0 0 0 0 0 0 0 0 0 0 0 1 ? 0 ? | Value = 7435000 Fathomed |
| 2: | 0 0 0 1 1 1 0 0 0 0 0 0 0 0 0 0 0 0 0 0 0 0 1 0 ? | Infeasible Fathomed |
| 2: | 0 0 0 1 1 1 0 0 0 0 0 0 0 0 0 0 0 0 0 0 0 0 0 0 1 | Value = 11420000 Fathomed |
| 1: | 0 0 0 1 1 1 ? ? 0 ? ? 0 ? ? ? ? ? ? ? ? 0 ? ? 0 ? | Value = 7420000 Fathomed |
| 1: | 0 0 0 1 1 0 1 ? 0 ? ? 0 ? ? ? ? ? ? ? ? 0 ? ? 0 ? | Value = 5750000 Fathomed |
| 1: | 0 0 0 1 1 0 0 1 0 ? ? 0 ? ? ? ? ? ? ? ? 0 ? ? 0 ? | Value = 5625000 Fathomed |
| 1: | 0 0 0 1 1 0 0 0 0 1 ? 0 ? ? ? ? ? ? ? ? 0 ? ? 0 ? | Value = 7250000 Fathomed |
| 1: | 0 0 0 1 1 0 0 0 0 0 1 0 ? ? ? ? ? ? ? ? 0 ? ? 0 ? | Value = 5250000 Fathomed |
| 1: | 0 0 0 1 1 0 0 0 0 0 0 0 1 ? ? ? ? ? ? ? 0 ? ? 0 ? | Value = 5995000 Fathomed |
| 1: | 0 0 0 1 1 0 0 0 0 0 0 0 0 1 ? ? ? ? ? ? 0 ? ? 0 ? | Value = 4795000 Fathomed |
| 1: | 0 0 0 1 1 0 0 0 0 0 0 0 0 0 1 ? ? ? ? ? 0 ? ? 0 ? | Value = 5250000 Fathomed |
| 1: | 0 0 0 1 1 0 0 0 0 0 0 0 0 0 0 1 ? ? ? ? 0 ? ? 0 ? | Value = 5300000 Fathomed |
| 1: | 0 0 0 1 1 0 0 0 0 0 0 0 0 0 0 0 1 ? ? ? 0 ? ? 0 ? | Value = 4900000 Fathomed |
| 1: | 0 0 0 1 1 0 0 0 0 0 0 0 0 0 0 0 0 1 ? ? 0 ? ? 0 ? | Value = 6750000 Fathomed |
| 1: | 0 0 0 1 1 0 0 0 0 0 0 0 0 0 0 0 0 0 1 ? 0 ? ? 0 ? | Value = 4825000 Fathomed |
| 1: | 0 0 0 1 1 0 0 0 0 0 0 0 0 0 0 0 0 0 0 1 0 ? ? 0 ? | Value = 12250000 Fathomed |
| 1: | 0 0 0 1 1 0 0 0 0 0 0 0 0 0 0 0 0 0 0 0 0 1 ? 0 ? | Value = 4765000 Fathomed |
| 1: | 0 0 0 1 1 0 0 0 0 0 0 0 0 0 0 0 0 0 0 0 0 0 1 0 ? | Infeasible Fathomed |
| 1: | 0 0 0 1 1 0 0 0 0 0 0 0 0 0 0 0 0 0 0 0 0 0 0 0 1 | Value = 8750000 Fathomed |
| Starting Solution 5 | | |
| 0: | ? ? ? ? 1 ? ? ? 0 ? ? 0 ? ? ? ? ? ? ? ? 0 ? ? 0 ? | Value = 4250000 |
| 1: | 0 0 0 0 1 1 ? ? 0 ? ? 0 ? ? ? ? ? ? ? ? 0 ? ? 0 ? | Value = 6920000 |
| 2: | 0 0 0 0 1 1 1 ? 0 ? ? 0 ? ? ? ? ? ? ? ? 0 ? ? 0 ? | Value = 7920000 |
| 3: | 0 0 0 0 1 1 1 1 0 ? ? 0 ? ? ? ? ? ? ? ? 0 ? ? 0 ? | Value = 8795000 |
| 4: | 0 0 0 0 1 1 1 1 0 1 ? 0 ? ? ? ? ? ? ? ? 0 ? ? 0 ? | Value = 11295000 |
| 5: | 0 0 0 0 1 1 1 1 0 1 1 0 ? ? ? ? ? ? ? ? 0 ? ? 0 ? | Infeasible |
| 5: | 0 0 0 0 1 1 1 1 0 1 0 0 1 ? ? ? ? ? ? ? 0 ? ? 0 ? | Value = 12540000 |
| 6: | 0 0 0 0 1 1 1 1 0 1 0 0 1 1 ? ? ? ? ? ? 0 ? ? 0 ? | Value = 12585000 |
| 7: | 0 0 0 0 1 1 1 1 0 1 0 0 1 1 1 ? ? ? ? ? 0 ? ? 0 ? | Value = 13085000 |
| 8: | 0 0 0 0 1 1 1 1 0 1 0 0 1 1 1 1 ? ? ? ? 0 ? ? 0 ? | Infeasible |
| 8: | 0 0 0 0 1 1 1 1 0 1 0 0 1 1 1 0 1 ? ? ? 0 ? ? 0 ? | Infeasible |
| 8: | 0 0 0 0 1 1 1 1 0 1 0 0 1 1 1 0 0 1 ? ? 0 ? ? 0 ? | Infeasible |
| 8: | 0 0 0 0 1 1 1 1 0 1 0 0 1 1 1 0 0 0 1 ? 0 ? ? 0 ? | Infeasible |
| 8: | 0 0 0 0 1 1 1 1 0 1 0 0 1 1 1 0 0 0 0 1 0 ? ? 0 ? | Infeasible |
| 8: | 0 0 0 0 1 1 1 1 0 1 0 0 1 1 1 0 0 0 0 0 0 1 ? 0 ? | Value = 13100000 |
| 9: | 0 0 0 0 1 1 1 1 0 1 0 0 1 1 1 0 0 0 0 0 0 1 1 0 ? | Infeasible |
| 9: | 0 0 0 0 1 1 1 1 0 1 0 0 1 1 1 0 0 0 0 0 0 1 0 0 1 | Value = 17100000 |
| 8: | 0 0 0 0 1 1 1 1 0 1 0 0 1 1 1 0 0 0 0 0 0 1 1 0 ? | Infeasible Fathomed |
| 8: | 0 0 0 0 1 1 1 1 0 1 0 0 1 1 1 0 0 0 0 0 0 1 0 0 1 | Value = 17100000 (Maximal) Fathomed |
| 7: | 0 0 0 0 1 1 1 1 0 1 0 0 1 1 1 1 ? ? ? ? 0 ? ? 0 ? | Infeasible Fathomed |
| 7: | 0 0 0 0 1 1 1 1 0 1 0 0 1 1 1 0 1 ? ? ? 0 ? ? 0 ? | Infeasible Fathomed |
| 7: | 0 0 0 0 1 1 1 1 0 1 0 0 1 1 1 0 0 1 ? ? 0 ? ? 0 ? | Infeasible Fathomed |
| 7: | 0 0 0 0 1 1 1 1 0 1 0 0 1 1 1 0 0 0 1 ? 0 ? ? 0 ? | Infeasible Fathomed |
| 7: | 0 0 0 0 1 1 1 1 0 1 0 0 1 1 1 0 0 0 0 1 0 ? ? 0 ? | Infeasible Fathomed |
| 7: | 0 0 0 0 1 1 1 1 0 1 0 0 1 1 1 0 0 0 0 0 0 1 ? 0 ? | Value = 13100000 Fathomed |
| 7: | 0 0 0 0 1 1 1 1 0 1 0 0 1 1 1 0 0 0 0 0 0 0 1 0 ? | Infeasible Fathomed |
| 7: | 0 0 0 0 1 1 1 1 0 1 0 0 1 1 1 0 0 0 0 0 0 0 0 0 1 | Value = 17085000 Fathomed |
| 6: | 0 0 0 0 1 1 1 1 0 1 0 0 1 1 1 ? ? ? ? ? 0 ? ? 0 ? | Value = 13085000 Fathomed |
| 6: | 0 0 0 0 1 1 1 1 0 1 0 0 1 1 0 1 ? ? ? ? 0 ? ? 0 ? | Infeasible Fathomed |
| 6: | 0 0 0 0 1 1 1 1 0 1 0 0 1 1 0 0 1 ? ? ? 0 ? ? 0 ? | Infeasible Fathomed |
| 6: | 0 0 0 0 1 1 1 1 0 1 0 0 1 1 0 0 0 1 ? ? 0 ? ? 0 ? | Infeasible Fathomed |
| 6: | 0 0 0 0 1 1 1 1 0 1 0 0 1 1 0 0 0 0 1 ? 0 ? ? 0 ? | Infeasible Fathomed |
| 6: | 0 0 0 0 1 1 1 1 0 1 0 0 1 1 0 0 0 0 0 1 0 ? ? 0 ? | Infeasible Fathomed |
| 6: | 0 0 0 0 1 1 1 1 0 1 0 0 1 1 0 0 0 0 0 0 0 1 ? 0 ? | Value = 12600000 Fathomed |
| 6: | 0 0 0 0 1 1 1 1 0 1 0 0 1 1 0 0 0 0 0 0 0 0 1 0 ? | Infeasible Fathomed |
| 6: | 0 0 0 0 1 1 1 1 0 1 0 0 1 1 0 0 0 0 0 0 0 0 0 0 1 | Value = 16585000 Fathomed |
| 5: | 0 0 0 0 1 1 1 1 0 1 0 0 1 1 ? ? ? ? ? ? 0 ? ? 0 ? | Value = 12585000 Fathomed |
| 5: | 0 0 0 0 1 1 1 1 0 1 0 0 1 0 1 ? ? ? ? ? 0 ? ? 0 ? | Value = 13040000 Fathomed |
| 5: | 0 0 0 0 1 1 1 1 0 1 0 0 1 0 0 1 ? ? ? ? 0 ? ? 0 ? | Value = 13090000 Fathomed |
| 5: | 0 0 0 0 1 1 1 1 0 1 0 0 1 0 0 0 1 ? ? ? 0 ? ? 0 ? | Value = 12690000 Fathomed |
| 5: | 0 0 0 0 1 1 1 1 0 1 0 0 1 0 0 0 0 1 ? ? 0 ? ? 0 ? | Infeasible Fathomed |
| 5: | 0 0 0 0 1 1 1 1 0 1 0 0 1 0 0 0 0 0 1 ? 0 ? ? 0 ? | Infeasible Fathomed |
| 5: | 0 0 0 0 1 1 1 1 0 1 0 0 1 0 0 0 0 0 0 1 0 ? ? 0 ? | Value = 20040000 Fathomed |
| 5: | 0 0 0 0 1 1 1 1 0 1 0 0 1 0 0 0 0 0 0 0 0 1 ? 0 ? | Value = 12555000 Fathomed |
| 5: | 0 0 0 0 1 1 1 1 0 1 0 0 1 0 0 0 0 0 0 0 0 0 1 0 ? | Infeasible Fathomed |
| 5: | 0 0 0 0 1 1 1 1 0 1 0 0 1 0 0 0 0 0 0 0 0 0 0 0 1 | Value = 16540000 Fathomed |
| 4: | 0 0 0 0 1 1 1 1 0 1 1 0 ? ? ? ? ? ? ? ? 0 ? ? 0 ? | Infeasible Fathomed |
| 4: | 0 0 0 0 1 1 1 1 0 1 0 0 1 ? ? ? ? ? ? ? 0 ? ? 0 ? | Value = 12540000 Fathomed |
| 4: | 0 0 0 0 1 1 1 1 0 1 0 0 0 1 ? ? ? ? ? ? 0 ? ? 0 ? | Value = 11340000 Fathomed |
| 4: | 0 0 0 0 1 1 1 1 0 1 0 0 0 0 1 ? ? ? ? ? 0 ? ? 0 ? | Value = 11795000 Fathomed |
| 4: | 0 0 0 0 1 1 1 1 0 1 0 0 0 0 0 1 ? ? ? ? 0 ? ? 0 ? | Value = 11845000 Fathomed |
| 4: | 0 0 0 0 1 1 1 1 0 1 0 0 0 0 0 0 1 ? ? ? 0 ? ? 0 ? | Value = 11445000 Fathomed |
| 4: | 0 0 0 0 1 1 1 1 0 1 0 0 0 0 0 0 0 1 ? ? 0 ? ? 0 ? | Infeasible Fathomed |
| 4: | 0 0 0 0 1 1 1 1 0 1 0 0 0 0 0 0 0 0 1 ? 0 ? ? 0 ? | Value = 11370000 Fathomed |
| 4: | 0 0 0 0 1 1 1 1 0 1 0 0 0 0 0 0 0 0 0 1 0 ? ? 0 ? | Value = 18795000 Fathomed |
| 4: | 0 0 0 0 1 1 1 1 0 1 0 0 0 0 0 0 0 0 0 0 0 1 ? 0 ? | Value = 11310000 Fathomed |
| 4: | 0 0 0 0 1 1 1 1 0 1 0 0 0 0 0 0 0 0 0 0 0 0 1 0 ? | Infeasible Fathomed |
| 4: | 0 0 0 0 1 1 1 1 0 1 0 0 0 0 0 0 0 0 0 0 0 0 0 0 1 | Value = 15295000 Fathomed |
| 3: | 0 0 0 0 1 1 1 1 0 1 ? 0 ? ? ? ? ? ? ? ? 0 ? ? 0 ? | Value = 11295000 Fathomed |
| 3: | 0 0 0 0 1 1 1 1 0 0 1 0 ? ? ? ? ? ? ? ? 0 ? ? 0 ? | Infeasible Fathomed |
| 3: | 0 0 0 0 1 1 1 1 0 0 0 0 1 ? ? ? ? ? ? ? 0 ? ? 0 ? | Value = 10040000 Fathomed |
| 3: | 0 0 0 0 1 1 1 1 0 0 0 0 0 1 ? ? ? ? ? ? 0 ? ? 0 ? | Value = 8840000 Fathomed |
| 3: | 0 0 0 0 1 1 1 1 0 0 0 0 0 0 1 ? ? ? ? ? 0 ? ? 0 ? | Value = 9295000 Fathomed |
| 3: | 0 0 0 0 1 1 1 1 0 0 0 0 0 0 0 1 ? ? ? ? 0 ? ? 0 ? | Value = 9345000 Fathomed |
| 3: | 0 0 0 0 1 1 1 1 0 0 0 0 0 0 0 0 1 ? ? ? 0 ? ? 0 ? | Value = 8945000 Fathomed |
| 3: | 0 0 0 0 1 1 1 1 0 0 0 0 0 0 0 0 0 1 ? ? 0 ? ? 0 ? | Value = 10795000 Fathomed |
| 3: | 0 0 0 0 1 1 1 1 0 0 0 0 0 0 0 0 0 0 1 ? 0 ? ? 0 ? | Value = 8870000 Fathomed |
| 3: | 0 0 0 0 1 1 1 1 0 0 0 0 0 0 0 0 0 0 0 1 0 ? ? 0 ? | Value = 16295000 Fathomed |
| 3: | 0 0 0 0 1 1 1 1 0 0 0 0 0 0 0 0 0 0 0 0 0 1 ? 0 ? | Value = 8810000 Fathomed |
| 3: | 0 0 0 0 1 1 1 1 0 0 0 0 0 0 0 0 0 0 0 0 0 0 1 0 ? | Infeasible Fathomed |
| 3: | 0 0 0 0 1 1 1 1 0 0 0 0 0 0 0 0 0 0 0 0 0 0 0 0 1 | Value = 12795000 Fathomed |
| 2: | 0 0 0 0 1 1 1 1 0 ? ? 0 ? ? ? ? ? ? ? ? 0 ? ? 0 ? | Value = 8795000 Fathomed |
| 2: | 0 0 0 0 1 1 1 0 0 1 ? 0 ? ? ? ? ? ? ? ? 0 ? ? 0 ? | Value = 10420000 Fathomed |
| 2: | 0 0 0 0 1 1 1 0 0 0 1 0 ? ? ? ? ? ? ? ? 0 ? ? 0 ? | Infeasible Fathomed |
| 2: | 0 0 0 0 1 1 1 0 0 0 0 0 1 ? ? ? ? ? ? ? 0 ? ? 0 ? | Value = 9165000 Fathomed |
| 2: | 0 0 0 0 1 1 1 0 0 0 0 0 0 1 ? ? ? ? ? ? 0 ? ? 0 ? | Value = 7965000 Fathomed |
| 2: | 0 0 0 0 1 1 1 0 0 0 0 0 0 0 1 ? ? ? ? ? 0 ? ? 0 ? | Value = 8420000 Fathomed |
| 2: | 0 0 0 0 1 1 1 0 0 0 0 0 0 0 0 1 ? ? ? ? 0 ? ? 0 ? | Value = 8470000 Fathomed |
| 2: | 0 0 0 0 1 1 1 0 0 0 0 0 0 0 0 0 1 ? ? ? 0 ? ? 0 ? | Value = 8070000 Fathomed |
| 2: | 0 0 0 0 1 1 1 0 0 0 0 0 0 0 0 0 0 1 ? ? 0 ? ? 0 ? | Value = 9920000 Fathomed |
| 2: | 0 0 0 0 1 1 1 0 0 0 0 0 0 0 0 0 0 0 1 ? 0 ? ? 0 ? | Value = 7995000 Fathomed |
| 2: | 0 0 0 0 1 1 1 0 0 0 0 0 0 0 0 0 0 0 0 1 0 ? ? 0 ? | Value = 15420000 Fathomed |
| 2: | 0 0 0 0 1 1 1 0 0 0 0 0 0 0 0 0 0 0 0 0 0 1 ? 0 ? | Value = 7935000 Fathomed |
| 2: | 0 0 0 0 1 1 1 0 0 0 0 0 0 0 0 0 0 0 0 0 0 0 1 0 ? | Value = 9120000 Fathomed |
| 2: | 0 0 0 0 1 1 1 0 0 0 0 0 0 0 0 0 0 0 0 0 0 0 0 0 1 | Value = 11920000 Fathomed |
| 1: | 0 0 0 0 1 1 1 ? 0 ? ? 0 ? ? ? ? ? ? ? ? 0 ? ? 0 ? | Value = 7920000 Fathomed |
| 1: | 0 0 0 0 1 1 0 1 0 ? ? 0 ? ? ? ? ? ? ? ? 0 ? ? 0 ? | Value = 7795000 Fathomed |
| 1: | 0 0 0 0 1 1 0 0 0 1 ? 0 ? ? ? ? ? ? ? ? 0 ? ? 0 ? | Value = 9420000 Fathomed |
| 1: | 0 0 0 0 1 1 0 0 0 0 1 0 ? ? ? ? ? ? ? ? 0 ? ? 0 ? | Value = 7420000 Fathomed |
| 1: | 0 0 0 0 1 1 0 0 0 0 0 0 1 ? ? ? ? ? ? ? 0 ? ? 0 ? | Value = 8165000 Fathomed |
| 1: | 0 0 0 0 1 1 0 0 0 0 0 0 0 1 ? ? ? ? ? ? 0 ? ? 0 ? | Value = 6965000 Fathomed |
| 1: | 0 0 0 0 1 1 0 0 0 0 0 0 0 0 1 ? ? ? ? ? 0 ? ? 0 ? | Value = 7420000 Fathomed |
| 1: | 0 0 0 0 1 1 0 0 0 0 0 0 0 0 0 1 ? ? ? ? 0 ? ? 0 ? | Value = 7470000 Fathomed |
| 1: | 0 0 0 0 1 1 0 0 0 0 0 0 0 0 0 0 1 ? ? ? 0 ? ? 0 ? | Value = 7070000 Fathomed |
| 1: | 0 0 0 0 1 1 0 0 0 0 0 0 0 0 0 0 0 1 ? ? 0 ? ? 0 ? | Value = 8920000 Fathomed |
| 1: | 0 0 0 0 1 1 0 0 0 0 0 0 0 0 0 0 0 0 1 ? 0 ? ? 0 ? | Value = 6995000 Fathomed |
| 1: | 0 0 0 0 1 1 0 0 0 0 0 0 0 0 0 0 0 0 0 1 0 ? ? 0 ? | Value = 14420000 Fathomed |
| 1: | 0 0 0 0 1 1 0 0 0 0 0 0 0 0 0 0 0 0 0 0 0 1 ? 0 ? | Value = 6935000 Fathomed |
| 1: | 0 0 0 0 1 1 0 0 0 0 0 0 0 0 0 0 0 0 0 0 0 0 1 0 ? | Value = 8120000 Fathomed |
| 1: | 0 0 0 0 1 1 0 0 0 0 0 0 0 0 0 0 0 0 0 0 0 0 0 0 1 | Value = 10920000 Fathomed |
| Starting Solution 6 | | |
| 0: | ? ? ? ? ? 1 ? ? 0 ? ? 0 ? ? ? ? ? ? ? ? 0 ? ? 0 ? | Value = 2670000 |
| 1: | 0 0 0 0 0 1 1 ? 0 ? ? 0 ? ? ? ? ? ? ? ? 0 ? ? 0 ? | Value = 3670000 |
| 2: | 0 0 0 0 0 1 1 1 0 ? ? 0 ? ? ? ? ? ? ? ? 0 ? ? 0 ? | Value = 4545000 |
| 3: | 0 0 0 0 0 1 1 1 0 1 ? 0 ? ? ? ? ? ? ? ? 0 ? ? 0 ? | Value = 7045000 |
| 4: | 0 0 0 0 0 1 1 1 0 1 1 0 ? ? ? ? ? ? ? ? 0 ? ? 0 ? | Value = 7545000 |
| 5: | 0 0 0 0 0 1 1 1 0 1 1 0 1 ? ? ? ? ? ? ? 0 ? ? 0 ? | Infeasible |
| 5: | 0 0 0 0 0 1 1 1 0 1 1 0 0 1 ? ? ? ? ? ? 0 ? ? 0 ? | Infeasible |
| 5: | 0 0 0 0 0 1 1 1 0 1 1 0 0 0 1 ? ? ? ? ? 0 ? ? 0 ? | Infeasible |
| 5: | 0 0 0 0 0 1 1 1 0 1 1 0 0 0 0 1 ? ? ? ? 0 ? ? 0 ? | Value = 8095000 |
| 6: | 0 0 0 0 0 1 1 1 0 1 1 0 0 0 0 1 1 ? ? ? 0 ? ? 0 ? | Value = 8245000 |
| 7: | 0 0 0 0 0 1 1 1 0 1 1 0 0 0 0 1 1 1 ? ? 0 ? ? 0 ? | Infeasible |
| 7: | 0 0 0 0 0 1 1 1 0 1 1 0 0 0 0 1 1 0 1 ? 0 ? ? 0 ? | Infeasible |
| 7: | 0 0 0 0 0 1 1 1 0 1 1 0 0 0 0 1 1 0 0 1 0 ? ? 0 ? | Value = 15745000 |
| 8: | 0 0 0 0 0 1 1 1 0 1 1 0 0 0 0 1 1 0 0 1 0 1 ? 0 ? | Value = 15760000 |
| 9: | 0 0 0 0 0 1 1 1 0 1 1 0 0 0 0 1 1 0 0 1 0 1 1 0 ? | Infeasible |
| 9: | 0 0 0 0 0 1 1 1 0 1 1 0 0 0 0 1 1 0 0 1 0 1 0 0 1 | Infeasible |
| 8: | 0 0 0 0 0 1 1 1 0 1 1 0 0 0 0 1 1 0 0 1 0 1 1 0 ? | Infeasible Fathomed |
| 8: | 0 0 0 0 0 1 1 1 0 1 1 0 0 0 0 1 1 0 0 1 0 1 0 0 1 | Infeasible Fathomed |
| 7: | 0 0 0 0 0 1 1 1 0 1 1 0 0 0 0 1 1 0 0 1 0 1 ? 0 ? | Value = 15760000 Fathomed |
| 7: | 0 0 0 0 0 1 1 1 0 1 1 0 0 0 0 1 1 0 0 1 0 0 1 0 ? | Infeasible Fathomed |
| 7: | 0 0 0 0 0 1 1 1 0 1 1 0 0 0 0 1 1 0 0 1 0 0 0 0 1 | Infeasible Fathomed |
| 6: | 0 0 0 0 0 1 1 1 0 1 1 0 0 0 0 1 1 1 ? ? 0 ? ? 0 ? | Infeasible Fathomed |
| 6: | 0 0 0 0 0 1 1 1 0 1 1 0 0 0 0 1 1 0 1 ? 0 ? ? 0 ? | Infeasible Fathomed |
| 6: | 0 0 0 0 0 1 1 1 0 1 1 0 0 0 0 1 1 0 0 1 0 ? ? 0 ? | Value = 15745000 Fathomed |
| 6: | 0 0 0 0 0 1 1 1 0 1 1 0 0 0 0 1 1 0 0 0 0 1 ? 0 ? | Value = 8260000 Fathomed |
| 6: | 0 0 0 0 0 1 1 1 0 1 1 0 0 0 0 1 1 0 0 0 0 0 1 0 ? | Value = 9445000 Fathomed |
| 6: | 0 0 0 0 0 1 1 1 0 1 1 0 0 0 0 1 1 0 0 0 0 0 0 0 1 | Value = 12245000 Fathomed |
| 5: | 0 0 0 0 0 1 1 1 0 1 1 0 0 0 0 1 1 ? ? ? 0 ? ? 0 ? | Value = 8245000 Fathomed |
| 5: | 0 0 0 0 0 1 1 1 0 1 1 0 0 0 0 1 0 1 ? ? 0 ? ? 0 ? | Infeasible Fathomed |
| 5: | 0 0 0 0 0 1 1 1 0 1 1 0 0 0 0 1 0 0 1 ? 0 ? ? 0 ? | Infeasible Fathomed |
| 5: | 0 0 0 0 0 1 1 1 0 1 1 0 0 0 0 1 0 0 0 1 0 ? ? 0 ? | Value = 15595000 Fathomed |
| 5: | 0 0 0 0 0 1 1 1 0 1 1 0 0 0 0 1 0 0 0 0 0 1 ? 0 ? | Value = 8110000 Fathomed |
| 5: | 0 0 0 0 0 1 1 1 0 1 1 0 0 0 0 1 0 0 0 0 0 0 1 0 ? | Value = 9295000 Fathomed |
| 5: | 0 0 0 0 0 1 1 1 0 1 1 0 0 0 0 1 0 0 0 0 0 0 0 0 1 | Value = 12095000 Fathomed |
| 4: | 0 0 0 0 0 1 1 1 0 1 1 0 1 ? ? ? ? ? ? ? 0 ? ? 0 ? | Infeasible Fathomed |
| 4: | 0 0 0 0 0 1 1 1 0 1 1 0 0 1 ? ? ? ? ? ? 0 ? ? 0 ? | Infeasible Fathomed |
| 4: | 0 0 0 0 0 1 1 1 0 1 1 0 0 0 1 ? ? ? ? ? 0 ? ? 0 ? | Infeasible Fathomed |
| 4: | 0 0 0 0 0 1 1 1 0 1 1 0 0 0 0 1 ? ? ? ? 0 ? ? 0 ? | Value = 8095000 Fathomed |
| 4: | 0 0 0 0 0 1 1 1 0 1 1 0 0 0 0 0 1 ? ? ? 0 ? ? 0 ? | Value = 7695000 Fathomed |
| 4: | 0 0 0 0 0 1 1 1 0 1 1 0 0 0 0 0 0 1 ? ? 0 ? ? 0 ? | Infeasible Fathomed |
| 4: | 0 0 0 0 0 1 1 1 0 1 1 0 0 0 0 0 0 0 1 ? 0 ? ? 0 ? | Infeasible Fathomed |
| 4: | 0 0 0 0 0 1 1 1 0 1 1 0 0 0 0 0 0 0 0 1 0 ? ? 0 ? | Value = 15045000 Fathomed |
| 4: | 0 0 0 0 0 1 1 1 0 1 1 0 0 0 0 0 0 0 0 0 0 1 ? 0 ? | Value = 7560000 Fathomed |
| 4: | 0 0 0 0 0 1 1 1 0 1 1 0 0 0 0 0 0 0 0 0 0 0 1 0 ? | Value = 8745000 Fathomed |
| 4: | 0 0 0 0 0 1 1 1 0 1 1 0 0 0 0 0 0 0 0 0 0 0 0 0 1 | Value = 11545000 Fathomed |
| 3: | 0 0 0 0 0 1 1 1 0 1 1 0 ? ? ? ? ? ? ? ? 0 ? ? 0 ? | Value = 7545000 Fathomed |
| 3: | 0 0 0 0 0 1 1 1 0 1 0 0 1 ? ? ? ? ? ? ? 0 ? ? 0 ? | Value = 8290000 Fathomed |
| 3: | 0 0 0 0 0 1 1 1 0 1 0 0 0 1 ? ? ? ? ? ? 0 ? ? 0 ? | Value = 7090000 Fathomed |
| 3: | 0 0 0 0 0 1 1 1 0 1 0 0 0 0 1 ? ? ? ? ? 0 ? ? 0 ? | Value = 7545000 Fathomed |
| 3: | 0 0 0 0 0 1 1 1 0 1 0 0 0 0 0 1 ? ? ? ? 0 ? ? 0 ? | Value = 7595000 Fathomed |
| 3: | 0 0 0 0 0 1 1 1 0 1 0 0 0 0 0 0 1 ? ? ? 0 ? ? 0 ? | Value = 7195000 Fathomed |
| 3: | 0 0 0 0 0 1 1 1 0 1 0 0 0 0 0 0 0 1 ? ? 0 ? ? 0 ? | Value = 9045000 Fathomed |
| 3: | 0 0 0 0 0 1 1 1 0 1 0 0 0 0 0 0 0 0 1 ? 0 ? ? 0 ? | Value = 7120000 Fathomed |
| 3: | 0 0 0 0 0 1 1 1 0 1 0 0 0 0 0 0 0 0 0 1 0 ? ? 0 ? | Value = 14545000 Fathomed |
| 3: | 0 0 0 0 0 1 1 1 0 1 0 0 0 0 0 0 0 0 0 0 0 1 ? 0 ? | Value = 7060000 Fathomed |
| 3: | 0 0 0 0 0 1 1 1 0 1 0 0 0 0 0 0 0 0 0 0 0 0 1 0 ? | Value = 8245000 Fathomed |
| 3: | 0 0 0 0 0 1 1 1 0 1 0 0 0 0 0 0 0 0 0 0 0 0 0 0 1 | Value = 11045000 Fathomed |
| 2: | 0 0 0 0 0 1 1 10 1 ? 0 ? ? ? ? ? ? ? ? 0 ? ? 0 ? | Value = 7045000 Fathomed |
| 2: | 0 0 0 0 0 1 1 1 0 0 1 0 ? ? ? ? ? ? ? ? 0 ? ? 0 ? | Value = 5045000 Fathomed |
| 2: | 0 0 0 0 0 1 1 1 0 0 0 0 1 ? ? ? ? ? ? ? 0 ? ? 0 ? | Value = 5790000 Fathomed |
| 2: | 0 0 0 0 0 1 1 1 0 0 0 0 0 1 ? ? ? ? ? ? 0 ? ? 0 ? | Value = 4590000 Fathomed |
| 2: | 0 0 0 0 0 1 1 1 0 0 0 0 0 0 1 ? ? ? ? ? 0 ? ? 0 ? | Value = 5045000 Fathomed |
| 2: | 0 0 0 0 0 1 1 1 0 0 0 0 0 0 0 1 ? ? ? ? 0 ? ? 0 ? | Value = 5095000 Fathomed |
| 2: | 0 0 0 0 0 1 1 1 0 0 0 0 0 0 0 0 1 ? ? ? 0 ? ? 0 ? | Value = 4695000 Fathomed |
| 2: | 0 0 0 0 0 1 1 1 0 0 0 0 0 0 0 0 0 1 ? ? 0 ? ? 0 ? | Value = 6545000 Fathomed |
| 2: | 0 0 0 0 0 1 1 1 0 0 0 0 0 0 0 0 0 0 1 ? 0 ? ? 0 ? | Value = 4620000 Fathomed |
| 2: | 0 0 0 0 0 1 1 1 0 0 0 0 0 0 0 0 0 0 0 1 0 ? ? 0 ? | Value = 12045000 Fathomed |
| 2: | 0 0 0 0 0 1 1 1 0 0 0 0 0 0 0 0 0 0 0 0 0 1 ? 0 ? | Value = 4560000 Fathomed |
| 2: | 0 0 0 0 0 1 1 1 0 0 0 0 0 0 0 0 0 0 0 0 0 0 1 0 ? | Value = 5745000 Fathomed |
| 2: | 0 0 0 0 0 1 1 1 0 0 0 0 0 0 0 0 0 0 0 0 0 0 0 0 1 | Value = 8545000 Fathomed |
| 1: | 0 0 0 0 0 1 1 1 0 ? ? 0 ? ? ? ? ? ? ? ? 0 ? ? 0 ? | Value = 4545000 Fathomed |
| 1: | 0 0 0 0 0 1 1 0 0 1 ? 0 ? ? ? ? ? ? ? ? 0 ? ? 0 ? | Value = 6170000 Fathomed |
| 1: | 0 0 0 0 0 1 1 0 0 0 1 0 ? ? ? ? ? ? ? ? 0 ? ? 0 ? | Value = 4170000 Fathomed |
| 1: | 0 0 0 0 0 1 1 0 0 0 0 0 1 ? ? ? ? ? ? ? 0 ? ? 0 ? | Value = 4915000 Fathomed |
| 1: | 0 0 0 0 0 1 1 0 0 0 0 0 0 1 ? ? ? ? ? ? 0 ? ? 0 ? | Value = 3715000 Fathomed |
| 1: | 0 0 0 0 0 1 1 0 0 0 0 0 0 0 1 ? ? ? ? ? 0 ? ? 0 ? | Value = 4170000 Fathomed |
| 1: | 0 0 0 0 0 1 1 0 0 0 0 0 0 0 0 1 ? ? ? ? 0 ? ? 0 ? | Value = 4220000 Fathomed |
| 1: | 0 0 0 0 0 1 1 0 0 0 0 0 0 0 0 0 1 ? ? ? 0 ? ? 0 ? | Value = 3820000 Fathomed |
| 1: | 0 0 0 0 0 1 1 0 0 0 0 0 0 0 0 0 0 1 ? ? 0 ? ? 0 ? | Value = 5670000 Fathomed |
| 1: | 0 0 0 0 0 1 1 0 0 0 0 0 0 0 0 0 0 0 1 ? 0 ? ? 0 ? | Value = 3745000 Fathomed |
| 1: | 0 0 0 0 0 1 1 0 0 0 0 0 0 0 0 0 0 0 0 1 0 ? ? 0 ? | Value = 11170000 Fathomed |
| 1: | 0 0 0 0 0 1 1 0 0 0 0 0 0 0 0 0 0 0 0 0 0 1 ? 0 ? | Value = 3685000 Fathomed |
| 1: | 0 0 0 0 0 1 1 0 0 0 0 0 0 0 0 0 0 0 0 0 0 0 1 0 ? | Value = 4870000 Fathomed |
| 1: | 0 0 0 0 0 1 1 0 0 0 0 0 0 0 0 0 0 0 0 0 0 0 0 0 1 | Value = 7670000 Fathomed |
| Starting Solution 7 | | |
| 0: | ? ? ? ? ? ? 1 ? 0 ? ? 0 ? ? ? ? ? ? ? ? 0 ? ? 0 ? | Value = 1000000 |
| 1: | 0 0 0 0 0 0 1 1 0 ? ? 0 ? ? ? ? ? ? ? ? 0 ? ? 0 ? | Value = 1875000 |
| 2: | 0 0 0 0 0 0 1 1 0 1 ? 0 ? ? ? ? ? ? ? ? 0 ? ? 0 ? | Value = 4375000 |
| 3: | 0 0 0 0 0 0 1 1 0 1 1 0 ? ? ? ? ? ? ? ? 0 ? ? 0 ? | Value = 4875000 |
| 4: | 0 0 0 0 0 0 1 1 0 1 1 0 1 ? ? ? ? ? ? ? 0 ? ? 0 ? | Value = 6120000 |
| 5: | 0 0 0 0 0 0 1 1 0 1 1 0 1 1 ? ? ? ? ? ? 0 ? ? 0 ? | Infeasible |
| 5: | 0 0 0 0 0 0 1 1 0 1 1 0 1 0 1 ? ? ? ? ? 0 ? ? 0 ? | Infeasible |
| 5: | 0 0 0 0 0 0 1 1 0 1 1 0 1 0 0 1 ? ? ? ? 0 ? ? 0 ? | Value = 6670000 |
| 6: | 0 0 0 0 0 0 1 1 0 1 1 0 1 0 0 1 1 ? ? ? 0 ? ? 0 ? | Value = 6820000 |
| 7: | 0 0 0 0 0 0 1 1 0 1 1 0 1 0 0 1 1 1 ? ? 0 ? ? 0 ? | Infeasible |
| 7: | 0 0 0 0 0 0 1 1 0 1 1 0 1 0 0 1 1 0 1 ? 0 ? ? 0 ? | Infeasible |
| 7: | 0 0 0 0 0 0 1 1 0 1 1 0 1 0 0 1 1 0 0 1 0 ? ? 0 ? | Value = 14320000 |
| 8: | 0 0 0 0 0 0 1 1 0 1 1 0 1 0 0 1 1 0 0 1 0 1 ? 0 ? | Value = 14335000 |
| 9: | 0 0 0 0 0 0 1 1 0 1 1 0 1 0 0 1 1 0 0 1 0 1 1 0 ? | Infeasible |
| 9: | 0 0 0 0 0 0 1 1 0 1 1 0 1 0 0 1 1 0 0 1 0 1 0 0 1 | Infeasible |
| 8: | 0 0 0 0 0 0 1 1 0 1 1 0 1 0 0 1 1 0 0 1 0 1 1 0 ? | Infeasible Fathomed |
| 8: | 0 0 0 0 0 0 1 1 0 1 1 0 1 0 0 1 1 0 0 1 0 1 0 0 1 | Infeasible Fathomed |
| 7: | 0 0 0 0 0 0 1 1 0 1 1 0 1 0 0 1 1 0 0 1 0 1 ? 0 ? | Value = 14335000 Fathomed |
| 7: | 0 0 0 0 0 0 1 1 0 1 1 0 1 0 0 1 1 0 0 1 0 0 1 0 ? | Infeasible Fathomed |
| 7: | 0 0 0 0 0 0 1 1 0 1 1 0 1 0 0 1 1 0 0 1 0 0 0 0 1 | Infeasible Fathomed |
| 6: | 0 0 0 0 0 0 1 1 0 1 1 0 1 0 0 1 1 1 ? ? 0 ? ? 0 ? | Infeasible Fathomed |
| 6: | 0 0 0 0 0 0 1 1 0 1 1 0 1 0 0 1 1 0 1 ? 0 ? ? 0 ? | Infeasible Fathomed |
| 6: | 0 0 0 0 0 0 1 1 0 1 1 0 1 0 0 1 1 0 0 1 0 ? ? 0 ? | Value = 14320000 Fathomed |
| 6: | 0 0 0 0 0 0 1 1 0 1 1 0 1 0 0 1 1 0 0 0 0 1 ? 0 ? | Value = 6835000 Fathomed |
| 6: | 0 0 0 0 0 0 1 1 0 1 1 0 1 0 0 1 1 0 0 0 0 0 1 0 ? | Infeasible Fathomed |
| 6: | 0 0 0 0 0 0 1 1 0 1 1 0 1 0 0 1 1 0 0 0 0 0 0 0 1 | Value = 10820000 Fathomed |
| 5: | 0 0 0 0 0 0 1 1 0 1 1 0 1 0 0 1 1 ? ? ? 0 ? ? 0 ? | Value = 6820000 Fathomed |
| 5: | 0 0 0 0 0 0 1 1 0 1 1 0 1 0 0 1 0 1 ? ? 0 ? ? 0 ? | Infeasible Fathomed |
| 5: | 0 0 0 0 0 0 1 1 0 1 1 0 1 0 0 1 0 0 1 ? 0 ? ? 0 ? | Infeasible Fathomed |
| 5: | 0 0 0 0 0 0 1 1 0 1 1 0 1 0 0 1 0 0 0 1 0 ? ? 0 ? | Value = 14170000 Fathomed |
| 5: | 0 0 0 0 0 0 1 1 0 1 1 0 1 0 0 1 0 0 0 0 0 1 ? 0 ? | Value = 6685000 Fathomed |
| 5: | 0 0 0 0 0 0 1 1 0 1 1 0 1 0 0 1 0 0 0 0 0 0 1 0 ? | Infeasible Fathomed |
| 5: | 0 0 0 0 0 0 1 1 0 1 1 0 1 0 0 1 0 0 0 0 0 0 0 0 1 | Value = 10670000 Fathomed |
| 4: | 0 0 0 0 0 0 1 1 0 1 1 0 1 1 ? ? ? ? ? ? 0 ? ? 0 ? | Infeasible Fathomed |
| 4: | 0 0 0 0 0 0 1 1 0 1 1 0 1 0 1 ? ? ? ? ? 0 ? ? 0 ? | Infeasible Fathomed |
| 4: | 0 0 0 0 0 0 1 1 0 1 1 0 1 0 0 1 ? ? ? ? 0 ? ? 0 ? | Value = 6670000 Fathomed |
| 4: | 0 0 0 0 0 0 1 1 0 1 1 0 1 0 0 0 1 ? ? ? 0 ? ? 0 ? | Value = 6270000 Fathomed |
| 4: | 0 0 0 0 0 0 1 1 0 1 1 0 1 0 0 0 0 1 ? ? 0 ? ? 0 ? | Infeasible Fathomed |
| 4: | 0 0 0 0 0 0 1 1 0 1 1 0 1 0 0 0 0 0 1 ? 0 ? ? 0 ? | Infeasible Fathomed |
| 4: | 0 0 0 0 0 0 1 1 0 1 1 0 1 0 0 0 0 0 0 1 0 ? ? 0 ? | Value = 13620000 Fathomed |
| 4: | 0 0 0 0 0 0 1 1 0 1 1 0 1 0 0 0 0 0 0 0 0 1 ? 0 ? | Value = 6135000 Fathomed |
| 4: | 0 0 0 0 0 0 1 1 0 1 1 0 1 0 0 0 0 0 0 0 0 0 1 0 ? | Infeasible Fathomed |
| 4: | 0 0 0 0 0 0 1 1 0 1 1 0 1 0 0 0 0 0 0 0 0 0 0 0 1 | Value = 10120000 Fathomed |
| 3: | 0 0 0 0 0 0 1 1 0 1 1 0 1 ? ? ? ? ? ? ? 0 ? ? 0 ? | Value = 6120000 Fathomed |
| 3: | 0 0 0 0 0 0 1 1 0 1 1 0 0 1 ? ? ? ? ? ? 0 ? ? 0 ? | Infeasible Fathomed |
| 3: | 0 0 0 0 0 0 1 1 0 1 1 0 0 0 1 ? ? ? ? ? 0 ? ? 0 ? | Infeasible Fathomed |
| 3: | 0 0 0 0 0 0 1 1 0 1 1 0 0 0 0 1 ? ? ? ? 0 ? ? 0 ? | Value = 5425000 Fathomed |
| 3: | 0 0 0 0 0 0 1 1 0 1 1 0 0 0 0 0 1 ? ? ? 0 ? ? 0 ? | Value = 5025000 Fathomed |
| 3: | 0 0 0 0 0 0 1 1 0 1 1 0 0 0 0 0 0 1 ? ? 0 ? ? 0 ? | Infeasible Fathomed |
| 3: | 0 0 0 0 0 0 1 1 0 1 1 0 0 0 0 0 0 0 1 ? 0 ? ? 0 ? | Infeasible Fathomed |
| 3: | 0 0 0 0 0 0 1 1 0 1 1 0 0 0 0 0 0 0 0 1 0 ? ? 0 ? | Value = 12375000 Fathomed |
| 3: | 0 0 0 0 0 0 1 1 0 1 1 0 0 0 0 0 0 0 0 0 0 1 ? 0 ? | Value = 4890000 Fathomed |
| 3: | 0 0 0 0 0 0 1 1 0 1 1 0 0 0 0 0 0 0 0 0 0 0 1 0 ? | Value = 6075000 Fathomed |
| 3: | 0 0 0 0 0 0 1 1 0 1 1 0 0 0 0 0 0 0 0 0 0 0 0 0 1 | Value = 8875000 Fathomed |
| 2: | 0 0 0 0 0 0 1 1 0 1 1 0 ? ? ? ? ? ? ? ? 0 ? ? 0 ? | Value = 4875000 Fathomed |
| 2: | 0 0 0 0 0 0 1 1 0 1 0 0 1 ? ? ? ? ? ? ? 0 ? ? 0 ? | Value = 5620000 Fathomed |
| 2: | 0 0 0 0 0 0 1 1 0 1 0 0 0 1 ? ? ? ? ? ? 0 ? ? 0 ? | Value = 4420000 Fathomed |
| 2: | 0 0 0 0 0 0 1 1 0 1 0 0 0 0 1 ? ? ? ? ? 0 ? ? 0 ? | Value = 4875000 Fathomed |
| 2: | 0 0 0 0 0 0 1 1 0 1 0 0 0 0 0 1 ? ? ? ? 0 ? ? 0 ? | Value = 4925000 Fathomed |
| 2: | 0 0 0 0 0 0 1 1 0 1 0 0 0 0 0 0 1 ? ? ? 0 ? ? 0 ? | Value = 4525000 Fathomed |
| 2: | 0 0 0 0 0 0 1 1 0 1 0 0 0 0 0 0 0 1 ? ? 0 ? ? 0 ? | Value = 6375000 Fathomed |
| 2: | 0 0 0 0 0 0 1 1 0 1 0 0 0 0 0 0 0 0 1 ? 0 ? ? 0 ? | Value = 4450000 Fathomed |
| 2: | 0 0 0 0 0 0 1 1 0 1 0 0 0 0 0 0 0 0 0 1 0 ? ? 0 ? | Value = 11875000 Fathomed |
| 2: | 0 0 0 0 0 0 1 1 0 1 0 0 0 0 0 0 0 0 0 0 0 1 ? 0 ? | Value = 4390000 Fathomed |
| 2: | 0 0 0 0 0 0 1 1 0 1 0 0 0 0 0 0 0 0 0 0 0 0 1 0 ? | Value = 5575000 Fathomed |
| 2: | 0 0 0 0 0 0 1 1 0 1 0 0 0 0 0 0 0 0 0 0 0 0 0 0 1 | Value = 8375000 Fathomed |
| 1: | 0 0 0 0 0 0 1 1 0 1 ? 0 ? ? ? ? ? ? ? ? 0 ? ? 0 ? | Value = 4375000 Fathomed |
| 1: | 0 0 0 0 0 0 1 1 0 0 1 0 ? ? ? ? ? ? ? ? 0 ? ? 0 ? | Value = 2375000 Fathomed |
| 1: | 0 0 0 0 0 0 1 1 0 0 0 0 1 ? ? ? ? ? ? ? 0 ? ? 0 ? | Value = 3120000 Fathomed |
| 1: | 0 0 0 0 0 0 1 1 0 0 0 0 0 1 ? ? ? ? ? ? 0 ? ? 0 ? | Value = 1920000 Fathomed |
| 1: | 0 0 0 0 0 0 1 1 0 0 0 0 0 0 1 ? ? ? ? ? 0 ? ? 0 ? | Value = 2375000 Fathomed |
| 1: | 0 0 0 0 0 0 1 1 0 0 0 0 0 0 0 1 ? ? ? ? 0 ? ? 0 ? | Value = 2425000 Fathomed |
| 1: | 0 0 0 0 0 0 1 1 0 0 0 0 0 0 0 0 1 ? ? ? 0 ? ? 0 ? | Value = 2025000 Fathomed |
| 1: | 0 0 0 0 0 0 1 1 0 0 0 0 0 0 0 0 0 1 ? ? 0 ? ? 0 ? | Value = 3875000 Fathomed |
| 1: | 0 0 0 0 0 0 1 1 0 0 0 0 0 0 0 0 0 0 1 ? 0 ? ? 0 ? | Value = 1950000 Fathomed |
| 1: | 0 0 0 0 0 0 1 1 0 0 0 0 0 0 0 0 0 0 0 1 0 ? ? 0 ? | Value = 9375000 Fathomed |
| 1: | 0 0 0 0 0 0 1 1 0 0 0 0 0 0 0 0 0 0 0 0 0 1 ? 0 ? | Value = 1890000 Fathomed |
| 1: | 0 0 0 0 0 0 1 1 0 0 0 0 0 0 0 0 0 0 0 0 0 0 1 0 ? | Value = 3075000 Fathomed |
| 1: | 0 0 0 0 0 0 1 1 0 0 0 0 0 0 0 0 0 0 0 0 0 0 0 0 1 | Value = 5875000 Fathomed |
| Starting Solution 8 | | |
| 0: | ? ? ? ? ? ? ? 1 0 ? ? 0 ? ? ? ? ? ? ? ? 0 ? ? 0 ? | Value = 875000 |
| 1: | 0 0 0 0 0 0 0 1 0 1 ? 0 ? ? ? ? ? ? ? ? 0 ? ? 0 ? | Value = 3375000 |
| 2: | 0 0 0 0 0 0 0 1 0 1 1 0 ? ? ? ? ? ? ? ? 0 ? ? 0 ? | Value = 3875000 |
| 3: | 0 0 0 0 0 0 0 1 0 1 1 0 1 ? ? ? ? ? ? ? 0 ? ? 0 ? | Value = 5120000 |
| 4: | 0 0 0 0 0 0 0 1 0 1 1 0 1 1 ? ? ? ? ? ? 0 ? ? 0 ? | Value = 5165000 |
| 5: | 0 0 0 0 0 0 0 1 0 1 1 0 1 1 1 ? ? ? ? ? 0 ? ? 0 ? | Infeasible |
| 5: | 0 0 0 0 0 0 0 1 0 1 1 0 1 1 0 1 ? ? ? ? 0 ? ? 0 ? | Value = 5715000 |
| 6: | 0 0 0 0 0 0 0 1 0 1 1 0 1 1 0 1 1 ? ? ? 0 ? ? 0 ? | Value = 5865000 |
| 7: | 0 0 0 0 0 0 0 1 0 1 1 0 1 1 0 1 1 1 ? ? 0 ? ? 0 ? | Infeasible |
| 7: | 0 0 0 0 0 0 0 1 0 1 1 0 1 1 0 1 1 0 1 ? 0 ? ? 0 ? | Infeasible |
| 7: | 0 0 0 0 0 0 0 1 0 1 1 0 1 1 0 1 1 0 0 1 0 ? ? 0 ? | Value = 13365000 |
| 8: | 0 0 0 0 0 0 0 1 0 1 1 0 1 1 0 1 1 0 0 1 0 1 ? 0 ? | Value = 13380000 |
| 9: | 0 0 0 0 0 0 0 1 0 1 1 0 1 1 0 1 1 0 0 1 0 1 1 0 ? | Infeasible |
| 9: | 0 0 0 0 0 0 0 1 0 1 1 0 1 1 0 1 1 0 0 1 0 1 0 0 1 | Infeasible |
| 8: | 0 0 0 0 0 0 0 1 0 1 1 0 1 1 0 1 1 0 0 1 0 1 1 0 ? | Infeasible Fathomed |
| 8: | 0 0 0 0 0 0 0 1 0 1 1 0 1 1 0 1 1 0 0 1 0 1 0 0 1 | Infeasible Fathomed |
| 7: | 0 0 0 0 0 0 0 1 0 1 1 0 1 1 0 1 1 0 0 1 0 1 ? 0 ? | Value = 13380000 Fathomed |
| 7: | 0 0 0 0 0 0 0 1 0 1 1 0 1 1 0 1 1 0 0 1 0 0 1 0 ? | Infeasible Fathomed |
| 7: | 0 0 0 0 0 0 0 1 0 1 1 0 1 1 0 1 1 0 0 1 0 0 0 0 1 | Infeasible Fathomed |
| 6: | 0 0 0 0 0 0 0 1 0 1 1 0 1 1 0 1 1 1 ? ? 0 ? ? 0 ? | Infeasible Fathomed |
| 6: | 0 0 0 0 0 0 0 1 0 1 1 0 1 1 0 1 1 0 1 ? 0 ? ? 0 ? | Infeasible Fathomed |
| 6: | 0 0 0 0 0 0 0 1 0 1 1 0 1 1 0 1 1 0 0 1 0 ? ? 0 ? | Value = 13365000 Fathomed |
| 6: | 0 0 0 0 0 0 0 1 0 1 1 0 1 1 0 1 1 0 0 0 0 1 ? 0 ? | Value = 5880000 Fathomed |
| 6: | 0 0 0 0 0 0 0 1 0 1 1 0 1 1 0 1 1 0 0 0 0 0 1 0 ? | Infeasible Fathomed |
| 6: | 0 0 0 0 0 0 0 1 0 1 1 0 1 1 0 1 1 0 0 0 0 0 0 0 1 | Value = 9865000 Fathomed |
| 5: | 0 0 0 0 0 0 0 1 0 1 1 0 1 1 0 1 1 ? ? ? 0 ? ? 0 ? | Value = 5865000 Fathomed |
| 5: | 0 0 0 0 0 0 0 1 0 1 1 0 1 1 0 1 0 1 ? ? 0 ? ? 0 ? | Infeasible Fathomed |
| 5: | 0 0 0 0 0 0 0 1 0 1 1 0 1 1 0 1 0 0 1 ? 0 ? ? 0 ? | Infeasible Fathomed |
| 5: | 0 0 0 0 0 0 0 1 0 1 1 0 1 1 0 1 0 0 0 1 0 ? ? 0 ? | Value = 13215000 Fathomed |
| 5: | 0 0 0 0 0 0 0 1 0 1 1 0 1 1 0 1 0 0 0 0 0 1 ? 0 ? | Value = 5730000 Fathomed |
| 5: | 0 0 0 0 0 0 0 1 0 1 1 0 1 1 0 1 0 0 0 0 0 0 1 0 ? | Infeasible Fathomed |
| 5: | 0 0 0 0 0 0 0 1 0 1 1 0 1 1 0 1 0 0 0 0 0 0 0 0 1 | Value = 9715000 Fathomed |
| 4: | 0 0 0 0 0 0 0 1 0 1 1 0 1 1 1 ? ? ? ? ? 0 ? ? 0 ? | Infeasible Fathomed |
| 4: | 0 0 0 0 0 0 0 1 0 1 1 0 1 1 0 1 ? ? ? ? 0 ? ? 0 ? | Value = 5715000 Fathomed |
| 4: | 0 0 0 0 0 0 0 1 0 1 1 0 1 1 0 0 1 ? ? ? 0 ? ? 0 ? | Value = 5315000 Fathomed |
| 4: | 0 0 0 0 0 0 0 1 0 1 1 0 1 1 0 0 0 1 ? ? 0 ? ? 0 ? | Infeasible Fathomed |
| 4: | 0 0 0 0 0 0 0 1 0 1 1 0 1 1 0 0 0 0 1 ? 0 ? ? 0 ? | Infeasible Fathomed |
| 4: | 0 0 0 0 0 0 0 1 0 1 1 0 1 1 0 0 0 0 0 1 0 ? ? 0 ? | Value = 12665000 Fathomed |
| 4: | 0 0 0 0 0 0 0 1 0 1 1 0 1 1 0 0 0 0 0 0 0 1 ? 0 ? | Value = 5180000 Fathomed |
| 4: | 0 0 0 0 0 0 0 1 0 1 1 0 1 1 0 0 0 0 0 0 0 0 1 0 ? | Infeasible Fathomed |
| 4: | 0 0 0 0 0 0 0 1 0 1 1 0 1 1 0 0 0 0 0 0 0 0 0 0 1 | Value = 9165000 Fathomed |
| 3: | 0 0 0 0 0 0 0 1 0 1 1 0 1 1 ? ? ? ? ? ? 0 ? ? 0 ? | Value = 5165000 Fathomed |
| 3: | 0 0 0 0 0 0 0 1 0 1 1 0 1 0 1 ? ? ? ? ? 0 ? ? 0 ? | Value = 5620000 Fathomed |
| 3: | 0 0 0 0 0 0 0 1 0 1 1 0 1 0 0 1 ? ? ? ? 0 ? ? 0 ? | Value = 5670000 Fathomed |
| 3: | 0 0 0 0 0 0 0 1 0 1 1 0 1 0 0 0 1 ? ? ? 0 ? ? 0 ? | Value = 5270000 Fathomed |
| 3: | 0 0 0 0 0 0 0 1 0 1 1 0 1 0 0 0 0 1 ? ? 0 ? ? 0 ? | Value = 7120000 Fathomed |
| 3: | 0 0 0 0 0 0 0 1 0 1 1 0 1 0 0 0 0 0 1 ? 0 ? ? 0 ? | Value = 5195000 Fathomed |
| 3: | 0 0 0 0 0 0 0 1 0 1 1 0 1 0 0 0 0 0 0 1 0 ? ? 0 ? | Value = 12620000 Fathomed |
| 3: | 0 0 0 0 0 0 0 1 0 1 1 0 1 0 0 0 0 0 0 0 0 1 ? 0 ? | Value = 5135000 Fathomed |
| 3: | 0 0 0 0 0 0 0 1 0 1 1 0 1 0 0 0 0 0 0 0 0 0 1 0 ? | Infeasible Fathomed |
| 3: | 0 0 0 0 0 0 0 1 0 1 1 0 1 0 0 0 0 0 0 0 0 0 0 0 1 | Value = 9120000 Fathomed |
| 2: | 0 0 0 0 0 0 0 1 0 1 1 0 1 ? ? ? ? ? ? ? 0 ? ? 0 ? | Value = 5120000 Fathomed |
| 2: | 0 0 0 0 0 0 0 1 0 1 1 0 0 1 ? ? ? ? ? ? 0 ? ? 0 ? | Value = 3920000 Fathomed |
| 2: | 0 0 0 0 0 0 0 1 0 1 1 0 0 0 1 ? ? ? ? ? 0 ? ? 0 ? | Value = 4375000 Fathomed |
| 2: | 0 0 0 0 0 0 0 1 0 1 1 0 0 0 0 1 ? ? ? ? 0 ? ? 0 ? | Value = 4425000 Fathomed |
| 2: | 0 0 0 0 0 0 0 1 0 1 1 0 0 0 0 0 1 ? ? ? 0 ? ? 0 ? | Value = 4025000 Fathomed |
| 2: | 0 0 0 0 0 0 0 1 0 1 1 0 0 0 0 0 0 1 ? ? 0 ? ? 0 ? | Value = 5875000 Fathomed |
| 2: | 0 0 0 0 0 0 0 1 0 1 1 0 0 0 0 0 0 0 1 ? 0 ? ? 0 ? | Value = 3950000 Fathomed |
| 2: | 0 0 0 0 0 0 0 1 0 1 1 0 0 0 0 0 0 0 0 1 0 ? ? 0 ? | Value = 11375000 Fathomed |
| 2: | 0 0 0 0 0 0 0 1 0 1 1 0 0 0 0 0 0 0 0 0 0 1 ? 0 ? | Value = 3890000 Fathomed |
| 2: | 0 0 0 0 0 0 0 1 0 1 1 0 0 0 0 0 0 0 0 0 0 0 1 0 ? | Value = 5075000 Fathomed |
| 2: | 0 0 0 0 0 0 0 1 0 1 1 0 0 0 0 0 0 0 0 0 0 0 0 0 1 | Value = 7875000 Fathomed |
| 1: | 0 0 0 0 0 0 0 1 0 1 1 0 ? ? ? ? ? ? ? ? 0 ? ? 0 ? | Value = 3875000 Fathomed |
| 1: | 0 0 0 0 0 0 0 1 0 1 0 0 1 ? ? ? ? ? ? ? 0 ? ? 0 ? | Value = 4620000 Fathomed |
| 1: | 0 0 0 0 0 0 0 1 0 1 0 0 0 1 ? ? ? ? ? ? 0 ? ? 0 ? | Value = 3420000 Fathomed |
| 1: | 0 0 0 0 0 0 0 1 0 1 0 0 0 0 1 ? ? ? ? ? 0 ? ? 0 ? | Value = 3875000 Fathomed |
| 1: | 0 0 0 0 0 0 0 1 0 1 0 0 0 0 0 1 ? ? ? ? 0 ? ? 0 ? | Value = 3925000 Fathomed |
| 1: | 0 0 0 0 0 0 0 1 0 1 0 0 0 0 0 0 1 ? ? ? 0 ? ? 0 ? | Value = 3525000 Fathomed |
| 1: | 0 0 0 0 0 0 0 1 0 1 0 0 0 0 0 0 0 1 ? ? 0 ? ? 0 ? | Value = 5375000 Fathomed |
| 1: | 0 0 0 0 0 0 0 1 0 1 0 0 0 0 0 0 0 0 1 ? 0 ? ? 0 ? | Value = 3450000 Fathomed |
| 1: | 0 0 0 0 0 0 0 1 0 1 0 0 0 0 0 0 0 0 0 1 0 ? ? 0 ? | Value = 10875000 Fathomed |
| 1: | 0 0 0 0 0 0 0 1 0 1 0 0 0 0 0 0 0 0 0 0 0 1 ? 0 ? | Value = 3390000 Fathomed |
| 1: | 0 0 0 0 0 0 0 1 0 1 0 0 0 0 0 0 0 0 0 0 0 0 1 0 ? | Value = 4575000 Fathomed |
| 1: | 0 0 0 0 0 0 0 1 0 1 0 0 0 0 0 0 0 0 0 0 0 0 0 0 1 | Value = 7375000 Fathomed |
| Starting Solution 9 | | |
| 0: | ? ? ? ? ? ? ? ? 1 ? ? 0 ? ? ? ? ? ? ? ? 0 ? ? 0 ? | Value = 1200000 |
| 1: | 0 0 0 0 0 0 0 0 1 1 ? 0 ? ? ? ? ? ? ? ? 0 ? ? 0 ? | Value = 3700000 |
| 2: | 0 0 0 0 0 0 0 0 1 1 1 0 ? ? ? ? ? ? ? ? 0 ? ? 0 ? | Value = 4200000 |
| 3: | 0 0 0 0 0 0 0 0 1 1 1 0 1 ? ? ? ? ? ? ? 0 ? ? 0 ? | Value = 5445000 |
| 4: | 0 0 0 0 0 0 0 0 1 1 1 0 1 1 ? ? ? ? ? ? 0 ? ? 0 ? | Value = 5490000 |
| 5: | 0 0 0 0 0 0 0 0 1 1 1 0 1 1 1 ? ? ? ? ? 0 ? ? 0 ? | Infeasible |
| 5: | 0 0 0 0 0 0 0 0 1 1 1 0 1 1 0 1 ? ? ? ? 0 ? ? 0 ? | Value = 6040000 |
| 6: | 0 0 0 0 0 0 0 0 1 1 1 0 1 1 0 1 1 ? ? ? 0 ? ? 0 ? | Value = 6190000 |
| 7: | 0 0 0 0 0 0 0 0 1 1 1 0 1 1 0 1 1 1 ? ? 0 ? ? 0 ? | Infeasible |
| 7: | 0 0 0 0 0 0 0 0 1 1 1 0 1 1 0 1 1 0 1 ? 0 ? ? 0 ? | Infeasible |
| 7: | 0 0 0 0 0 0 0 0 1 1 1 0 1 1 0 1 1 0 0 1 0 ? ? 0 ? | Value = 13690000 |
| 8: | 0 0 0 0 0 0 0 0 1 1 1 0 1 1 0 1 1 0 0 1 0 1 ? 0 ? | Value = 13705000 |
| 9: | 0 0 0 0 0 0 0 0 1 1 1 0 1 1 0 1 1 0 0 1 0 1 1 0 ? | Infeasible |
| 9: | 0 0 0 0 0 0 0 0 1 1 1 0 1 1 0 1 1 0 0 1 0 1 0 0 1 | Value = 17705000 |
| 8: | 0 0 0 0 0 0 0 0 1 1 1 0 1 1 0 1 1 0 0 1 0 1 1 0 ? | Infeasible Fathomed |
| 8: | 0 0 0 0 0 0 0 0 1 1 1 0 1 1 0 1 1 0 0 1 0 1 0 0 1 | Value = 17705000 (Maximal) Fathomed |
| 7: | 0 0 0 0 0 0 0 0 1 1 1 0 1 1 0 1 1 0 0 1 0 1 ? 0 ? | Value = 13705000 Fathomed |
| 7: | 0 0 0 0 0 0 0 0 1 1 1 0 1 1 0 1 1 0 0 1 0 0 1 0 ? | Infeasible Fathomed |
| 7: | 0 0 0 0 0 0 0 0 1 1 1 0 1 1 0 1 1 0 0 1 0 0 0 0 1 | Value = 17690000 Fathomed |
| 6: | 0 0 0 0 0 0 0 0 1 1 1 0 1 1 0 1 1 1 ? ? 0 ? ? 0 ? | Infeasible Fathomed |
| 6: | 0 0 0 0 0 0 0 0 1 1 1 0 1 1 0 1 1 0 1 ? 0 ? ? 0 ? | Infeasible Fathomed |
| 6: | 0 0 0 0 0 0 0 0 1 1 1 0 1 1 0 1 1 0 0 1 0 ? ? 0 ? | Value = 13690000 Fathomed |
| 6: | 0 0 0 0 0 0 0 0 1 1 1 0 1 1 0 1 1 0 0 0 0 1 ? 0 ? | Value = 6205000 Fathomed |
| 6: | 0 0 0 0 0 0 0 0 1 1 1 0 1 1 0 1 1 0 0 0 0 0 1 0 ? | Value = 7390000 Fathomed |
| 6: | 0 0 0 0 0 0 0 0 1 1 1 0 1 1 0 1 1 0 0 0 0 0 0 0 1 | Value = 10190000 Fathomed |
| 5: | 0 0 0 0 0 0 0 0 1 1 1 0 1 1 0 1 1 ? ? ? 0 ? ? 0 ? | Value = 6190000 Fathomed |
| 5: | 0 0 0 0 0 0 0 0 1 1 1 0 1 1 0 1 0 1 ? ? 0 ? ? 0 ? | Infeasible Fathomed |
| 5: | 0 0 0 0 0 0 0 0 1 1 1 0 1 1 0 1 0 0 1 ? 0 ? ? 0 ? | Infeasible Fathomed |
| 5: | 0 0 0 0 0 0 0 0 1 1 1 0 1 1 0 1 0 0 0 1 0 ? ? 0 ? | Value = 13540000 Fathomed |
| 5: | 0 0 0 0 0 0 0 0 1 1 1 0 1 1 0 1 0 0 0 0 0 1 ? 0 ? | Value = 6055000 Fathomed |
| 5: | 0 0 0 0 0 0 0 0 1 1 1 0 1 1 0 1 0 0 0 0 0 0 1 0 ? | Value = 7240000 Fathomed |
| 5: | 0 0 0 0 0 0 0 0 1 1 1 0 1 1 0 1 0 0 0 0 0 0 0 0 1 | Value = 10040000 Fathomed |
| 4: | 0 0 0 0 0 0 0 0 1 1 1 0 1 1 1 ? ? ? ? ? 0 ? ? 0 ? | Infeasible Fathomed |
| 4: | 0 0 0 0 0 0 0 0 1 1 1 0 1 1 0 1 ? ? ? ? 0 ? ? 0 ? | Value = 6040000 Fathomed |
| 4: | 0 0 0 0 0 0 0 0 1 1 1 0 1 1 0 0 1 ? ? ? 0 ? ? 0 ? | Value = 5640000 Fathomed |
| 4: | 0 0 0 0 0 0 0 0 1 1 1 0 1 1 0 0 0 1 ? ? 0 ? ? 0 ? | Infeasible Fathomed |
| 4: | 0 0 0 0 0 0 0 0 1 1 1 0 1 1 0 0 0 0 1 ? 0 ? ? 0 ? | Infeasible Fathomed |
| 4: | 0 0 0 0 0 0 0 0 1 1 1 0 1 1 0 0 0 0 0 1 0 ? ? 0 ? | Value = 12990000 Fathomed |
| 4: | 0 0 0 0 0 0 0 0 1 1 1 0 1 1 0 0 0 0 0 0 0 1 ? 0 ? | Value = 5505000 Fathomed |
| 4: | 0 0 0 0 0 0 0 0 1 1 1 0 1 1 0 0 0 0 0 0 0 0 1 0 ? | Value = 6690000 Fathomed |
| 4: | 0 0 0 0 0 0 0 0 1 1 1 0 1 1 0 0 0 0 0 0 0 0 0 0 1 | Value = 9490000 Fathomed |
| 3: | 0 0 0 0 0 0 0 0 1 1 1 0 1 1 ? ? ? ? ? ? 0 ? ? 0 ? | Value = 5490000 Fathomed |
| 3: | 0 0 0 0 0 0 0 0 1 1 1 0 1 0 1 ? ? ? ? ? 0 ? ? 0 ? | Value = 5945000 Fathomed |
| 3: | 0 0 0 0 0 0 0 0 1 1 1 0 1 0 0 1 ? ? ? ? 0 ? ? 0 ? | Value = 5995000 Fathomed |
| 3: | 0 0 0 0 0 0 0 0 1 1 1 0 1 0 0 0 1 ? ? ? 0 ? ? 0 ? | Value = 5595000 Fathomed |
| 3: | 0 0 0 0 0 0 0 0 1 1 1 0 1 0 0 0 0 1 ? ? 0 ? ? 0 ? | Value = 7445000 Fathomed |
| 3: | 0 0 0 0 0 0 0 0 1 1 1 0 1 0 0 0 0 0 1 ? 0 ? ? 0 ? | Infeasible Fathomed |
| 3: | 0 0 0 0 0 0 0 0 1 1 1 0 1 0 0 0 0 0 0 1 0 ? ? 0 ? | Value = 12945000 Fathomed |
| 3: | 0 0 0 0 0 0 0 0 1 1 1 0 1 0 0 0 0 0 0 0 0 1 ? 0 ? | Value = 5460000 Fathomed |
| 3: | 0 0 0 0 0 0 0 0 1 1 1 0 1 0 0 0 0 0 0 0 0 0 1 0 ? | Value = 6645000 Fathomed |
| 3: | 0 0 0 0 0 0 0 0 1 1 1 0 1 0 0 0 0 0 0 0 0 0 0 0 1 | Value = 9445000 Fathomed |
| 2: | 0 0 0 0 0 0 0 0 1 1 1 0 1 ? ? ? ? ? ? ? 0 ? ? 0 ? | Value = 5445000 Fathomed |
| 2: | 0 0 0 0 0 0 0 0 1 1 1 0 0 1 ? ? ? ? ? ? 0 ? ? 0 ? | Value = 4245000 Fathomed |
| 2: | 0 0 0 0 0 0 0 0 1 1 1 0 0 0 1 ? ? ? ? ? 0 ? ? 0 ? | Value = 4700000 Fathomed |
| 2: | 0 0 0 0 0 0 0 0 1 1 1 0 0 0 0 1 ? ? ? ? 0 ? ? 0 ? | Value = 4750000 Fathomed |
| 2: | 0 0 0 0 0 0 0 0 1 1 1 0 0 0 0 0 1 ? ? ? 0 ? ? 0 ? | Value = 4350000 Fathomed |
| 2: | 0 0 0 0 0 0 0 0 1 1 1 0 0 0 0 0 0 1 ? ? 0 ? ? 0 ? | Value = 6200000 Fathomed |
| 2: | 0 0 0 0 0 0 0 0 1 1 1 0 0 0 0 0 0 0 1 ? 0 ? ? 0 ? | Infeasible Fathomed |
| 2: | 0 0 0 0 0 0 0 0 1 1 1 0 0 0 0 0 0 0 0 1 0 ? ? 0 ? | Value = 11700000 Fathomed |
| 2: | 0 0 0 0 0 0 0 0 1 1 1 0 0 0 0 0 0 0 0 0 0 1 ? 0 ? | Value = 4215000 Fathomed |
| 2: | 0 0 0 0 0 0 0 0 1 1 1 0 0 0 0 0 0 0 0 0 0 0 1 0 ? | Value = 5400000 Fathomed |
| 2: | 0 0 0 0 0 0 0 0 1 1 1 0 0 0 0 0 0 0 0 0 0 0 0 0 1 | Value = 8200000 Fathomed |
| 1: | 0 0 0 0 0 0 0 0 1 1 1 0 ? ? ? ? ? ? ? ? 0 ? ? 0 ? | Value = 4200000 Fathomed |
| 1: | 0 0 0 0 0 0 0 0 1 1 0 0 1 ? ? ? ? ? ? ? 0 ? ? 0 ? | Value = 4945000 Fathomed |
| 1: | 0 0 0 0 0 0 0 0 1 1 0 0 0 1 ? ? ? ? ? ? 0 ? ? 0 ? | Value = 3745000 Fathomed |
| 1: | 0 0 0 0 0 0 0 0 1 1 0 0 0 0 1 ? ? ? ? ? 0 ? ? 0 ? | Value = 4200000 Fathomed |
| 1: | 0 0 0 0 0 0 0 0 1 1 0 0 0 0 0 1 ? ? ? ? 0 ? ? 0 ? | Value = 4250000 Fathomed |
| 1: | 0 0 0 0 0 0 0 0 1 1 0 0 0 0 0 0 1 ? ? ? 0 ? ? 0 ? | Value = 3850000 Fathomed |
| 1: | 0 0 0 0 0 0 0 0 1 1 0 0 0 0 0 0 0 1 ? ? 0 ? ? 0 ? | Value = 5700000 Fathomed |
| 1: | 0 0 0 0 0 0 0 0 1 1 0 0 0 0 0 0 0 0 1 ? 0 ? ? 0 ? | Value = 3775000 Fathomed |
| 1: | 0 0 0 0 0 0 0 0 1 1 0 0 0 0 0 0 0 0 0 1 0 ? ? 0 ? | Value = 11200000 Fathomed |
| 1: | 0 0 0 0 0 0 0 0 1 1 0 0 0 0 0 0 0 0 0 0 0 1 ? 0 ? | Value = 3715000 Fathomed |
| 1: | 0 0 0 0 0 0 0 0 1 1 0 0 0 0 0 0 0 0 0 0 0 0 1 0 ? | Value = 4900000 Fathomed |
| 1: | 0 0 0 0 0 0 0 0 1 1 0 0 0 0 0 0 0 0 0 0 0 0 0 0 1 | Value = 7700000 Fathomed |
| Starting Solution 10 | | |
| 0: | ? ? ? ? ? ? ? ? 0 1 ? 0 ? ? ? ? ? ? ? ? 0 ? ? 0 ? | Value = 2500000 |
| 1: | 0 0 0 0 0 0 0 0 0 1 1 0 ? ? ? ? ? ? ? ? 0 ? ? 0 ? | Value = 3000000 |
| 2: | 0 0 0 0 0 0 0 0 0 1 1 0 1 ? ? ? ? ? ? ? 0 ? ? 0 ? | Value = 4245000 |
| 3: | 0 0 0 0 0 0 0 0 0 1 1 0 1 1 ? ? ? ? ? ? 0 ? ? 0 ? | Value = 4290000 |
| 4: | 0 0 0 0 0 0 0 0 0 1 1 0 1 1 1 ? ? ? ? ? 0 ? ? 0 ? | Infeasible |
| 4: | 0 0 0 0 0 0 0 0 0 1 1 0 1 1 0 1 ? ? ? ? 0 ? ? 0 ? | Value = 4840000 |
| 5: | 0 0 0 0 0 0 0 0 0 1 1 0 1 1 0 1 1 ? ? ? 0 ? ? 0 ? | Value = 4990000 |
| 6: | 0 0 0 0 0 0 0 0 0 1 1 0 1 1 0 1 1 1 ? ? 0 ? ? 0 ? | Infeasible |
| 6: | 0 0 0 0 0 0 0 0 0 1 1 0 1 1 0 1 1 0 1 ? 0 ? ? 0 ? | Infeasible |
| 6: | 0 0 0 0 0 0 0 0 0 1 1 0 1 1 0 1 1 0 0 1 0 ? ? 0 ? | Value = 12490000 |
| 7: | 0 0 0 0 0 0 0 0 0 1 1 0 1 1 0 1 1 0 0 1 0 1 ? 0 ? | Value = 12505000 |
| 8: | 0 0 0 0 0 0 0 0 0 1 1 0 1 1 0 1 1 0 0 1 0 1 1 0 ? | Infeasible |
| 8: | 0 0 0 0 0 0 0 0 0 1 1 0 1 1 0 1 1 0 0 1 0 1 0 0 1 | Value = 16505000 |
| 7: | 0 0 0 0 0 0 0 0 0 1 1 0 1 1 0 1 1 0 0 1 0 1 1 0 ? | Infeasible Fathomed |
| 7: | 0 0 0 0 0 0 0 0 0 1 1 0 1 1 0 1 1 0 0 1 0 1 0 0 1 | Value = 16505000 Fathomed |
| 6: | 0 0 0 0 0 0 0 0 0 1 1 0 1 1 0 1 1 0 0 1 0 1 ? 0 ? | Value = 12505000 Fathomed |
| 6: | 0 0 0 0 0 0 0 0 0 1 1 0 1 1 0 1 1 0 0 1 0 0 1 0 ? | Infeasible Fathomed |
| 6: | 0 0 0 0 0 0 0 0 0 1 1 0 1 1 0 1 1 0 0 1 0 0 0 0 1 | Value = 16490000 Fathomed |
| 5: | 0 0 0 0 0 0 0 0 0 1 1 0 1 1 0 1 1 1 ? ? 0 ? ? 0 ? | Infeasible Fathomed |
| 5: | 0 0 0 0 0 0 0 0 0 1 1 0 1 1 0 1 1 0 1 ? 0 ? ? 0 ? | Infeasible Fathomed |
| 5: | 0 0 0 0 0 0 0 0 0 1 1 0 1 1 0 1 1 0 0 1 0 ? ? 0 ? | Value = 12490000 Fathomed |
| 5: | 0 0 0 0 0 0 0 0 0 1 1 0 1 1 0 1 1 0 0 0 0 1 ? 0 ? | Value = 5005000 Fathomed |
| 5: | 0 0 0 0 0 0 0 0 0 1 1 0 1 1 0 1 1 0 0 0 0 0 1 0 ? | Value = 6190000 Fathomed |
| 5: | 0 0 0 0 0 0 0 0 0 1 1 0 1 1 0 1 1 0 0 0 0 0 0 0 1 | Value = 8990000 Fathomed |
| 4: | 0 0 0 0 0 0 0 0 0 1 1 0 1 1 0 1 1 ? ? ? 0 ? ? 0 ? | Value = 4990000 Fathomed |
| 4: | 0 0 0 0 0 0 0 0 0 1 1 0 1 1 0 1 0 1 ? ? 0 ? ? 0 ? | Infeasible Fathomed |
| 4: | 0 0 0 0 0 0 0 0 0 1 1 0 1 1 0 1 0 0 1 ? 0 ? ? 0 ? | Infeasible Fathomed |
| 4: | 0 0 0 0 0 0 0 0 0 1 1 0 1 1 0 1 0 0 0 1 0 ? ? 0 ? | Value = 12340000 Fathomed |
| 4: | 0 0 0 0 0 0 0 0 0 1 1 0 1 1 0 1 0 0 0 0 0 1 ? 0 ? | Value = 4855000 Fathomed |
| 4: | 0 0 0 0 0 0 0 0 0 1 1 0 1 1 0 1 0 0 0 0 0 0 1 0 ? | Value = 6040000 Fathomed |
| 4: | 0 0 0 0 0 0 0 0 0 1 1 0 1 1 0 1 0 0 0 0 0 0 0 0 1 | Value = 8840000 Fathomed |
| 3: | 0 0 0 0 0 0 0 0 0 1 1 0 1 1 1 ? ? ? ? ? 0 ? ? 0 ? | Infeasible Fathomed |
| 3: | 0 0 0 0 0 0 0 0 0 1 1 0 1 1 0 1 ? ? ? ? 0 ? ? 0 ? | Value = 4840000 Fathomed |
| 3: | 0 0 0 0 0 0 0 0 0 1 1 0 1 1 0 0 1 ? ? ? 0 ? ? 0 ? | Value = 4440000 Fathomed |
| 3: | 0 0 0 0 0 0 0 0 0 1 1 0 1 1 0 0 0 1 ? ? 0 ? ? 0 ? | Infeasible Fathomed |
| 3: | 0 0 0 0 0 0 0 0 0 1 1 0 1 1 0 0 0 0 1 ? 0 ? ? 0 ? | Infeasible Fathomed |
| 3: | 0 0 0 0 0 0 0 0 0 1 1 0 1 1 0 0 0 0 0 1 0 ? ? 0 ? | Value = 11790000 Fathomed |
| 3: | 0 0 0 0 0 0 0 0 0 1 1 0 1 1 0 0 0 0 0 0 0 1 ? 0 ? | Value = 4305000 Fathomed |
| 3: | 0 0 0 0 0 0 0 0 0 1 1 0 1 1 0 0 0 0 0 0 0 0 1 0 ? | Value = 5490000 Fathomed |
| 3: | 0 0 0 0 0 0 0 0 0 1 1 0 1 1 0 0 0 0 0 0 0 0 0 0 1 | Value = 8290000 Fathomed |
| 2: | 0 0 0 0 0 0 0 0 0 1 1 0 1 1 ? ? ? ? ? ? 0 ? ? 0 ? | Value = 4290000 Fathomed |
| 2: | 0 0 0 0 0 0 0 0 0 1 1 0 1 0 1 ? ? ? ? ? 0 ? ? 0 ? | Value = 4745000 Fathomed |
| 2: | 0 0 0 0 0 0 0 0 0 1 1 0 1 0 0 1 ? ? ? ? 0 ? ? 0 ? | Value = 4795000 Fathomed |
| 2: | 0 0 0 0 0 0 0 0 0 1 1 0 1 0 0 0 1 ? ? ? 0 ? ? 0 ? | Value = 4395000 Fathomed |
| 2: | 0 0 0 0 0 0 0 0 0 1 1 0 1 0 0 0 0 1 ? ? 0 ? ? 0 ? | Value = 6245000 Fathomed |
| 2: | 0 0 0 0 0 0 0 0 0 1 1 0 1 0 0 0 0 0 1 ? 0 ? ? 0 ? | Value = 4320000 Fathomed |
| 2: | 0 0 0 0 0 0 0 0 0 1 1 0 1 0 0 0 0 0 0 1 0 ? ? 0 ? | Value = 11745000 Fathomed |
| 2: | 0 0 0 0 0 0 0 0 0 1 1 0 1 0 0 0 0 0 0 0 0 1 ? 0 ? | Value = 4260000 Fathomed |
| 2: | 0 0 0 0 0 0 0 0 0 1 1 0 1 0 0 0 0 0 0 0 0 0 1 0 ? | Value = 5445000 Fathomed |
| 2: | 0 0 0 0 0 0 0 0 0 1 1 0 1 0 0 0 0 0 0 0 0 0 0 0 1 | Value = 8245000 Fathomed |
| 1: | 0 0 0 0 0 0 0 0 0 1 1 0 1 ? ? ? ? ? ? ? 0 ? ? 0 ? | Value = 4245000 Fathomed |
| 1: | 0 0 0 0 0 0 0 0 0 1 1 0 0 1 ? ? ? ? ? ? 0 ? ? 0 ? | Value = 3045000 Fathomed |
| 1: | 0 0 0 0 0 0 0 0 0 1 1 0 0 0 1 ? ? ? ? ? 0 ? ? 0 ? | Value = 3500000 Fathomed |
| 1: | 0 0 0 0 0 0 0 0 0 1 1 0 0 0 0 1 ? ? ? ? 0 ? ? 0 ? | Value = 3550000 Fathomed |
| 1: | 0 0 0 0 0 0 0 0 0 1 1 0 0 0 0 0 1 ? ? ? 0 ? ? 0 ? | Value = 3150000 Fathomed |
| 1: | 0 0 0 0 0 0 0 0 0 1 1 0 0 0 0 0 0 1 ? ? 0 ? ? 0 ? | Value = 5000000 Fathomed |
| 1: | 0 0 0 0 0 0 0 0 0 1 1 0 0 0 0 0 0 0 1 ? 0 ? ? 0 ? | Value = 3075000 Fathomed |
| 1: | 0 0 0 0 0 0 0 0 0 1 1 0 0 0 0 0 0 0 0 1 0 ? ? 0 ? | Value = 10500000 Fathomed |
| 1: | 0 0 0 0 0 0 0 0 0 1 1 0 0 0 0 0 0 0 0 0 0 1 ? 0 ? | Value = 3015000 Fathomed |
| 1: | 0 0 0 0 0 0 0 0 0 1 1 0 0 0 0 0 0 0 0 0 0 0 1 0 ? | Value = 4200000 Fathomed |
| 1: | 0 0 0 0 0 0 0 0 0 1 1 0 0 0 0 0 0 0 0 0 0 0 0 0 1 | Value = 7000000 Fathomed |
| Starting Solution 11 | | |
| 0: | ? ? ? ? ? ? ? ? 0 ? 1 0 ? ? ? ? ? ? ? ? 0 ? ? 0 ? | Value = 500000 |
| 1: | 0 0 0 0 0 0 0 0 0 0 1 0 1 ? ? ? ? ? ? ? 0 ? ? 0 ? | Value = 1745000 |
| 2: | 0 0 0 0 0 0 0 0 0 0 1 0 1 1 ? ? ? ? ? ? 0 ? ? 0 ? | Value = 1790000 |
| 3: | 0 0 0 0 0 0 0 0 0 0 1 0 1 1 1 ? ? ? ? ? 0 ? ? 0 ? | Infeasible |
| 3: | 0 0 0 0 0 0 0 0 0 0 1 0 1 1 0 1 ? ? ? ? 0 ? ? 0 ? | Value = 2340000 |
| 4: | 0 0 0 0 0 0 0 0 0 0 1 0 1 1 0 1 1 ? ? ? 0 ? ? 0 ? | Value = 2490000 |
| 5: | 0 0 0 0 0 0 0 0 0 0 1 0 1 1 0 1 1 1 ? ? 0 ? ? 0 ? | Infeasible |
| 5: | 0 0 0 0 0 0 0 0 0 0 1 0 1 1 0 1 1 0 1 ? 0 ? ? 0 ? | Infeasible |
| 5: | 0 0 0 0 0 0 0 0 0 0 1 0 1 1 0 1 1 0 0 1 0 ? ? 0 ? | Value = 9990000 |
| 6: | 0 0 0 0 0 0 0 0 0 0 1 0 1 1 0 1 1 0 0 1 0 1 ? 0 ? | Value = 10005000 |
| 7: | 0 0 0 0 0 0 0 0 0 0 1 0 1 1 0 1 1 0 0 1 0 1 1 0 ? | Infeasible |
| 7: | 0 0 0 0 0 0 0 0 0 0 1 0 1 1 0 1 1 0 0 1 0 1 0 0 1 | Value = 14005000 |
| 6: | 0 0 0 0 0 0 0 0 0 0 1 0 1 1 0 1 1 0 0 1 0 1 1 0 ? | Infeasible Fathomed |
| 6: | 0 0 0 0 0 0 0 0 0 0 1 0 1 1 0 1 1 0 0 1 0 1 0 0 1 | Value = 14005000 Fathomed |
| 5: | 0 0 0 0 0 0 0 0 0 0 1 0 1 1 0 1 1 0 0 1 0 1 ? 0 ? | Value = 10005000 Fathomed |
| 5: | 0 0 0 0 0 0 0 0 0 0 1 0 1 1 0 1 1 0 0 1 0 0 1 0 ? | Infeasible Fathomed |
| 5: | 0 0 0 0 0 0 0 0 0 0 1 0 1 1 0 1 1 0 0 1 0 0 0 0 1 | Value = 13990000 Fathomed |
| 4: | 0 0 0 0 0 0 0 0 0 0 1 0 1 1 0 1 1 1 ? ? 0 ? ? 0 ? | Infeasible Fathomed |
| 4: | 0 0 0 0 0 0 0 0 0 0 1 0 1 1 0 1 1 0 1 ? 0 ? ? 0 ? | Infeasible Fathomed |
| 4: | 0 0 0 0 0 0 0 0 0 0 1 0 1 1 0 1 1 0 0 1 0 ? ? 0 ? | Value = 9990000 Fathomed |
| 4: | 0 0 0 0 0 0 0 0 0 0 1 0 1 1 0 1 1 0 0 0 0 1 ? 0 ? | Value = 2505000 Fathomed |
| 4: | 0 0 0 0 0 0 0 0 0 0 1 0 1 1 0 1 1 0 0 0 0 0 1 0 ? | Value = 3690000 Fathomed |
| 4: | 0 0 0 0 0 0 0 0 0 0 1 0 1 1 0 1 1 0 0 0 0 0 0 0 1 | Value = 6490000 Fathomed |
| 3: | 0 0 0 0 0 0 0 0 0 0 1 0 1 1 0 1 1 ? ? ? 0 ? ? 0 ? | Value = 2490000 Fathomed |
| 3: | 0 0 0 0 0 0 0 0 0 0 1 0 1 1 0 1 0 1 ? ? 0 ? ? 0 ? | Infeasible Fathomed |
| 3: | 0 0 0 0 0 0 0 0 0 0 1 0 1 1 0 1 0 0 1 ? 0 ? ? 0 ? | Infeasible Fathomed |
| 3: | 0 0 0 0 0 0 0 0 0 0 1 0 1 1 0 1 0 0 0 1 0 ? ? 0 ? | Value = 9840000 Fathomed |
| 3: | 0 0 0 0 0 0 0 0 0 0 1 0 1 1 0 1 0 0 0 0 0 1 ? 0 ? | Value = 2355000 Fathomed |
| 3: | 0 0 0 0 0 0 0 0 0 0 1 0 1 1 0 1 0 0 0 0 0 0 1 0 ? | Value = 3540000 Fathomed |
| 3: | 0 0 0 0 0 0 0 0 0 0 1 0 1 1 0 1 0 0 0 0 0 0 0 0 1 | Value = 6340000 Fathomed |
| 2: | 0 0 0 0 0 0 0 0 0 0 1 0 1 1 1 ? ? ? ? ? 0 ? ? 0 ? | Infeasible Fathomed |
| 2: | 0 0 0 0 0 0 0 0 0 0 1 0 1 1 0 1 ? ? ? ? 0 ? ? 0 ? | Value = 2340000 Fathomed |
| 2: | 0 0 0 0 0 0 0 0 0 0 1 0 1 1 0 0 1 ? ? ? 0 ? ? 0 ? | Value = 1940000 Fathomed |
| 2: | 0 0 0 0 0 0 0 0 0 0 1 0 1 1 0 0 0 1 ? ? 0 ? ? 0 ? | Infeasible Fathomed |
| 2: | 0 0 0 0 0 0 0 0 0 0 1 0 1 1 0 0 0 0 1 ? 0 ? ? 0 ? | Infeasible Fathomed |
| 2: | 0 0 0 0 0 0 0 0 0 0 1 0 1 1 0 0 0 0 0 1 0 ? ? 0 ? | Value = 9290000 Fathomed |
| 2: | 0 0 0 0 0 0 0 0 0 0 1 0 1 1 0 0 0 0 0 0 0 1 ? 0 ? | Value = 1805000 Fathomed |
| 2: | 0 0 0 0 0 0 0 0 0 0 1 0 1 1 0 0 0 0 0 0 0 0 1 0 ? | Value = 2990000 Fathomed |
| 2: | 0 0 0 0 0 0 0 0 0 0 1 0 1 1 0 0 0 0 0 0 0 0 0 0 1 | Value = 5790000 Fathomed |
| 1: | 0 0 0 0 0 0 0 0 0 0 1 0 1 1 ? ? ? ? ? ? 0 ? ? 0 ? | Value = 1790000 Fathomed |
| 1: | 0 0 0 0 0 0 0 0 0 0 1 0 1 0 1 ? ? ? ? ? 0 ? ? 0 ? | Value = 2245000 Fathomed |
| 1: | 0 0 0 0 0 0 0 0 0 0 1 0 1 0 0 1 ? ? ? ? 0 ? ? 0 ? | Value = 2295000 Fathomed |
| 1: | 0 0 0 0 0 0 0 0 0 0 1 0 1 0 0 0 1 ? ? ? 0 ? ? 0 ? | Value = 1895000 Fathomed |
| 1: | 0 0 0 0 0 0 0 0 0 0 1 0 1 0 0 0 0 1 ? ? 0 ? ? 0 ? | Value = 3745000 Fathomed |
| 1: | 0 0 0 0 0 0 0 0 0 0 1 0 1 0 0 0 0 0 1 ? 0 ? ? 0 ? | Value = 1820000 Fathomed |
| 1: | 0 0 0 0 0 0 0 0 0 0 1 0 1 0 0 0 0 0 0 1 0 ? ? 0 ? | Value = 9245000 Fathomed |
| 1: | 0 0 0 0 0 0 0 0 0 0 1 0 1 0 0 0 0 0 0 0 0 1 ? 0 ? | Value = 1760000 Fathomed |
| 1: | 0 0 0 0 0 0 0 0 0 0 1 0 1 0 0 0 0 0 0 0 0 0 1 0 ? | Value = 2945000 Fathomed |
| 1: | 0 0 0 0 0 0 0 0 0 0 1 0 1 0 0 0 0 0 0 0 0 0 0 0 1 | Value = 5745000 Fathomed |
| Starting Solution 12 | | |
| 0: | ? ? ? ? ? ? ? ? 0 ? ? 1 ? ? ? ? ? ? ? ? 0 ? ? 0 ? | Value = 250000 |
| 1: | 0 0 0 0 0 0 0 0 0 0 0 1 1 ? ? ? ? ? ? ? 0 ? ? 0 ? | Value = 1495000 |
| 2: | 0 0 0 0 0 0 0 0 0 0 0 1 1 1 ? ? ? ? ? ? 0 ? ? 0 ? | Value = 1540000 |
| 3: | 0 0 0 0 0 0 0 0 0 0 0 1 1 1 1 ? ? ? ? ? 0 ? ? 0 ? | Value = 2040000 |
| 4: | 0 0 0 0 0 0 0 0 0 0 0 1 1 1 1 1 ? ? ? ? 0 ? ? 0 ? | Value = 2590000 |
| 5: | 0 0 0 0 0 0 0 0 0 0 0 1 1 1 1 1 1 ? ? ? 0 ? ? 0 ? | Value = 2740000 |
| 6: | 0 0 0 0 0 0 0 0 0 0 0 1 1 1 1 1 1 1 ? ? 0 ? ? 0 ? | Value = 4740000 |
| 7: | 0 0 0 0 0 0 0 0 0 0 0 1 1 1 1 1 1 1 1 ? 0 ? ? 0 ? | Infeasible |
| 7: | 0 0 0 0 0 0 0 0 0 0 0 1 1 1 1 1 1 1 0 1 0 ? ? 0 ? | Value = 12240000 |
| 8: | 0 0 0 0 0 0 0 0 0 0 0 1 1 1 1 1 1 1 0 1 0 1 ? 0 ? | Value = 12255000 |
| 9: | 0 0 0 0 0 0 0 0 0 0 0 1 1 1 1 1 1 1 0 1 0 1 1 0 ? | Infeasible |
| 9: | 0 0 0 0 0 0 0 0 0 0 0 1 1 1 1 1 1 1 0 1 0 1 0 0 1 | Value = 16255000 |
| 8: | 0 0 0 0 0 0 0 0 0 0 0 1 1 1 1 1 1 1 0 1 0 1 1 0 ? | Infeasible Fathomed |
| 8: | 0 0 0 0 0 0 0 0 0 0 0 1 1 1 1 1 1 1 0 1 0 1 0 0 1 | Value = 16255000 Fathomed |
| 7: | 0 0 0 0 0 0 0 0 0 0 0 1 1 1 1 1 1 1 0 1 0 1 ? 0 ? | Value = 12255000 Fathomed |
| 7: | 0 0 0 0 0 0 0 0 0 0 0 1 1 1 1 1 1 1 0 1 0 0 1 0 ? | Infeasible Fathomed |
| 7: | 0 0 0 0 0 0 0 0 0 0 0 1 1 1 1 1 1 1 0 1 0 0 0 0 1 | Value = 16240000 Fathomed |
| 6: | 0 0 0 0 0 0 0 0 0 0 0 1 1 1 1 1 1 1 1 ? 0 ? ? 0 ? | Infeasible Fathomed |
| 6: | 0 0 0 0 0 0 0 0 0 0 0 1 1 1 1 1 1 1 0 1 0 ? ? 0 ? | Value = 12240000 Fathomed |
| 6: | 0 0 0 0 0 0 0 0 0 0 0 1 1 1 1 1 1 1 0 0 0 1 ? 0 ? | Value = 4755000 Fathomed |
| 6: | 0 0 0 0 0 0 0 0 0 0 0 1 1 1 1 1 1 1 0 0 0 0 1 0 ? | Infeasible Fathomed |
| 6: | 0 0 0 0 0 0 0 0 0 0 0 1 1 1 1 1 1 1 0 0 0 0 0 0 1 | Value = 8740000 Fathomed |
| 5: | 0 0 0 0 0 0 0 0 0 0 0 1 1 1 1 1 1 1 ? ? 0 ? ? 0 ? | Value = 4740000 Fathomed |
| 5: | 0 0 0 0 0 0 0 0 0 0 0 1 1 1 1 1 1 0 1 ? 0 ? ? 0 ? | Infeasible Fathomed |
| 5: | 0 0 0 0 0 0 0 0 0 0 0 1 1 1 1 1 1 0 0 1 0 ? ? 0 ? | Value = 10240000 Fathomed |
| 5: | 0 0 0 0 0 0 0 0 0 0 0 1 1 1 1 1 1 0 0 0 0 1 ? 0 ? | Value = 2755000 Fathomed |
| 5: | 0 0 0 0 0 0 0 0 0 0 0 1 1 1 1 1 1 0 0 0 0 0 1 0 ? | Infeasible Fathomed |
| 5: | 0 0 0 0 0 0 0 0 0 0 0 1 1 1 1 1 1 0 0 0 0 0 0 0 1 | Value = 6740000 Fathomed |
| 4: | 0 0 0 0 0 0 0 0 0 0 0 1 1 1 1 1 1 ? ? ? 0 ? ? 0 ? | Value = 2740000 Fathomed |
| 4: | 0 0 0 0 0 0 0 0 0 0 0 1 1 1 1 1 0 1 ? ? 0 ? ? 0 ? | Value = 4590000 Fathomed |
| 4: | 0 0 0 0 0 0 0 0 0 0 0 1 1 1 1 1 0 0 1 ? 0 ? ? 0 ? | Infeasible Fathomed |
| 4: | 0 0 0 0 0 0 0 0 0 0 0 1 1 1 1 1 0 0 0 1 0 ? ? 0 ? | Value = 10090000 Fathomed |
| 4: | 0 0 0 0 0 0 0 0 0 0 0 1 1 1 1 1 0 0 0 0 0 1 ? 0 ? | Value = 2605000 Fathomed |
| 4: | 0 0 0 0 0 0 0 0 0 0 0 1 1 1 1 1 0 0 0 0 0 0 1 0 ? | Infeasible Fathomed |
| 4: | 0 0 0 0 0 0 0 0 0 0 0 1 1 1 1 1 0 0 0 0 0 0 0 0 1 | Value = 6590000 Fathomed |
| 3: | 0 0 0 0 0 0 0 0 0 0 0 1 1 1 1 1 ? ? ? ? 0 ? ? 0 ? | Value = 2590000 Fathomed |
| 3: | 0 0 0 0 0 0 0 0 0 0 0 1 1 1 1 0 1 ? ? ? 0 ? ? 0 ? | Value = 2190000 Fathomed |
| 3: | 0 0 0 0 0 0 0 0 0 0 0 1 1 1 1 0 0 1 ? ? 0 ? ? 0 ? | Value = 4040000 Fathomed |
| 3: | 0 0 0 0 0 0 0 0 0 0 0 1 1 1 1 0 0 0 1 ? 0 ? ? 0 ? | Infeasible Fathomed |
| 3: | 0 0 0 0 0 0 0 0 0 0 0 1 1 1 1 0 0 0 0 1 0 ? ? 0 ? | Value = 9540000 Fathomed |
| 3: | 0 0 0 0 0 0 0 0 0 0 0 1 1 1 1 0 0 0 0 0 0 1 ? 0 ? | Value = 2055000 Fathomed |
| 3: | 0 0 0 0 0 0 0 0 0 0 0 1 1 1 1 0 0 0 0 0 0 0 1 0 ? | Infeasible Fathomed |
| 3: | 0 0 0 0 0 0 0 0 0 0 0 1 1 1 1 0 0 0 0 0 0 0 0 0 1 | Value = 6040000 Fathomed |
| 2: | 0 0 0 0 0 0 0 0 0 0 0 1 1 1 1 ? ? ? ? ? 0 ? ? 0 ? | Value = 2040000 Fathomed |
| 2: | 0 0 0 0 0 0 0 0 0 0 0 1 1 1 0 1 ? ? ? ? 0 ? ? 0 ? | Value = 2090000 Fathomed |
| 2: | 0 0 0 0 0 0 0 0 0 0 0 1 1 1 0 0 1 ? ? ? 0 ? ? 0 ? | Value = 1690000 Fathomed |
| 2: | 0 0 0 0 0 0 0 0 0 0 0 1 1 1 0 0 0 1 ? ? 0 ? ? 0 ? | Value = 3540000 Fathomed |
| 2: | 0 0 0 0 0 0 0 0 0 0 0 1 1 1 0 0 0 0 1 ? 0 ? ? 0 ? | Value = 1615000 Fathomed |
| 2: | 0 0 0 0 0 0 0 0 0 0 0 1 1 1 0 0 0 0 0 1 0 ? ? 0 ? | Value = 9040000 Fathomed |
| 2: | 0 0 0 0 0 0 0 0 0 0 0 1 1 1 0 0 0 0 0 0 0 1 ? 0 ? | Value = 1555000 Fathomed |
| 2: | 0 0 0 0 0 0 0 0 0 0 0 1 1 1 0 0 0 0 0 0 0 0 1 0 ? | Value = 2740000 Fathomed |
| 2: | 0 0 0 0 0 0 0 0 0 0 0 1 1 1 0 0 0 0 0 0 0 0 0 0 1 | Value = 5540000 Fathomed |
| 1: | 0 0 0 0 0 0 0 0 0 0 0 1 1 1 ? ? ? ? ? ? 0 ? ? 0 ? | Value = 1540000 Fathomed |
| 1: | 0 0 0 0 0 0 0 0 0 0 0 1 1 0 1 ? ? ? ? ? 0 ? ? 0 ? | Value = 1995000 Fathomed |
| 1: | 0 0 0 0 0 0 0 0 0 0 0 1 1 0 0 1 ? ? ? ? 0 ? ? 0 ? | Value = 2045000 Fathomed |
| 1: | 0 0 0 0 0 0 0 0 0 0 0 1 1 0 0 0 1 ? ? ? 0 ? ? 0 ? | Value = 1645000 Fathomed |
| 1: | 0 0 0 0 0 0 0 0 0 0 0 1 1 0 0 0 0 1 ? ? 0 ? ? 0 ? | Value = 3495000 Fathomed |
| 1: | 0 0 0 0 0 0 0 0 0 0 0 1 1 0 0 0 0 0 1 ? 0 ? ? 0 ? | Value = 1570000 Fathomed |
| 1: | 0 0 0 0 0 0 0 0 0 0 0 1 1 0 0 0 0 0 0 1 0 ? ? 0 ? | Value = 8995000 Fathomed |
| 1: | 0 0 0 0 0 0 0 0 0 0 0 1 1 0 0 0 0 0 0 0 0 1 ? 0 ? | Value = 1510000 Fathomed |
| 1: | 0 0 0 0 0 0 0 0 0 0 0 1 1 0 0 0 0 0 0 0 0 0 1 0 ? | Value = 2695000 Fathomed |
| 1: | 0 0 0 0 0 0 0 0 0 0 0 1 1 0 0 0 0 0 0 0 0 0 0 0 1 | Value = 5495000 Fathomed |
| Starting Solution 13 | | |
| 0: | ? ? ? ? ? ? ? ? 0 ? ? 0 1 ? ? ? ? ? ? ? 0 ? ? 0 ? | Value = 1245000 |
| 1: | 0 0 0 0 0 0 0 0 0 0 0 0 1 1 ? ? ? ? ? ? 0 ? ? 0 ? | Value = 1290000 |
| 2: | 0 0 0 0 0 0 0 0 0 0 0 0 1 1 1 ? ? ? ? ? 0 ? ? 0 ? | Value = 1790000 |
| 3: | 0 0 0 0 0 0 0 0 0 0 0 0 1 1 1 1 ? ? ? ? 0 ? ? 0 ? | Value = 2340000 |
| 4: | 0 0 0 0 0 0 0 0 0 0 0 0 1 1 1 1 1 ? ? ? 0 ? ? 0 ? | Value = 2490000 |
| 5: | 0 0 0 0 0 0 0 0 0 0 0 0 1 1 1 1 1 1 ? ? 0 ? ? 0 ? | Value = 4490000 |
| 6: | 0 0 0 0 0 0 0 0 0 0 0 0 1 1 1 1 1 1 1 ? 0 ? ? 0 ? | Infeasible |
| 6: | 0 0 0 0 0 0 0 0 0 0 0 0 1 1 1 1 1 1 0 1 0 ? ? 0 ? | Value = 11990000 |
| 7: | 0 0 0 0 0 0 0 0 0 0 0 0 1 1 1 1 1 1 0 1 0 1 ? 0 ? | Value = 12005000 |
| 8: | 0 0 0 0 0 0 0 0 0 0 0 0 1 1 1 1 1 1 0 1 0 1 1 0 ? | Infeasible |
| 8: | 0 0 0 0 0 0 0 0 0 0 0 0 1 1 1 1 1 1 0 1 0 1 0 0 1 | Value = 16005000 |
| 7: | 0 0 0 0 0 0 0 0 0 0 0 0 1 1 1 1 1 1 0 1 0 1 1 0 ? | Infeasible Fathomed |
| 7: | 0 0 0 0 0 0 0 0 0 0 0 0 1 1 1 1 1 1 0 1 0 1 0 0 1 | Value = 16005000 Fathomed |
| 6: | 0 0 0 0 0 0 0 0 0 0 0 0 1 1 1 1 1 1 0 1 0 1 ? 0 ? | Value = 12005000 Fathomed |
| 6: | 0 0 0 0 0 0 0 0 0 0 0 0 1 1 1 1 1 1 0 1 0 0 1 0 ? | Infeasible Fathomed |
| 6: | 0 0 0 0 0 0 0 0 0 0 0 0 1 1 1 1 1 1 0 1 0 0 0 0 1 | Value = 15990000 Fathomed |
| 5: | 0 0 0 0 0 0 0 0 0 0 0 0 1 1 1 1 1 1 1 ? 0 ? ? 0 ? | Infeasible Fathomed |
| 5: | 0 0 0 0 0 0 0 0 0 0 0 0 1 1 1 1 1 1 0 1 0 ? ? 0 ? | Value = 11990000 Fathomed |
| 5: | 0 0 0 0 0 0 0 0 0 0 0 0 1 1 1 1 1 1 0 0 0 1 ? 0 ? | Value = 4505000 Fathomed |
| 5: | 0 0 0 0 0 0 0 0 0 0 0 0 1 1 1 1 1 1 0 0 0 0 1 0 ? | Infeasible Fathomed |
| 5: | 0 0 0 0 0 0 0 0 0 0 0 0 1 1 1 1 1 1 0 0 0 0 0 0 1 | Value = 8490000 Fathomed |
| 4: | 0 0 0 0 0 0 0 0 0 0 0 0 1 1 1 1 1 1 ? ? 0 ? ? 0 ? | Value = 4490000 Fathomed |
| 4: | 0 0 0 0 0 0 0 0 0 0 0 0 1 1 1 1 1 0 1 ? 0 ? ? 0 ? | Value = 2565000 Fathomed |
| 4: | 0 0 0 0 0 0 0 0 0 0 0 0 1 1 1 1 1 0 0 1 0 ? ? 0 ? | Value = 9990000 Fathomed |
| 4: | 0 0 0 0 0 0 0 0 0 0 0 0 1 1 1 1 1 0 0 0 0 1 ? 0 ? | Value = 2505000 Fathomed |
| 4: | 0 0 0 0 0 0 0 0 0 0 0 0 1 1 1 1 1 0 0 0 0 0 1 0 ? | Infeasible Fathomed |
| 4: | 0 0 0 0 0 0 0 0 0 0 0 0 1 1 1 1 1 0 0 0 0 0 0 0 1 | Value = 6490000 Fathomed |
| 3: | 0 0 0 0 0 0 0 0 0 0 0 0 1 1 1 1 1 ? ? ? 0 ? ? 0 ? | Value = 2490000 Fathomed |
| 3: | 0 0 0 0 0 0 0 0 0 0 0 0 1 1 1 1 0 1 ? ? 0 ? ? 0 ? | Value = 4340000 Fathomed |
| 3: | 0 0 0 0 0 0 0 0 0 0 0 0 1 1 1 1 0 0 1 ? 0 ? ? 0 ? | Value = 2415000 Fathomed |
| 3: | 0 0 0 0 0 0 0 0 0 0 0 0 1 1 1 1 0 0 0 1 0 ? ? 0 ? | Value = 9840000 Fathomed |
| 3: | 0 0 0 0 0 0 0 0 0 0 0 0 1 1 1 1 0 0 0 0 0 1 ? 0 ? | Value = 2355000 Fathomed |
| 3: | 0 0 0 0 0 0 0 0 0 0 0 0 1 1 1 1 0 0 0 0 0 0 1 0 ? | Infeasible Fathomed |
| 3: | 0 0 0 0 0 0 0 0 0 0 0 0 1 1 1 1 0 0 0 0 0 0 0 0 1 | Value = 6340000 Fathomed |
| 2: | 0 0 0 0 0 0 0 0 0 0 0 0 1 1 1 1 ? ? ? ? 0 ? ? 0 ? | Value = 2340000 Fathomed |
| 2: | 0 0 0 0 0 0 0 0 0 0 0 0 1 1 1 0 1 ? ? ? 0 ? ? 0 ? | Value = 1940000 Fathomed |
| 2: | 0 0 0 0 0 0 0 0 0 0 0 0 1 1 1 0 0 1 ? ? 0 ? ? 0 ? | Value = 3790000 Fathomed |
| 2: | 0 0 0 0 0 0 0 0 0 0 0 0 1 1 1 0 0 0 1 ? 0 ? ? 0 ? | Value = 1865000 Fathomed |
| 2: | 0 0 0 0 0 0 0 0 0 0 0 0 1 1 1 0 0 0 0 1 0 ? ? 0 ? | Value = 9290000 Fathomed |
| 2: | 0 0 0 0 0 0 0 0 0 0 0 0 1 1 1 0 0 0 0 0 0 1 ? 0 ? | Value = 1805000 Fathomed |
| 2: | 0 0 0 0 0 0 0 0 0 0 0 0 1 1 1 0 0 0 0 0 0 0 1 0 ? | Infeasible Fathomed |
| 2: | 0 0 0 0 0 0 0 0 0 0 0 0 1 1 1 0 0 0 0 0 0 0 0 0 1 | Value = 5790000 Fathomed |
| 1: | 0 0 0 0 0 0 0 0 0 0 0 0 1 1 1 ? ? ? ? ? 0 ? ? 0 ? | Value = 1790000 Fathomed |
| 1: | 0 0 0 0 0 0 0 0 0 0 0 0 1 1 0 1 ? ? ? ? 0 ? ? 0 ? | Value = 1840000 Fathomed |
| 1: | 0 0 0 0 0 0 0 0 0 0 0 0 1 1 0 0 1 ? ? ? 0 ? ? 0 ? | Value = 1440000 Fathomed |
| 1: | 0 0 0 0 0 0 0 0 0 0 0 0 1 1 0 0 0 1 ? ? 0 ? ? 0 ? | Value = 3290000 Fathomed |
| 1: | 0 0 0 0 0 0 0 0 0 0 0 0 1 1 0 0 0 0 1 ? 0 ? ? 0 ? | Value = 1365000 Fathomed |
| 1: | 0 0 0 0 0 0 0 0 0 0 0 0 1 1 0 0 0 0 0 1 0 ? ? 0 ? | Value = 8790000 Fathomed |
| 1: | 0 0 0 0 0 0 0 0 0 0 0 0 1 1 0 0 0 0 0 0 0 1 ? 0 ? | Value = 1305000 Fathomed |
| 1: | 0 0 0 0 0 0 0 0 0 0 0 0 1 1 0 0 0 0 0 0 0 0 1 0 ? | Value = 2490000 Fathomed |
| 1: | 0 0 0 0 0 0 0 0 0 0 0 0 1 1 0 0 0 0 0 0 0 0 0 0 1 | Value = 5290000 Fathomed |
| Starting Solution 14 | | |
| 0: | ? ? ? ? ? ? ? ? 0 ? ? 0 ? 1 ? ? ? ? ? ? 0 ? ? 0 ? | Value = 45000 |
| 1: | 0 0 0 0 0 0 0 0 0 0 0 0 0 1 1 ? ? ? ? ? 0 ? ? 0 ? | Value = 545000 |
| 2: | 0 0 0 0 0 0 0 0 0 0 0 0 0 1 1 1 ? ? ? ? 0 ? ? 0 ? | Value = 1095000 |
| 3: | 0 0 0 0 0 0 0 0 0 0 0 0 0 1 1 1 1 ? ? ? 0 ? ? 0 ? | Value = 1245000 |
| 4: | 0 0 0 0 0 0 0 0 0 0 0 0 0 1 1 1 1 1 ? ? 0 ? ? 0 ? | Value = 3245000 |
| 5: | 0 0 0 0 0 0 0 0 0 0 0 0 0 1 1 1 1 1 1 ? 0 ? ? 0 ? | Infeasible |
| 5: | 0 0 0 0 0 0 0 0 0 0 0 0 0 1 1 1 1 1 0 1 0 ? ? 0 ? | Value = 10745000 |
| 6: | 0 0 0 0 0 0 0 0 0 0 0 0 0 1 1 1 1 1 0 1 0 1 ? 0 ? | Value = 10760000 |
| 7: | 0 0 0 0 0 0 0 0 0 0 0 0 0 1 1 1 1 1 0 1 0 1 1 0 ? | Value = 11960000 |
| 8: | 0 0 0 0 0 0 0 0 0 0 0 0 0 1 1 1 1 1 0 1 0 1 1 0 1 | Infeasible |
| 7: | 0 0 0 0 0 0 0 0 0 0 0 0 0 1 1 1 1 1 0 1 0 1 1 0 1 | Infeasible Fathomed |
| 6: | 0 0 0 0 0 0 0 0 0 0 0 0 0 1 1 1 1 1 0 1 0 1 1 0 ? | Value = 11960000 Fathomed |
| 6: | 0 0 0 0 0 0 0 0 0 0 0 0 0 1 1 1 1 1 0 1 0 1 0 0 1 | Value = 14760000 Fathomed |
| 5: | 0 0 0 0 0 0 0 0 0 0 0 0 0 1 1 1 1 1 0 1 0 1 ? 0 ? | Value = 10760000 Fathomed |
| 5: | 0 0 0 0 0 0 0 0 0 0 0 0 0 1 1 1 1 1 0 1 0 0 1 0 ? | Value = 11945000 Fathomed |
| 5: | 0 0 0 0 0 0 0 0 0 0 0 0 0 1 1 1 1 1 0 1 0 0 0 0 1 | Value = 14745000 Fathomed |
| 4: | 0 0 0 0 0 0 0 0 0 0 0 0 0 1 1 1 1 1 1 ? 0 ? ? 0 ? | Infeasible Fathomed |
| 4: | 0 0 0 0 0 0 0 0 0 0 0 0 0 1 1 1 1 1 0 1 0 ? ? 0 ? | Value = 10745000 Fathomed |
| 4: | 0 0 0 0 0 0 0 0 0 0 0 0 0 1 1 1 1 1 0 0 0 1 ? 0 ? | Value = 3260000 Fathomed |
| 4: | 0 0 0 0 0 0 0 0 0 0 0 0 0 1 1 1 1 1 0 0 0 0 1 0 ? | Value = 4445000 Fathomed |
| 4: | 0 0 0 0 0 0 0 0 0 0 0 0 0 1 1 1 1 1 0 0 0 0 0 0 1 | Value = 7245000 Fathomed |
| 3: | 0 0 0 0 0 0 0 0 0 0 0 0 0 1 1 1 1 1 ? ? 0 ? ? 0 ? | Value = 3245000 Fathomed |
| 3: | 0 0 0 0 0 0 0 0 0 0 0 0 0 1 1 1 1 0 1 ? 0 ? ? 0 ? | Value = 1320000 Fathomed |
| 3: | 0 0 0 0 0 0 0 0 0 0 0 0 0 1 1 1 1 0 0 1 0 ? ? 0 ? | Value = 8745000 Fathomed |
| 3: | 0 0 0 0 0 0 0 0 0 0 0 0 0 1 1 1 1 0 0 0 0 1 ? 0 ? | Value = 1260000 Fathomed |
| 3: | 0 0 0 0 0 0 0 0 0 0 0 0 0 1 1 1 1 0 0 0 0 0 1 0 ? | Value = 2445000 Fathomed |
| 3: | 0 0 0 0 0 0 0 0 0 0 0 0 0 1 1 1 1 0 0 0 0 0 0 0 1 | Value = 5245000 Fathomed |
| 2: | 0 0 0 0 0 0 0 0 0 0 0 0 0 1 1 1 1 ? ? ? 0 ? ? 0 ? | Value = 1245000 Fathomed |
| 2: | 0 0 0 0 0 0 0 0 0 0 0 0 0 1 1 1 0 1 ? ? 0 ? ? 0 ? | Value = 3095000 Fathomed |
| 2: | 0 0 0 0 0 0 0 0 0 0 0 0 0 1 1 1 0 0 1 ? 0 ? ? 0 ? | Value = 1170000 Fathomed |
| 2: | 0 0 0 0 0 0 0 0 0 0 0 0 0 1 1 1 0 0 0 1 0 ? ? 0 ? | Value = 8595000 Fathomed |
| 2: | 0 0 0 0 0 0 0 0 0 0 0 0 0 1 1 1 0 0 0 0 0 1 ? 0 ? | Value = 1110000 Fathomed |
| 2: | 0 0 0 0 0 0 0 0 0 0 0 0 0 1 1 1 0 0 0 0 0 0 1 0 ? | Value = 2295000 Fathomed |
| 2: | 0 0 0 0 0 0 0 0 0 0 0 0 0 1 1 1 0 0 0 0 0 0 0 0 1 | Value = 5095000 Fathomed |
| 1: | 0 0 0 0 0 0 0 0 0 0 0 0 0 1 1 1 ? ? ? ? 0 ? ? 0 ? | Value = 1095000 Fathomed |
| 1: | 0 0 0 0 0 0 0 0 0 0 0 0 0 1 1 0 1 ? ? ? 0 ? ? 0 ? | Value = 695000 Fathomed |
| 1: | 0 0 0 0 0 0 0 0 0 0 0 0 0 1 1 0 0 1 ? ? 0 ? ? 0 ? | Value = 2545000 Fathomed |
| 1: | 0 0 0 0 0 0 0 0 0 0 0 0 0 1 1 0 0 0 1 ? 0 ? ? 0 ? | Value = 620000 Fathomed |
| 1: | 0 0 0 0 0 0 0 0 0 0 0 0 0 1 1 0 0 0 0 1 0 ? ? 0 ? | Value = 8045000 Fathomed |
| 1: | 0 0 0 0 0 0 0 0 0 0 0 0 0 1 1 0 0 0 0 0 0 1 ? 0 ? | Value = 560000 Fathomed |
| 1: | 0 0 0 0 0 0 0 0 0 0 0 0 0 1 1 0 0 0 0 0 0 0 1 0 ? | Value = 1745000 Fathomed |
| 1: | 0 0 0 0 0 0 0 0 0 0 0 0 0 1 1 0 0 0 0 0 0 0 0 0 1 | Value = 4545000 Fathomed |
| Starting Solution 15 | | |
| 0: | ? ? ? ? ? ? ? ? 0 ? ? 0 ? ? 1 ? ? ? ? ? 0 ? ? 0 ? | Value = 500000 |
| 1: | 0 0 0 0 0 0 0 0 0 0 0 0 0 0 1 1 ? ? ? ? 0 ? ? 0 ? | Value = 1050000 |
| 2: | 0 0 0 0 0 0 0 0 0 0 0 0 0 0 1 1 1 ? ? ? 0 ? ? 0 ? | Value = 1200000 |
| 3: | 0 0 0 0 0 0 0 0 0 0 0 0 0 0 1 1 1 1 ? ? 0 ? ? 0 ? | Value = 3200000 |
| 4: | 0 0 0 0 0 0 0 0 0 0 0 0 0 0 1 1 1 1 1 ? 0 ? ? 0 ? | Value = 3275000 |
| 5: | 0 0 0 0 0 0 0 0 0 0 0 0 0 0 1 1 1 1 1 1 0 ? ? 0 ? | Value = 10775000 |
| 6: | 0 0 0 0 0 0 0 0 0 0 0 0 0 0 1 1 1 1 1 1 0 1 ? 0 ? | Value = 10790000 |
| 7: | 0 0 0 0 0 0 0 0 0 0 0 0 0 0 1 1 1 1 1 1 0 1 1 0 ? | Value = 11990000 |
| 8: | 0 0 0 0 0 0 0 0 0 0 0 0 0 0 1 1 1 1 1 1 0 1 1 0 1 | Value = 15990000 |
| 7: | 0 0 0 0 0 0 0 0 0 0 0 0 0 0 1 1 1 1 1 1 0 1 1 0 1 | Value = 15990000 Fathomed |
| 6: | 0 0 0 0 0 0 0 0 0 0 0 0 0 0 1 1 1 1 1 1 0 1 1 0 ? | Value = 11990000 Fathomed |
| 6: | 0 0 0 0 0 0 0 0 0 0 0 0 0 0 1 1 1 1 1 1 0 1 0 0 1 | Value = 14790000 Fathomed |
| 5: | 0 0 0 0 0 0 0 0 0 0 0 0 0 0 1 1 1 1 1 1 0 1 ? 0 ? | Value = 10790000 Fathomed |
| 5: | 0 0 0 0 0 0 0 0 0 0 0 0 0 0 1 1 1 1 1 1 0 0 1 0 ? | Value = 11975000 Fathomed |
| 5: | 0 0 0 0 0 0 0 0 0 0 0 0 0 0 1 1 1 1 1 1 0 0 0 0 1 | Value = 14775000 Fathomed |
| 4: | 0 0 0 0 0 0 0 0 0 0 0 0 0 0 1 1 1 1 1 1 0 ? ? 0 ? | Value = 10775000 Fathomed |
| 4: | 0 0 0 0 0 0 0 0 0 0 0 0 0 0 1 1 1 1 1 0 0 1 ? 0 ? | Value = 3290000 Fathomed |
| 4: | 0 0 0 0 0 0 0 0 0 0 0 0 0 0 1 1 1 1 1 0 0 0 1 0 ? | Value = 4475000 Fathomed |
| 4: | 0 0 0 0 0 0 0 0 0 0 0 0 0 0 1 1 1 1 1 0 0 0 0 0 1 | Value = 7275000 Fathomed |
| 3: | 0 0 0 0 0 0 0 0 0 0 0 0 0 0 1 1 1 1 1 ? 0 ? ? 0 ? | Value = 3275000 Fathomed |
| 3: | 0 0 0 0 0 0 0 0 0 0 0 0 0 0 1 1 1 1 0 1 0 ? ? 0 ? | Value = 10700000 Fathomed |
| 3: | 0 0 0 0 0 0 0 0 0 0 0 0 0 0 1 1 1 1 0 0 0 1 ? 0 ? | Value = 3215000 Fathomed |
| 3: | 0 0 0 0 0 0 0 0 0 0 0 0 0 0 1 1 1 1 0 0 0 0 1 0 ? | Value = 4400000 Fathomed |
| 3: | 0 0 0 0 0 0 0 0 0 0 0 0 0 0 1 1 1 1 0 0 0 0 0 0 1 | Value = 7200000 Fathomed |
| 2: | 0 0 0 0 0 0 0 0 0 0 0 0 0 0 1 1 1 1 ? ? 0 ? ? 0 ? | Value = 3200000 Fathomed |
| 2: | 0 0 0 0 0 0 0 0 0 0 0 0 0 0 1 1 1 0 1 ? 0 ? ? 0 ? | Value = 1275000 Fathomed |
| 2: | 0 0 0 0 0 0 0 0 0 0 0 0 0 0 1 1 1 0 0 10 ? ? 0 ? | Value = 8700000 Fathomed |
| 2: | 0 0 0 0 0 0 0 0 0 0 0 0 0 0 1 1 1 0 0 0 0 1 ? 0 ? | Value = 1215000 Fathomed |
| 2: | 0 0 0 0 0 0 0 0 0 0 0 0 0 0 1 1 1 0 0 0 0 0 1 0 ? | Value = 2400000 Fathomed |
| 2: | 0 0 0 0 0 0 0 0 0 0 0 0 0 0 1 1 1 0 0 0 0 0 0 0 1 | Value = 5200000 Fathomed |
| 1: | 0 0 0 0 0 0 0 0 0 0 0 0 0 0 1 1 1 ? ? ? 0 ? ? 0 ? | Value = 1200000 Fathomed |
| 1: | 0 0 0 0 0 0 0 0 0 0 0 0 0 0 1 1 0 1 ? ? 0 ? ? 0 ? | Value = 3050000 Fathomed |
| 1: | 0 0 0 0 0 0 0 0 0 0 0 0 0 0 1 1 0 0 1 ? 0 ? ? 0 ? | Value = 1125000 Fathomed |
| 1: | 0 0 0 0 0 0 0 0 0 0 0 0 0 0 1 1 0 0 0 1 0 ? ? 0 ? | Value = 8550000 Fathomed |
| 1: | 0 0 0 0 0 0 0 0 0 0 0 0 0 0 1 1 0 0 0 0 0 1 ? 0 ? | Value = 1065000 Fathomed |
| 1: | 0 0 0 0 0 0 0 0 0 0 0 0 0 0 1 1 0 0 0 0 0 0 1 0 ? | Value = 2250000 Fathomed |
| 1: | 0 0 0 0 0 0 0 0 0 0 0 0 0 0 1 1 0 0 0 0 0 0 0 0 1 | Value = 5050000 Fathomed |
| Starting Solution 16 | | |
| 0: | ? ? ? ? ? ? ? ? 0 ? ? 0 ? ? ? 1 ? ? ? ? 0 ? ? 0 ? | Value = 550000 |
| 1: | 0 0 0 0 0 0 0 0 0 0 0 0 0 0 0 1 1 ? ? ? 0 ? ? 0 ? | Value = 700000 |
| 2: | 0 0 0 0 0 0 0 0 0 0 0 0 0 0 0 1 1 1 ? ? 0 ? ? 0 ? | Value = 2700000 |
| 3: | 0 0 0 0 0 0 0 0 0 0 0 0 0 0 0 1 1 1 1 ? 0 ? ? 0 ? | Value = 2775000 |
| 4: | 0 0 0 0 0 0 0 0 0 0 0 0 0 0 0 1 1 1 1 1 0 ? ? 0 ? | Value = 10275000 |
| 5: | 0 0 0 0 0 0 0 0 0 0 0 0 0 0 0 1 1 1 1 1 0 1 ? 0 ? | Value = 10290000 |
| 6: | 0 0 0 0 0 0 0 0 0 0 0 0 0 0 0 1 1 1 1 1 0 1 1 0 ? | Value = 11490000 |
| 7: | 0 0 0 0 0 0 0 0 0 0 0 0 0 0 0 1 1 1 1 1 0 1 1 0 1 | Value = 15490000 |
| 6: | 0 0 0 0 0 0 0 0 0 0 0 0 0 0 0 1 1 1 1 1 0 1 1 0 1 | Value = 15490000 Fathomed |
| 5: | 0 0 0 0 0 0 0 0 0 0 0 0 0 0 0 1 1 1 1 1 0 1 1 0 ? | Value = 11490000 Fathomed |
| 5: | 0 0 0 0 0 0 0 0 0 0 0 0 0 0 0 1 1 1 1 1 0 1 0 0 1 | Value = 14290000 Fathomed |
| 4: | 0 0 0 0 0 0 0 0 0 0 0 0 0 0 0 1 1 1 1 1 0 1 ? 0 ? | Value = 10290000 Fathomed |
| 4: | 0 0 0 0 0 0 0 0 0 0 0 0 0 0 0 1 1 1 1 1 0 0 1 0 ? | Value = 11475000 Fathomed |
| 4: | 0 0 0 0 0 0 0 0 0 0 0 0 0 0 0 1 1 1 1 1 0 0 0 0 1 | Value = 14275000 Fathomed |
| 3: | 0 0 0 0 0 0 0 0 0 0 0 0 0 0 0 1 1 1 1 1 0 ? ? 0 ? | Value = 10275000 Fathomed |
| 3: | 0 0 0 0 0 0 0 0 0 0 0 0 0 0 0 1 1 1 1 0 0 1 ? 0 ? | Value = 2790000 Fathomed |
| 3: | 0 0 0 0 0 0 0 0 0 0 0 0 0 0 0 1 1 1 1 0 0 0 1 0 ? | Value = 3975000 Fathomed |
| 3: | 0 0 0 0 0 0 0 0 0 0 0 0 0 0 0 1 1 1 1 0 0 0 0 0 1 | Value = 6775000 Fathomed |
| 2: | 0 0 0 0 0 0 0 0 0 0 0 0 0 0 0 1 1 1 1 ? 0 ? ? 0 ? | Value = 2775000 Fathomed |
| 2: | 0 0 0 0 0 0 0 0 0 0 0 0 0 0 0 1 1 1 0 1 0 ? ? 0 ? | Value = 10200000 Fathomed |
| 2: | 0 0 0 0 0 0 0 0 0 0 0 0 0 0 0 1 1 1 0 0 0 1 ? 0 ? | Value = 2715000 Fathomed |
| 2: | 0 0 0 0 0 0 0 0 0 0 0 0 0 0 0 1 1 1 0 0 0 0 1 0 ? | Value = 3900000 Fathomed |
| 2: | 0 0 0 0 0 0 0 0 0 0 0 0 0 0 0 1 1 1 0 0 0 0 0 0 1 | Value = 6700000 Fathomed |
| 1: | 0 0 0 0 0 0 0 0 0 0 0 0 0 0 0 1 1 1 ? ? 0 ? ? 0 ? | Value = 2700000 Fathomed |
| 1: | 0 0 0 0 0 0 0 0 0 0 0 0 0 0 0 1 1 0 1 ? 0 ? ? 0 ? | Value = 775000 Fathomed |
| 1: | 0 0 0 0 0 0 0 0 0 0 0 0 0 0 0 1 1 0 0 1 0 ? ? 0 ? | Value = 8200000 Fathomed |
| 1: | 0 0 0 0 0 0 0 0 0 0 0 0 0 0 0 1 1 0 0 0 0 1 ? 0 ? | Value = 715000 Fathomed |
| 1: | 0 0 0 0 0 0 0 0 0 0 0 0 0 0 0 1 1 0 0 0 0 0 1 0 ? | Value = 1900000 Fathomed |
| 1: | 0 0 0 0 0 0 0 0 0 0 0 0 0 0 0 1 1 0 0 0 0 0 0 0 1 | Value = 4700000 Fathomed |
| Starting Solution 17 | | |
| 0: | ? ? ? ? ? ? ? ? 0 ? ? 0 ? ? ? ? 1 ? ? ? 0 ? ? 0 ? | Value = 150000 |
| 1: | 0 0 0 0 0 0 0 0 0 0 0 0 0 0 0 0 1 1 ? ? 0 ? ? 0 ? | Value = 2150000 |
| 2: | 0 0 0 0 0 0 0 0 0 0 0 0 0 0 0 0 1 1 1 ? 0 ? ? 0 ? | Value = 2225000 |
| 3: | 0 0 0 0 0 0 0 0 0 0 0 0 0 0 0 0 1 1 1 1 0 ? ? 0 ? | Value = 9725000 |
| 4: | 0 0 0 0 0 0 0 0 0 0 0 0 0 0 0 0 1 1 1 1 0 1 ? 0 ? | Value = 9740000 |
| 5: | 0 0 0 0 0 0 0 0 0 0 0 0 0 0 0 0 1 1 1 1 0 1 1 0 ? | Value = 10940000 |
| 6: | 0 0 0 0 0 0 0 0 0 0 0 0 0 0 0 0 1 1 1 1 0 1 1 0 1 | Value = 14940000 |
| 5: | 0 0 0 0 0 0 0 0 0 0 0 0 0 0 0 0 1 1 1 1 0 1 1 0 1 | Value = 14940000 Fathomed |
| 4: | 0 0 0 0 0 0 0 0 0 0 0 0 0 0 0 0 1 1 1 1 0 1 1 0 ? | Value = 10940000 Fathomed |
| 4: | 0 0 0 0 0 0 0 0 0 0 0 0 0 0 0 0 1 1 1 1 0 1 0 0 1 | Value = 13740000 Fathomed |
| 3: | 0 0 0 0 0 0 0 0 0 0 0 0 0 0 0 0 1 1 1 1 0 1 ? 0 ? | Value = 9740000 Fathomed |
| 3: | 0 0 0 0 0 0 0 0 0 0 0 0 0 0 0 0 1 1 1 1 0 0 1 0 ? | Value = 10925000 Fathomed |
| 3: | 0 0 0 0 0 0 0 0 0 0 0 0 0 0 0 0 1 1 1 1 0 0 0 0 1 | Value = 13725000 Fathomed |
| 2: | 0 0 0 0 0 0 0 0 0 0 0 0 0 0 0 0 1 1 1 1 0 ? ? 0 ? | Value = 9725000 Fathomed |
| 2: | 0 0 0 0 0 0 0 0 0 0 0 0 0 0 0 0 1 1 1 0 0 1 ? 0 ? | Value = 2240000 Fathomed |
| 2: | 0 0 0 0 0 0 0 0 0 0 0 0 0 0 0 0 1 1 1 0 0 0 1 0 ? | Value = 3425000 Fathomed |
| 2: | 0 0 0 0 0 0 0 0 0 0 0 0 0 0 0 0 1 1 1 0 0 0 0 0 1 | Value = 6225000 Fathomed |
| 1: | 0 0 0 0 0 0 0 0 0 0 0 0 0 0 0 0 1 1 1 ? 0 ? ? 0 ? | Value = 2225000 Fathomed |
| 1: | 0 0 0 0 0 0 0 0 0 0 0 0 0 0 0 0 1 1 0 1 0 ? ? 0 ? | Value = 9650000 Fathomed |
| 1: | 0 0 0 0 0 0 0 0 0 0 0 0 0 0 0 0 1 1 0 0 0 1 ? 0 ? | Value = 2165000 Fathomed |
| 1: | 0 0 0 0 0 0 0 0 0 0 0 0 0 0 0 0 1 1 0 0 0 0 1 0 ? | Value = 3350000 Fathomed |
| 1: | 0 0 0 0 0 0 0 0 0 0 0 0 0 0 0 0 1 1 0 0 0 0 0 0 1 | Value = 6150000 Fathomed |
| Starting Solution 18 | | |
| 0: | ? ? ? ? ? ? ? ? 0 ? ? 0 ? ? ? ? ? 1 ? ? 0 ? ? 0 ? | Value = 2000000 |
| 1: | 0 0 0 0 0 0 0 0 0 0 0 0 0 0 0 0 0 1 1 ? 0 ? ? 0 ? | Value = 2075000 |
| 2: | 0 0 0 0 0 0 0 0 0 0 0 0 0 0 0 0 0 1 1 1 0 ? ? 0 ? | Value = 9575000 |
| 3: | 0 0 0 0 0 0 0 0 0 0 0 0 0 0 0 0 0 1 1 1 0 1 ? 0 ? | Value = 9590000 |
| 4: | 0 0 0 0 0 0 0 0 0 0 0 0 0 0 0 0 0 1 1 1 0 1 1 0 ? | Value = 10790000 |
| 5: | 0 0 0 0 0 0 0 0 0 0 0 0 0 0 0 0 0 1 1 1 0 1 1 0 1 | Value = 14790000 |
| 4: | 0 0 0 0 0 0 0 0 0 0 0 0 0 0 0 0 0 1 1 1 0 1 1 0 1 | Value = 14790000 Fathomed |
| 3: | 0 0 0 0 0 0 0 0 0 0 0 0 0 0 0 0 0 1 1 1 0 1 1 0 ? | Value = 10790000 Fathomed |
| 3: | 0 0 0 0 0 0 0 0 0 0 0 0 0 0 0 0 0 1 1 1 0 1 0 0 1 | Value = 13590000 Fathomed |
| 2: | 0 0 0 0 0 0 0 0 0 0 0 0 0 0 0 0 0 1 1 1 0 1 ? 0 ? | Value = 9590000 Fathomed |
| 2: | 0 0 0 0 0 0 0 0 0 0 0 0 0 0 0 0 0 1 1 1 0 0 1 0 ? | Value = 10775000 Fathomed |
| 2: | 0 0 0 0 0 0 0 0 0 0 0 0 0 0 0 0 0 1 1 1 0 0 0 0 1 | Value = 13575000 Fathomed |
| 1: | 0 0 0 0 0 0 0 0 0 0 0 0 0 0 0 0 0 1 1 1 0 ? ? 0 ? | Value = 9575000 Fathomed |
| 1: | 0 0 0 0 0 0 0 0 0 0 0 0 0 0 0 0 0 1 1 0 0 1 ? 0 ? | Value = 2090000 Fathomed |
| 1: | 0 0 0 0 0 0 0 0 0 0 0 0 0 0 0 0 0 1 1 0 0 0 1 0 ? | Value = 3275000 Fathomed |
| 1: | 0 0 0 0 0 0 0 0 0 0 0 0 0 0 0 0 0 1 1 0 0 0 0 0 1 | Value = 6075000 Fathomed |
| Starting Solution 19 | | |
| 0: | ? ? ? ? ? ? ? ? 0 ? ? 0 ? ? ? ? ? ? 1 ? 0 ? ? 0 ? | Value = 75000 |
| 1: | 0 0 0 0 0 0 0 0 0 0 0 0 0 0 0 0 0 0 1 1 0 ? ? 0 ? | Value = 7575000 |
| 2: | 0 0 0 0 0 0 0 0 0 0 0 0 0 0 0 0 0 0 1 1 0 1 ? 0 ? | Value = 7590000 |
| 3: | 0 0 0 0 0 0 0 0 0 0 0 0 0 0 0 0 0 0 1 1 0 1 1 0 ? | Value = 8790000 |
| 4: | 0 0 0 0 0 0 0 0 0 0 0 0 0 0 0 0 0 0 1 1 0 1 1 0 1 | Value = 12790000 |
| 3: | 0 0 0 0 0 0 0 0 0 0 0 0 0 0 0 0 0 0 1 1 0 1 1 0 1 | Value = 12790000 Fathomed |
| 2: | 0 0 0 0 0 0 0 0 0 0 0 0 0 0 0 0 0 0 1 1 0 1 1 0 ? | Value = 8790000 Fathomed |
| 2: | 0 0 0 0 0 0 0 0 0 0 0 0 0 0 0 0 0 0 1 1 0 1 0 0 1 | Value = 11590000 Fathomed |
| 1: | 0 0 0 0 0 0 0 0 0 0 0 0 0 0 0 0 0 0 1 1 0 1 ? 0 ? | Value = 7590000 Fathomed |
| 1: | 0 0 0 0 0 0 0 0 0 0 0 0 0 0 0 0 0 0 1 1 0 0 1 0 ? | Value = 8775000 Fathomed |
| 1: | 0 0 0 0 0 0 0 0 0 0 0 0 0 0 0 0 0 0 1 1 0 0 0 0 1 | Value = 11575000 Fathomed |
| Starting Solution 20 | | |
| 0: | ? ? ? ? ? ? ? ? 0 ? ? 0 ? ? ? ? ? ? ? 1 0 ? ? 0 ? | Value = 7500000 |
| 1: | 0 0 0 0 0 0 0 0 0 0 0 0 0 0 0 0 0 0 0 1 0 1 ? 0 ? | Value = 7515000 |
| 2: | 0 0 0 0 0 0 0 0 0 0 0 0 0 0 0 0 0 0 0 1 0 1 1 0 ? | Value = 8715000 |
| 3: | 0 0 0 0 0 0 0 0 0 0 0 0 0 0 0 0 0 0 0 1 0 1 1 0 1 | Value = 12715000 |
| 2: | 0 0 0 0 0 0 0 0 0 0 0 0 0 0 0 0 0 0 0 1 0 1 1 0 1 | Value = 12715000 Fathomed |
| 1: | 0 0 0 0 0 0 0 0 0 0 0 0 0 0 0 0 0 0 0 1 0 1 1 0 ? | Value = 8715000 Fathomed |
| 1: | 0 0 0 0 0 0 0 0 0 0 0 0 0 0 0 0 0 0 0 1 0 1 0 0 1 | Value = 11515000 Fathomed |
| Starting Solution 21 | | |
| 0: | ? ? ? ? ? ? ? ? 0 ? ? 0 ? ? ? ? ? ? ? ? 1 ? ? 0 ? | Value = 0 |
| 1: | 0 0 0 0 0 0 0 0 0 0 0 0 0 0 0 0 0 0 0 0 1 1 ? 0 ? | Value = 15000 |
| 2: | 0 0 0 0 0 0 0 0 0 0 0 0 0 0 0 0 0 0 0 0 1 1 1 0 ? | Value = 1215000 |
| 3: | 0 0 0 0 0 0 0 0 0 0 0 0 0 0 0 0 0 0 0 0 1 1 1 0 1 | Value = 5215000 |
| 2: | 0 0 0 0 0 0 0 0 0 0 0 0 0 0 0 0 0 0 0 0 1 1 1 0 1 | Value = 5215000 Fathomed |
| 1: | 0 0 0 0 0 0 0 0 0 0 0 0 0 0 0 0 0 0 0 0 1 1 1 0 ? | Value = 1215000 Fathomed |
| 1: | 0 0 0 0 0 0 0 0 0 0 0 0 0 0 0 0 0 0 0 0 1 1 0 0 1 | Value = 4015000 Fathomed |
| Starting Solution 22 | | |
| 0: | ? ? ? ? ? ? ? ? 0 ? ? 0 ? ? ? ? ? ? ? ? 0 1 ? 0 ? | Value = 15000 |
| 1: | 0 0 0 0 0 0 0 0 0 0 0 0 0 0 0 0 0 0 0 0 0 1 1 0 ? | Value = 1215000 |
| 2: | 0 0 0 0 0 0 0 0 0 0 0 0 0 0 0 0 0 0 0 0 0 1 1 0 1 | Value = 5215000 |
| 1: | 0 0 0 0 0 0 0 0 0 0 0 0 0 0 0 0 0 0 0 0 0 1 1 0 1 | Value = 5215000 Fathomed |
| Starting Solution 23 | | |
| 0: | ? ? ? ? ? ? ? ? 0 ? ? 0 ? ? ? ? ? ? ? ? 0 ? 1 0 ? | Value = 1200000 |
| 1: | 0 0 0 0 0 0 0 0 0 0 0 0 0 0 0 0 0 0 0 0 0 0 1 0 1 | Value = 5200000 |
| Starting Solution 24 | | |
| 0: | ? ? ? ? ? ? ? ? 0 ? ? 0 ? ? ? ? ? ? ? ? 0 ? ? 1 ? | Value = 1600000 |
| 1: | 0 0 0 0 0 0 0 0 0 0 0 0 0 0 0 0 0 0 0 0 0 0 0 1 1 | Value = 5600000 |
| Starting Solution 25 | | |
| 0: | ? ? ? ? ? ? ? ? 0 ? ? 0 ? ? ? ? ? ? ? ? 0 ? ? 0 1 | Value = 4000000 |
| 0: | 0 0 0 0 0 0 0 0 1 1 1 0 1 1 0 1 1 0 0 1 0 1 0 0 1 | Value = 17705000 Optimal (Maximal) |

3/12/2013 2:07:37 PM Analysis complete . . .

What is claimed is:

1. A unique method using a computing device for managing a portfolio of projects, the method comprising:
(a) receiving, into the computing device, input from a user comprising data (soft data) concerning one or more of the projects either in an active portfolio (inflight project) or that is being considered for inclusion in a portfolio (candidate project);
(b) receiving, into the computing device, input from a system comprising data (hard data) concerning one or more of the projects either in an active portfolio (inflight project) or that is being considered for inclusion in a portfolio (candidate project);
(c) combining these two data inputs by a rational mathematical formula to enable them to provide a greater field of intelligence for project portfolio management;
(d) establishing and selecting the optimization criteria which includes a broad base for said criteria including multiple funding sources;
(e) setting up the problem with an extensible and inclusive algorithm that allows;
i the employment of a Branch and Bound Simplex algorithmic process;
ii multi-period planning for projects;
iii pre-requisites and co-requisites;
iv multi-role resources;
v factoring for resource proficiency;
vi optional confidence levels to project estimates;
vii inclusion of standard models such as the MIT model of portfolio classification;
viii the creation of additional models that are complimentary or supplementary to the said standard models making the system responsive to the dynamics of the environment;
ix the employment of a singular Objective Function allowing the user to optimize a single attribute at the expense of others or;
x the employment of Full Spectrum Optimization across all said criteria and;
xi the ability to run complex sensitivity analysis on the results of the said Full Spectrum Optimization;
(f) periodic execution of question sets for the portfolios that are driven by payback values of the projects and the resource utilizations on a role-by-role basis;
(g) providing a report to the user representing the results of the optimization analysis and the recommended portfolio's configuration.

2. The method of claim 1, further comprising of the use of intelligence derived from an integrated automated project office system which uses best practices to validate individual projects.

3. The method of claim 1, further comprising the use of an integrated resource utilization planner that address the need for balancing resources in the portfolio on an ongoing basis comprising:
(a) the ability to rebalance the portfolio based on changing resource availability;
(b) the ability to create new resources;
(c) the ability to delete an assignment;
(d) the ability to update an assignment;
(e) the ability to implement automated flex tasking;
(f) the ability to view assignments by project, person or role;
(g) the ability to modify any of the work-items in an assignment;
(h) report all of the status information on any or all assignments.

4. A computing device for managing a portfolio of projects, the computing device comprising:
(a) user interface for receiving an input from a user comprising data concerning the projects comprising or intending to comprise the portfolio;
(b) a processing device, in communication with the user interface, for selecting the intended optimization for the portfolio;
(c) the execution on the said computing device of optimizing the portfolio;
(d) providing, by way of the user interface, a report to the user representing the result of optimization's execution.

5. The computing device of claims 1, 2, 3 and 4 wherein the user interface and the processing device communicate to each other over the Internet or an intranet.
